(19) United States
(12) Patent Application Publication
(10) Pub. No.: US 2021/0297687 A1
(43) Pub. Date: Sep. 23, 2021

(54) ENCODING APPARATUS, ENCODING METHOD, DECODING APPARATUS, AND DECODING METHOD

(71) Applicant: SONY CORPORATION, Tokyo (JP)

(72) Inventors: Takuro KAWAI, Tokyo (JP); Kenichiro HOSOKAWA, Kanagawa (JP); Ohji NAKAGAMI, Tokyo (JP); Masaru IKEDA, Kanagawa (JP)

(73) Assignee: SONY CORPORATION, Tokyo (JP)

(21) Appl. No.: 16/486,657

(22) PCT Filed: Mar. 1, 2018
(86) PCT No.: PCT/JP2018/007704

§ 371 Date: Aug. 16, 2019

(30) Foreign Application Priority Data
Mar. 15, 2017 (JP) 2017-049889

(51) Int. Cl. H04N 19/50; H04N 19/182; H04N 19/117; H04N 19/46

(52) U.S. Cl. CPC H04N 19/50; H04N 19/46; H04N 19/117; H04N 19/182

(57) ABSTRACT

There is provided an encoding apparatus, an encoding method, a decoding apparatus, and a decoding method that can significantly improve S/N of an image. A classification unit classifies a target pixel of a first image, which is obtained by adding a residual of prediction encoding and a predicted image, into one of a plurality of classes, and a filter processing unit applies a filtering process corresponding to the class of the target pixel to the first image to generate a second image used to predict the predicted image. The classification is performed by using previous-stage filter related information regarding a previous-stage filtering process executed in a previous stage of the filtering process of the filter processing unit. The present technique can be applied to, for example, an encoding apparatus or a decoding apparatus of an image.

### TECHNICAL FIELD

The present technique relates to an encoding apparatus, an encoding method, a decoding apparatus, and a decoding method, and particularly, to an encoding apparatus, an encoding method, a decoding apparatus, and a decoding method that can significantly improve, for example, S/N of an image.

### BACKGROUND ART

An ILF (In Loop Filter) is proposed in, for example, HEVC (High Efficiency Video Coding) that is one of prediction encoding systems. In addition, the ILF is expected to be adopted in post-HEVC (prediction encoding system of next generation of HEVC).

An example of the ILF includes a DF (Deblocking Filter) for reducing blocking noise, an SAO (Sample Adaptive Offset) for reducing ringing, and an ALF (Adaptive Loop Filter) for minimizing encoding errors (errors of decoded image with respect to original image).

The ALF is described in PTL 1, and the SAO is described in PTL 2.

### CITATION LIST

### Patent Literature

### [PTL 1]

Japanese Patent No. 5485983

### [PTL 2]

JP 2014-523183T

### SUMMARY

### Technical Problem

The currently proposed DF, SAO, and ALF as ILFs operate independently of each other. Therefore, a filter that executes a filtering process in a later stage does not execute the filtering process by taking into account a filtering process of a filter that executes the filtering process in a previous stage.

That is, in a case where the filtering processes are executed in the order of, for example, DF, SAO, and ALF, the SAO does not execute the filtering process by taking into account the DF in the previous stage of the SAO, and the ALF does not execute the filtering process by taking into account the DF and the SAO in the previous stages of the ALF.

Therefore, the filtering process of a filter in the later stage may not be the optimal filtering process, and it is difficult to significantly improve the S/N (Signal to Noise Ratio) of the image.

The present technique has been made in view of the circumstances, and the present technique can significantly improve the S/N of the image.

### Solution to Problem

The present technique provides an encoding apparatus including: a classification unit that classifies a target pixel of a first image, the first image being obtained by adding a residual of prediction encoding and a predicted image, into one of a plurality of classes; and a filter processing unit that applies a filtering process corresponding to the class of the target pixel to the first image to generate a second image used to predict the predicted image, in which the classification unit performs the classification by using previous-stage filter related information regarding a previous-stage filtering process executed in a previous stage of the filtering process of the filter processing unit, and the encoding apparatus performs the prediction encoding.

The present technique provides an encoding method of an encoding apparatus, the encoding apparatus including: a classification unit that classifies a target pixel of a first image, the first image being obtained by adding a residual of prediction encoding and a predicted image, into one of a plurality of classes; and a filter processing unit that applies a filtering process corresponding to the class of the target pixel to the first image to generate a second image used to predict the predicted image, in which the encoding apparatus performs the prediction encoding, and the classification unit performs the classification by using previous-stage filter related information regarding a previous-stage filtering process executed in a previous stage of the filtering process of the filter processing unit.

In the encoding apparatus and the encoding method of the present technique, the classification is performed by classifying the target pixel of the first image, the first image being obtained by adding the residual of the prediction encoding and the predicted image, into one of the plurality of classes. In addition, the filtering process corresponding to the class of the target pixel is applied to the first image to generate the second image used to predict the predicted image, and the prediction encoding is performed. In the prediction encoding, the classification is performed by using the previous-stage filter related information regarding the previous-stage filtering process executed in the previous stage of the filtering process of the filter processing unit.

The present technique provides a decoding apparatus including: a classification unit that classifies a target pixel of a first image, the first image being obtained by adding a residual of prediction encoding and a predicted image, into one of a plurality of classes; and a filter processing unit that applies a filtering process corresponding to the class of the target pixel to the first image to generate a second image used to predict the predicted image, in which the classification unit performs the classification by using previous-stage filter related information regarding a previous-stage filtering process executed in a previous stage of the filtering process of the filter processing unit, and the decoding apparatus uses the predicted image to decode an image.

The present technique provides a decoding method of a decoding apparatus, the decoding apparatus including: a classification unit that classifies a target pixel of a first image, the first image being obtained by adding a residual of prediction encoding and a predicted image, into one of a plurality of classes; and a filter processing unit that applies a filtering process corresponding to the class of the target pixel to the first image to generate a second image used to predict the predicted image, in which the decoding apparatus uses the predicted image to decode an image, and the classification unit performs the classification by using previous-stage filter related information regarding a previous-stage filtering process executed in a previous stage of the filtering process of the filter processing unit.

In the decoding apparatus and the decoding method of the present technique, the classification is performed by classifying the target pixel of the first image, the first image being obtained by adding the residual of the prediction encoding and the predicted image, into one of the plurality of classes. In addition, the filtering process corresponding to the class of the target pixel is applied to the first image to generate the second image used to predict the predicted image, and the predicted image is used to decode the image. In the decoding, the classification is performed by using the previous-stage filter related information regarding the previous-stage filtering process executed in the previous stage of the filtering process of the filter processing unit.

Note that the encoding apparatus and the decoding apparatus may be an independent apparatus or may be an internal block included in one apparatus.

In addition, the encoding apparatus and the decoding apparatus can be realized by causing a computer to execute a program. The program can be transmitted and provided through a transmission medium or can be recorded and provided in a recording medium.

### Advantageous Effect of Invention

According to the present technique, the S/N of the image can be significantly improved.

Note that the advantageous effect described here may not be limited, and the advantageous effect may be any of the advantageous effects described in the present disclosure.

### BRIEF DESCRIPTION OF DRAWINGS

FIG. 1 is a diagram illustrating a configuration example of an embodiment of an image processing system according to the present technique.

FIG. 2 is a block diagram illustrating a first configuration example of an image conversion apparatus that executes an adaptive classification process.

FIG. 3 is a block diagram illustrating a configuration example of a learning apparatus that performs learning of tap coefficients stored in a coefficient acquisition unit 23.

FIG. 4 is a block diagram illustrating a configuration example of a learning unit 43.

FIG. 5 is a block diagram illustrating a second configuration example of the image conversion apparatus that executes the adaptive classification process.

FIG. 6 is a block diagram illustrating a configuration example of the learning apparatus that performs learning of seed coefficients stored in a coefficient acquisition unit 61.

FIG. 7 is a block diagram illustrating a configuration example of a learning unit 73.

FIG. 8 is a block diagram illustrating another configuration example of the learning unit 73.

FIG. 9 is a block diagram illustrating a first configuration example of an encoding apparatus 11.

FIG. 10 is a diagram illustrating an example of DF information and SAO information as previous-stage filter related information used by an adaptive classification filter 113 in an adaptive classification process (and learning).

FIG. 11 is a block diagram illustrating a configuration example of the adaptive classification filter 113.

FIG. 12 is a block diagram illustrating a configuration example of a learning apparatus 131.

FIG. 13 is a diagram describing a filtering process executed by a DF 111.

FIG. 14 is a diagram illustrating an example of position information of pixels of an image being decoded that can be subjected to DF.

FIG. 15 is a diagram illustrating an example of classification using the DF information.

FIG. 16 is a flow chart describing an example of a process in a case where a classification unit 162 uses the DF information to perform classification.

FIG. 17 is a diagram illustrating another example of the classification using the DF information.

FIG. 18 is a block diagram illustrating a configuration example of the classification unit 162 in a case of using the DF information and image feature values as other information to perform the classification.

FIG. 19 is a flow chart describing an example of a process of the learning apparatus 131.

FIG. 20 is a block diagram illustrating a configuration example of an image conversion apparatus 133.

FIG. 21 is a flow chart describing an example of an encoding process of the encoding apparatus 11.

FIG. 22 is a flow chart describing an example of an adaptive classification process executed in step S57.

FIG. 23 is a block diagram illustrating a first configuration example of a decoding apparatus 12.

FIG. 24 is a block diagram illustrating a configuration example of an adaptive classification filter 208.

FIG. 25 is a block diagram illustrating a configuration example of an image conversion apparatus 231.

FIG. 26 is a flow chart describing an example of a decoding process of the decoding apparatus 12.

FIG. 27 is a flow chart describing an example of an adaptive classification process executed in step S123.

FIG. 28 is a diagram describing an example of a reduction method of reducing the tap coefficients of each class obtained by the tap coefficient learning.

FIG. 29 is a block diagram illustrating a second configuration example of the encoding apparatus 11.

FIG. 30 is a block diagram illustrating a configuration example of an adaptive classification filter 311.

FIG. 31 is a block diagram illustrating a configuration example of a learning apparatus 331.

FIG. 32 is a flow chart describing an example of a process of the learning apparatus 331.

FIG. 33 is a block diagram illustrating a configuration example of an image conversion apparatus 333.

FIG. 34 is a flow chart describing an example of an encoding process of the encoding apparatus 11.

FIG. 35 is a flow chart describing an example of an adaptive classification process executed in step S257.

FIG. 36 is a block diagram illustrating a second configuration example of the decoding apparatus 12.

FIG. 37 is a block diagram illustrating a configuration example of an adaptive classification filter 411.

FIG. 38 is a block diagram illustrating a configuration example of an image conversion apparatus 431.

FIG. 39 is a flow chart describing an example of a decoding process of the decoding apparatus 12.

FIG. 40 is a flow chart describing an example of an adaptive classification process executed in step S323.

FIG. 41 is a diagram illustrating an example of a multi-view image encoding system.

FIG. 42 is a diagram illustrating a main configuration example of a multi-view image encoding apparatus according to the present technique.

FIG. 43 is a diagram illustrating a main configuration example of a multi-view image decoding apparatus according to the present technique.

FIG. 44 is a diagram illustrating an example of a tiered image encoding system.

FIG. 45 is a diagram illustrating a main configuration example of a tiered image encoding apparatus according to the present technique.

FIG. 46 is a diagram illustrating a main configuration example of a tiered image decoding apparatus according to the present technique.

FIG. 47 is a block diagram illustrating a main configuration example of a computer.

FIG. 48 is a block diagram illustrating an example of a schematic configuration of a television apparatus.

FIG. 49 is a block diagram illustrating an example of a schematic configuration of a mobile phone.

FIG. 50 is a block diagram illustrating an example of a schematic configuration of a recording/reproducing apparatus.

FIG. 51 is a block diagram illustrating an example of a schematic configuration of an imaging apparatus.

FIG. 52 is a block diagram illustrating an example of a schematic configuration of a video set.

FIG. 53 is a block diagram illustrating an example of a schematic configuration of a video processor.

FIG. 54 is a block diagram illustrating another example of the schematic configuration of the video processor.

### DESCRIPTION OF EMBODIMENTS

### <Image Processing System According to Present Technique>

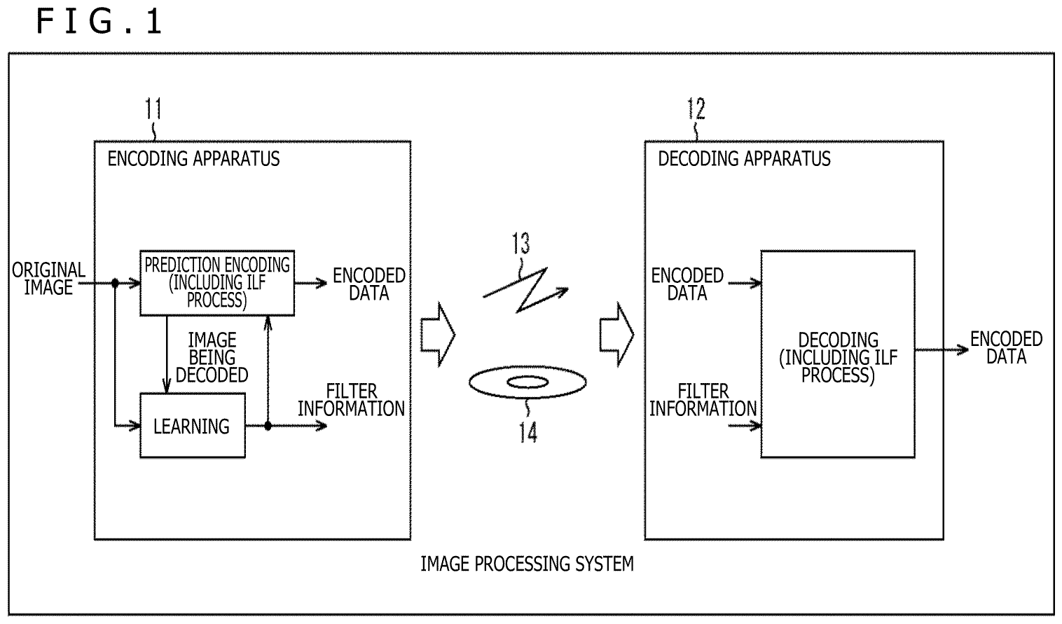

FIG. 1 is a diagram illustrating a configuration example of an embodiment of an image processing system according to the present technique.

In FIG. 1, the image processing system includes an encoding apparatus 11 and a decoding apparatus 12.

An original image to be encoded is supplied to the encoding apparatus 11.

The encoding apparatus 11 uses, for example, prediction encoding, such as HEVC and AVC (Advanced Video Coding), to encode the original image.

In the prediction encoding of the encoding apparatus 11, a predicted image of the original image is generated, and the residual between the original image and the predicted image is encoded.

Furthermore, in the prediction encoding of the encoding apparatus 11, an ILF process is executed, in which an ILF is applied to an image being decoded obtained by adding the residual of the prediction encoding and the predicted image. In this way, a reference image used for the prediction of the predicted image is generated.

Here, the image obtained by applying a filtering process (filtering) as the ILF process to the image being decoded will also be referred to as an image after filtering.

In addition to the prediction encoding, the encoding apparatus 11 uses the image being decoded and the original image to perform learning and the like to obtain filtering information that is information regarding the filtering process as the ILF process such that the image after filtering becomes as close to the original image as possible.

The ILF process of the encoding apparatus 11 can be executed by using the filter information obtained by learning.

Here, the learning for obtaining the filter information can be performed, for example, for every one or a plurality of sequences of the original image, for every one or a plurality of scenes (frames from a scene change to the next scene change) of the original image, for every one or a plurality of frames (pictures) of the original image, for every one or a plurality of slices of the original image, for every one or a plurality of blocks as encoding units of the picture, or in other arbitrary units. In addition, the learning for obtaining the filter information can be performed, for example, in a case where the residual or the RD cost becomes equal to or greater than a threshold.

The encoding apparatus 11 transmits the encoded data obtained by the prediction encoding of the original image through a transmission medium 13 or transmits and records the encoded data in a recording medium 14.

In addition, the encoding apparatus 11 can transmit the filter information obtained by the learning through the transmission medium 13 or can transmit and record the filter information in the recording medium 14.

Note that the learning for obtaining the filter information can be performed by an apparatus different from the encoding apparatus 11.

In addition, the filter information can be transmitted separately from the encoded data or can be included in the encoded data and transmitted.

Furthermore, other than using the original image (and the image being decoded obtained from the original image), the learning for obtaining the filter information can be performed by using an image different from the original image including image feature values similar to the original image.

The decoding apparatus 12 collects (receives) (acquires) the encoded data and necessary filter information transmitted from the encoding apparatus 11 through the transmission medium 13 or the recording medium 14 and uses a system corresponding to the prediction encoding of the encoding apparatus 11 to decode the encoded data.

That is, the decoding apparatus 12 processes the encoded data from the encoding apparatus 11 to obtain the residual of the prediction encoding. Furthermore, the decoding apparatus 12 adds the residual and the predicted image to obtain an image being decoded similar to the image being decoded obtained by the encoding apparatus 11. The decoding apparatus 12 then applies, to the image being decoded, a filtering process as an ILF process using the filter information from the encoding apparatus 11 as necessary and obtains the image after filtering.

The decoding apparatus 12 outputs the image after filtering as a decoded image of the original image and temporarily stores the image after filtering as a reference image to be used for the prediction of the predicted image as necessary.

The filtering process as the ILF process of the encoding apparatus 11 and the decoding apparatus 12 can be executed by using an arbitrary filter.

In addition, the filtering process of the encoding apparatus 11 and the decoding apparatus 12 can be executed based on an adaptive classification process (prediction computation of the adaptive classification process). Hereinafter, the adaptive classification process will be described.

### <Adaptive Classification Process>

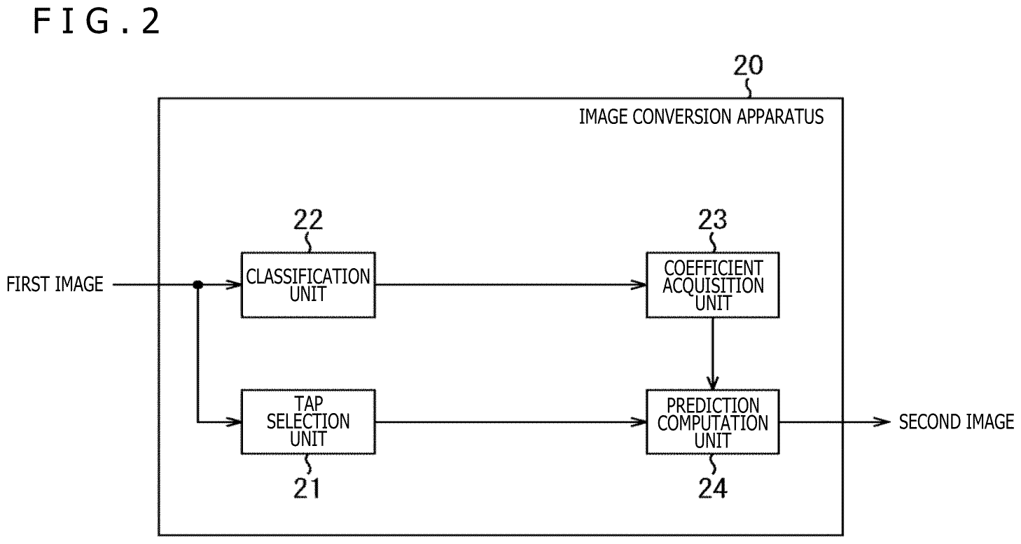

FIG. 2 is a block diagram illustrating a first configuration example of an image conversion apparatus that executes the adaptive classification process.

Here, the adaptive classification process can be considered as, for example, an image conversion process of converting a first image into a second image.

The image conversion process of converting the first image into the second image can be various types of signal processing depending on the definition of the first and second images.

That is, if, for example, the first image is an image with low spatial resolution, and the second image is an image with high spatial resolution, the image conversion process can be a spatial resolution creation (improvement) process of improving the spatial resolution.

In addition, if, for example, the first image is an image with low S/N, and the second image is an image with high S/N, the image conversion process can be a noise removal process of removing the noise.

Furthermore, if, for example, the first image is an image with a predetermined number of pixels (size), and the second image is an image with the number of pixels higher or lower than the number of pixels of the first image, the image conversion process can be a resizing process of resizing (enlarging or reducing) the image.

In addition, for example, if the first image is a decoded image obtained by decoding an image encoded in blocks of HEVC or the like, and the second image is an original image before encoding, the image conversion process can be a distortion removal process of removing block distortion caused by the block-based encoding and decoding.

Note that other than the image, the processing target of the adaptive classification process can be, for example, sound. The adaptive classification process of the sound can be considered as a sound conversion process of converting first sound (for example, sound with low S/N or the like) into second sound (for example, sound with high S/N or the like).

In the adaptive classification process, tap coefficients of a class obtained by classifying a pixel value of a target pixel (processing target pixel to be processed) targeted in the first image into one of a plurality of classes and pixel values of the same number of pixels as the number of tap coefficients in the first image selected with respect to the target pixel are used to perform prediction computation, and a pixel value of the target pixel is obtained.

FIG. 2 illustrates a configuration example of an image conversion apparatus that executes an image conversion process based on the adaptive classification process.

In FIG. 2, an image conversion apparatus 20 includes a tap selection unit 21, a classification unit 22, a coefficient acquisition unit 23, and a prediction computation unit 24.

The first image is supplied to the image conversion apparatus 20. The first image supplied to the image conversion apparatus 20 is supplied to the tap selection unit 21 and the classification unit 22.

The tap selection unit 21 sequentially selects a pixel included in the first image as a target pixel. The tap selection unit 21 further selects, as a prediction tap, some of the pixels (pixel values of the pixels) included in the first image used for predicting a corresponding pixel (pixel value of the corresponding pixel) of the second image corresponding to the target pixel.

Specifically, the tap selection unit 21 selects, as a prediction tap, a plurality of pixels of the first image at positions spatially or temporally close to the position of the target pixel in the spatio-temporal space. In this way, the tap selection unit 21 forms the prediction tap and supplies the prediction tap to the prediction computation unit 24.

The classification unit 22 classifies the target pixel into one of some classes according to a certain rule and supplies a class code corresponding to the class obtained as a result of the classification to the coefficient acquisition unit 23.

That is, for example, the classification unit 22 selects, as a class tap, some of the pixels (pixel values of the pixels) included in the first image used for classifying the target pixel. For example, the classification unit 22 selects the class tap just like the selection of the prediction tap selected by the tap selection unit 21.

Note that the tap structures of the prediction tap and the class tap may be the same or may be different.

The classification unit 22 uses, for example, the class tap to classify the target pixel and supplies a class code corresponding to the class obtained as a result of the classification to the coefficient acquisition unit 23.

For example, the classification unit 22 uses the class tap to obtain an image feature value of the target pixel. The classification unit 22 further classifies the target pixel according to the image feature value of the target pixel and supplies the class code corresponding to the class obtained as a result of the classification to the coefficient acquisition unit 23.

Here, an example of the method of classification that can be adopted includes ADRC (Adaptive Dynamic Range Coding).

In the method of using the ADRC, an ADRC process is applied to the pixels (pixel values of the pixels) included in the class tap, and the class of the target pixel is decided according to an ADRC code (ADRC value) obtained as a result of the ADRC process. The ADRC code represents a waveform pattern of the image feature values of a small area including the target value.

Note that in L-bit ADRC, for example, a maximum value MAX and a minimum value MIN of the pixel values of the pixels included in the class tap are detected, and DR=MAX−MIN is used as a local dynamic range of a set. The pixel value of each pixel included in the class tap is re-quantized into L bits based on the dynamic range DR. That is, the minimum value MIN is subtracted from the pixel value of each pixel included in the class tap, and the subtracted value is divided (re-quantized) by DR/2^{L}. The pixel values of the pixels of L bits included in the class tap obtained in this way are then lined up in a predetermined order, and the bit string is output as an ADRC code. Therefore, for example, in a case where a 1-bit ADRC process is applied to the class tap, the pixel value of each pixel included in the class tap is divided by an average value of the maximum value MAX and the minimum value MIN (rounded down to the nearest decimal), and in this way, the pixel value of each pixel is set to 1 bit (binarized). The pixel values in 1 bit are then lined up in a predetermined order, and the bit string is output as an ADRC code.

Note that, for example, the classification unit 22 can also output, as the class code, a pattern of level distribution of the pixel values of the pixels included in the class tap. However, if the class tap includes pixel values of N pixels, and A bits are allocated to the pixel value of each pixel in this case, the number of types of the class code output by the classification unit 22 is (2^{N})^{A}, and this is an enormous number exponentially proportional to the number of bits A of the pixel value of the pixel.

Therefore, it is preferable that the classification unit 22 use the ADRC process, vector quantization, or the like to compress the amount of information of the class tap to perform the classification.

The coefficient acquisition unit 23 stores tap coefficients of each class obtained by learning described later and further acquires tap coefficients of the class indicated by the class code supplied from the classification unit 22, that is, tap coefficients of the class of the target pixel, from among the stored tap coefficients. The coefficient acquisition unit 23 further supplies the tap coefficients of the class of the target pixel to the prediction computation unit 24.

Here, the tap coefficients are coefficients equivalent to coefficients multiplied with input data in a so-called tap in a digital filter.

The prediction computation unit 24 uses the prediction tap output by the tap selection unit 21 and the tap coefficients supplied from the coefficient acquisition unit 23 to perform predetermined prediction computation of obtaining a predicted value of a true value of the pixel value of the pixel (corresponding pixel) of the second image corresponding to the target pixel. In this way, the prediction computation unit 24 obtains and outputs the pixel value (predicted value of the pixel value) of the corresponding pixel, that is, the pixel value of the pixel included in the second image.

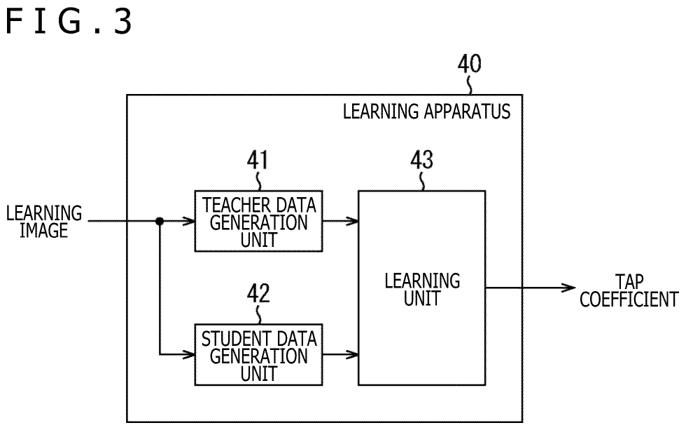

FIG. 3 is a block diagram illustrating a configuration example of a learning apparatus that performs learning of the tap coefficients stored in the coefficient acquisition unit 23.

In an example considered here, the second image is an image with high quality (high-quality image), and the first image is an image with low quality (low-quality image) obtained by, for example, using an LPF (Low Pass Filter) to filter the high-quality image to reduce the image quality (resolution). The prediction tap is selected from the low-quality image, and the prediction tap and the tap coefficients are used to obtain (predict) the pixel value of the pixel of the high-quality image (high-quality pixel) based on the predetermined prediction computation.

Assuming that, for example, linear first-order prediction computation is adopted as the predetermined prediction computation, a pixel value y of the high-quality pixel is obtained by the following linear first-order equation.

$$\begin{matrix}[ Math . 1 ] & \\ y = {\sum }_{n = 1}^{N} {W}_{n} {X}_{n} & ( 1 )\end{matrix}$$

Here, in Formula (1), xₙ, represents a pixel value of an nth pixel of the low-quality image (hereinafter, appropriately referred to as low-quality pixel) included in the prediction tap for the high-quality pixel y as a corresponding pixel, and wₙ represents an nth tap coefficient multiplied with the nth low-quality pixel (pixel value of the nth low-quality pixel). Note that in Formula (1), it is assumed that the prediction tap includes N low-quality pixels x₁, x₂, . . . , x_{N}.

Here, a second or higher order equation can also be used instead of the linear first-order equation indicated in Formula (1) to obtain the pixel value y of the high-quality pixel.

Now, a prediction error eₖ between yₖ and y_{k′} is represented by the following formula, where yₖ represents a true value of the pixel value of the high-quality pixel of a kth sample, and y_{k′} represents a predicted value of the true value yₖ obtained by Formula (1).

[Math. 2]

eₖ=yₖ−y_{k′} (2)

Now, the predicted value y_{k′} of Formula (2) is obtained according to Formula (1), and y_{k′} of Formula (2) is replaced according to Formula (1) to obtain the following formula.

$$\begin{matrix}[ Math . 3 ] & \\ {e}_{k} = {y}_{k} - ( {\sum }_{n = 1}^{N} {W}_{n} {X}_{n} , k ) & ( 3 )\end{matrix}$$

Here, x_{n,k} in Formula (3) represents an nth low-quality pixel included in the prediction tap with respect to the high-quality pixel of the kth sample as a corresponding pixel.

Although the tap coefficient wₙ is optimal for predicting the high-quality pixel when the prediction error eₖ of Formula (3) (or Formula (2)) is 0, it is generally difficult to obtain such a tap coefficient wₙ for all the high-quality pixels.

Therefore, when, for example, a least-squares method is adopted as a standard indicating that the tap coefficient wₙ is optimal, the optimal tap coefficient wₙ can be obtained by minimizing a sum total E of square errors (statistical errors) represented by the following formula.

$$\begin{matrix}[ Math . 4 ] & \\ E = {\sum }_{k = 1}^{K} {e}_{k}^{2} & ( 4 )\end{matrix}$$

Here, K in Formula (4) represents the number of samples (the number of samples for learning) of a set of the high-quality pixel yₖ as a corresponding pixel and low-quality pixels x_{1,k}, x_{2,k}, . . . , x_{N,k} included in the prediction tap for the high-quality pixel yₖ.

A minimum value (lowest value) of the sum total E of square errors in Formula (4) is provided by wₙ where the partial derivative of the sum total E with respect to the tap coefficient wₙ is 0 as indicated in Formula (5).

$$\begin{matrix}[ Math . 5 ] & \\ \frac{\partial E}{\partial {W}_{n}} = {e}_{1} \frac{\partial {e}_{1}}{\partial {W}_{n}} + {e}_{2} \frac{\partial {e}_{2}}{\partial {W}_{n}} + … + {e}_{k} \frac{\partial {e}_{k}}{\partial {W}_{n}} = 0 \\ ( n = 1 , 2 , … , N ) & ( 5 )\end{matrix}$$

Therefore, the following formula can be obtained as a partial derivative of Formula (3) with respect to the tap coefficient wₙ.

$$\begin{matrix}[ Math . 6 ] & \\ \frac{\partial {e}_{k}}{\partial {W}_{1}} = - {X}_{1 , k} , \frac{\partial {e}_{k}}{\partial {W}_{2}} = - {X}_{2 , k} , … , \frac{\partial {e}_{k}}{\partial {W}_{N}} = - {X}_{N , k} , \\ ( k = 1 , 2 , … , K ) & ( 6 )\end{matrix}$$

The following formula is obtained from Formulas (5) and (6).

$$\begin{matrix}[ Math . 7 ] & \\ {\sum }_{k = 1}^{K} {e}_{k} {X}_{1 , k} = 0 , {\sum }_{k = 1}^{K} {e}_{k} {X}_{2 , k} = 0 , … {\sum }_{k = 1}^{K} {e}_{k} {X}_{N , k} = 0 & ( 7 )\end{matrix}$$

Formula (3) can be assigned to eₖ of Formula (7), and Formula (7) can be represented by a normal equation indicated in Formula (8).

$$\begin{matrix} [ Math . 8 ] & \\ [ \begin{matrix}( {\sum }_{k = 1}^{K} {X}_{1 , k} {X}_{1 , k} ) & ( {\sum }_{k = 1}^{K} {X}_{1 , k} {X}_{2 , k} ) & … & ( {\sum }_{k = 1}^{K} {X}_{1 , k} {X}_{N , k} ) \\ ( {\sum }_{k = 1}^{K} {X}_{2 , k} {X}_{1 , k} ) & ( {\sum }_{k = 1}^{K} {X}_{2 , k} {X}_{2 , k} ) & … & ( {\sum }_{k = 1}^{K} {X}_{2 , k} {X}_{N , k} ) \\ ⋮ & ⋮ & ⋱ & ⋮ \\ ( {\sum }_{k = 1}^{K} {X}_{N , k} {X}_{1 , k} ) & ( {\sum }_{k = 1}^{K} {X}_{N , k} {X}_{2 , k} ) & … & ( {\sum }_{k = 1}^{K} {X}_{N , k} {X}_{N , k} )\end{matrix} ] [ \begin{matrix}{W}_{1} \\ {W}_{2} \\ ⋮ \\ {W}_{N}\end{matrix} ] = [ \begin{matrix}( {\sum }_{k = 1}^{K} {X}_{1 , k} {y}_{k} ) \\ ( {\sum }_{k = 1}^{K} {X}_{2 , k} {y}_{k} ) \\ ⋮ \\ ( {\sum }_{k = 1}^{K} {X}_{N , k} {y}_{k} )\end{matrix} ] & ( 8 )\end{matrix}$$

The normal equation of Formula (8) can be solved for the tap coefficient wₙ by using, for example, a sweep-out method (elimination method of Gauss-Jordan) or the like.

The normal equation of Formula (8) can be established and solved for each class to obtain the optimal tap coefficient (here, tap coefficient minimizing the sum total E of square errors) wₙ for each class.

FIG. 3 illustrates a configuration example of the learning apparatus that establishes and solves the normal equation of Formula (8) to perform the learning for obtaining the tap coefficient wₙ.

In FIG. 3, a learning apparatus 40 includes a teacher data generation unit 41, a student data generation unit 42, and a learning unit 43.

A learning image used for the learning of the tap coefficient wₙ (image as a sample for learning) is supplied to the teacher data generation unit 41 and the student data generation unit 42. An example of the learning image that can be used includes a high-quality image with high resolution.

The teacher data generation unit 32 uses the learning image to generate teacher data as a teacher (true value) of the learning of the tap coefficient, that is, teacher data to be obtained in the adaptive classification process, which is a teacher image as a mapping destination of mapping in the prediction computation based on Formula (1), and supplies the teacher image to the learning unit 43. Here, for example, the teacher data generation unit 32 sets, as a teacher image, the high-quality image that is a learning image and supplies the teacher image to the learning unit 43.

The student data generation unit 42 uses the learning image to generate student data as a student of the learning of the tap coefficient, that is, student data as a target of prediction computation with respect to the tap coefficient in the adaptive classification process, which is a student image as a target of conversion in mapping in the prediction computation based on Formula (1), and supplies the student image to the learning unit 43. Here, the student data generation unit 42 uses, for example, the LPF (Low Pass Filter) to filter the high-quality image as a learning image to reduce the resolution to generate a low-quality image and supplies the low-quality image as a student image to the learning unit 43.

The learning unit 43 sequentially sets, as a target pixel, a pixel included in the student image as student data from the student data generation unit 42 and selects, as a prediction tap, the pixel from the student image that is in the same tap structure as the tap structure selected by the tap selection unit 21 of FIG. 2 regarding the target pixel. The learning unit 43 further uses the corresponding pixel included in the teacher image corresponding to the target pixel and the prediction tap of the target pixel to establish and solve the normal equation of Formula (8) for each class to thereby obtain the tap coefficients of each class.

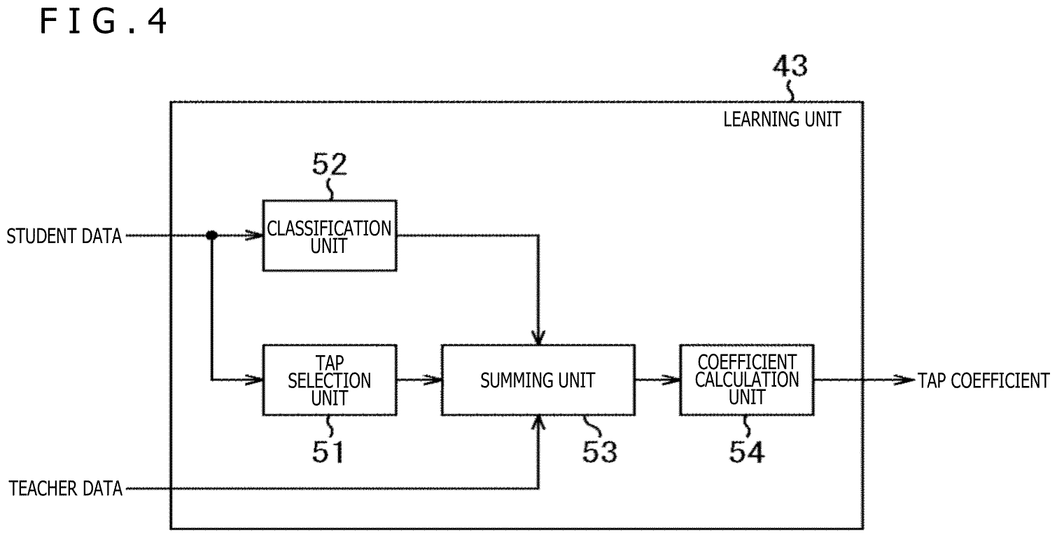

FIG. 4 is a block diagram illustrating a configuration example of the learning unit 43 of FIG. 3.

In FIG. 4, the learning unit 43 includes a tap selection unit 51, a classification unit 52, a summing unit 53, and a coefficient calculation unit 54.

The student image (student data) is supplied to the tap selection unit 51 and the classification unit 52, and the teacher image (teacher data) is supplied to the summing unit 53.

The tap selection unit 51 sequentially selects a pixel included in the student image as a target pixel and supplies information indicating the target pixel to necessary blocks.

Regarding the target pixel, the tap selection unit 51 further selects, as a prediction tap, the same pixel as the pixel selected by the tap selection unit 21 of FIG. 2 from the pixels included in the student image to thereby obtain the prediction tap in the same tap structure as the tap structure obtained by the tap selection unit 21 and supplies the prediction tap to the summing unit 53.

Regarding the target pixel, the classification unit 52 uses the student image to perform the same classification as the classification performed by the classification unit 22 of FIG. 2 and outputs the class code corresponding to the class of the target pixel obtained as a result of the classification to the summing unit 53.

For example, regarding the target pixel, the classification unit 52 selects, as a class tap, the same pixel as the pixel selected by the classification unit 22 of FIG. 2 from the pixels included in the student image to thereby form a class tap with the same tap structure as the tap structure obtained by the classification unit 22. Furthermore, the classification unit 52 uses the class tap of the target pixel to perform the same classification as the classification performed by the classification unit 22 of FIG. 2 and outputs the class code corresponding to the class of the target pixel obtained as a result of the classification to the summing unit 53.

The summing unit 53 acquires the corresponding pixel (pixel value of the corresponding pixel) corresponding to the target pixel from the pixels included in the teacher image (teacher data) and sums, for each class code supplied from the classification unit 52, the corresponding pixel and the pixel (pixel value of the pixel) of the student image included in the prediction tap regarding the target pixel supplied from the tap selection unit 51.

That is, the corresponding pixel yₖ of the teacher image as teacher data, the prediction tap x_{n,k} of the target pixel as student data, and the class code indicating the class of the target pixel are supplied to the summing unit 53.

For each class of the target pixel, the summing unit 53 uses the prediction tap (student data) x_{n,k} to perform computation equivalent to the multiplication (x_{n,k}x_{n′,k}) of the student data and the summation (Σ) in the matrix on the left-hand side of Formula (8).

Furthermore, for each class of the target pixel, the summing unit 53 also uses the prediction tap (student data) x_{n,k} and the teacher data yₖ to perform computation equivalent to the multiplication (x_{n,k}yₖ) of the student data x_{n,k} and the teacher data yₖ and the summation (Σ) in the vector on the right-hand side of Formula (8).

That is, the summing unit 53 stores, in a built-in memory of the summing unit 53 (not illustrated), the component (Σx_{n,k}x_{n′,k}) of the matrix on the left-hand side and the component (Σx_{n,k}yₖ) of the vector on the right-hand side in Formula (8) obtained for the corresponding pixel corresponding to the target pixel as teacher data of the last time. For the teacher data as a corresponding pixel corresponding to a new target pixel, the summing unit 53 sums the corresponding component x_{n,x+1}x_{n′,k+1} or x_{n,k+1}yₖ₊₁ calculated by using the teacher data yₖ₊₁ and the student data x_{n,K+1} to the component (Σx_{n,k}x_{n′,k}) of the matrix or the component (Σx_{n,k}yₖ) of the vector (performs the addition indicated by the summation of Formula (8)).

Furthermore, for example, the summing unit 53 sets all the pixels of the student image as target pixels to perform the summing to thereby establish the normal equation indicated in Formula (8) for each class and supplies the normal equations to the coefficient calculation unit 54.

The coefficient calculation unit 54 solves the normal equation for each class supplied from the summing unit 53 to obtain and output the optimal tap coefficients wₙ for each class.

The tap coefficients wₙ of each class obtained as described above can be stored in the coefficient acquisition unit 23 in the image conversion apparatus 20 of FIG. 2.

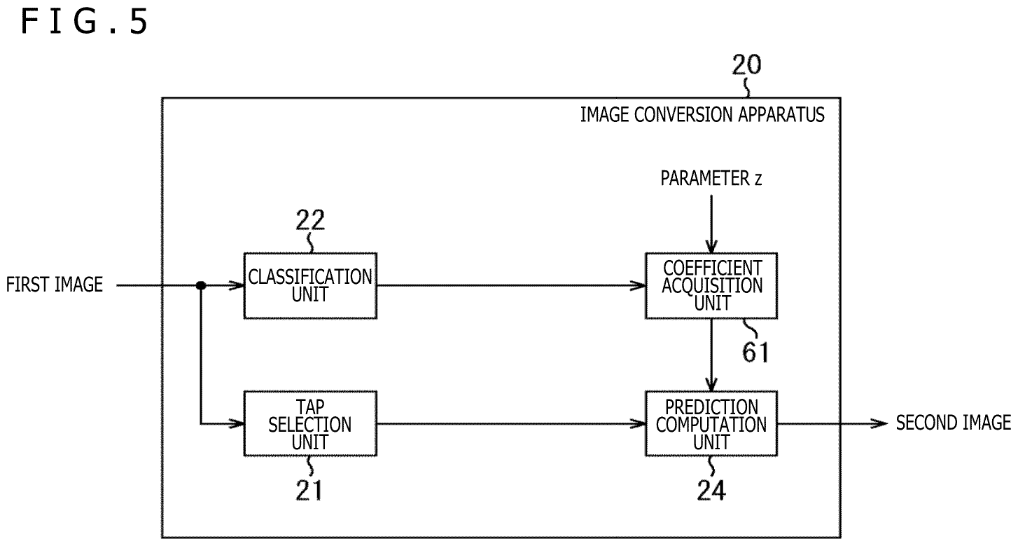

FIG. 5 is a block diagram illustrating a second configuration example of the image conversion apparatus that executes the adaptive classification process.

Note that in FIG. 5, the same reference signs are provided to the parts corresponding to the case of FIG. 2, and the description will be appropriately skipped.

In FIG. 5, the image conversion apparatus 20 includes the tap selection unit 21, the classification unit 22, the prediction computation unit 24, and a coefficient acquisition unit 61.

Therefore, the image conversion apparatus 20 of FIG. 5 is in common with the case of FIG. 2 in that the image conversion apparatus 20 includes the tap selection unit 21, the classification unit 22, and the prediction computation unit 24.

However, FIG. 5 is different from the case of FIG. 2 in that the coefficient acquisition unit 61 is provided in place of the coefficient acquisition unit 23.

The coefficient acquisition unit 61 stores seed coefficients described later. Furthermore, a parameter z is supplied to the coefficient acquisition unit 61 from the outside.

The coefficient acquisition unit 61 uses the seed coefficients to generate and store tap coefficients of each class corresponding to the parameter z and uses the tap coefficients for each class to acquire the tap coefficients of the class from the classification unit 22. The coefficient acquisition unit 61 supplies the tap coefficients to the prediction computation unit 24.

Here, although the coefficient acquisition unit 23 of FIG. 2 stores the tap coefficients, the coefficient acquisition unit 61 of FIG. 5 stores the seed coefficients. The parameter z can be provided (decided) to generate the tap coefficients from the seed coefficients, and from this viewpoint, it can be assumed that the seed coefficients are information equivalent to the tap coefficients. In the present specification, it is assumed that the tap coefficients include, in addition to the tap coefficients, the seed coefficients that allow to generate the tap coefficients, as necessary.

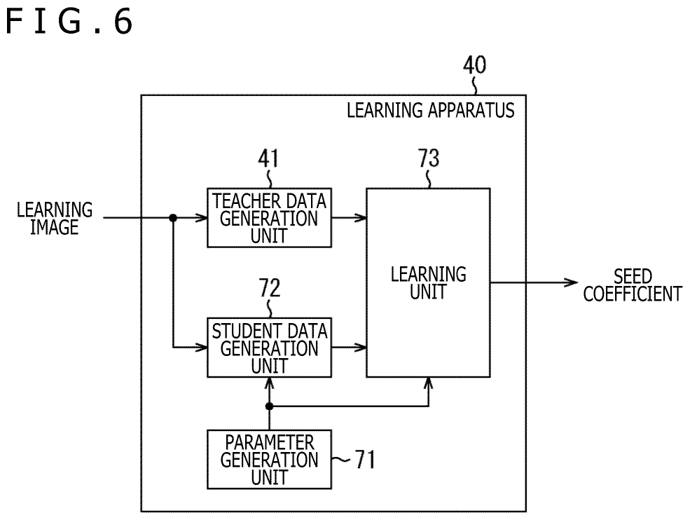

FIG. 6 is a block diagram illustrating a configuration example of the learning apparatus that performs learning for obtaining the seed coefficients stored in the coefficient acquisition unit 61.

In an example considered here, the second image is an image with high quality (high-quality image), and the first image is an image with low quality (low-quality image) obtained by reducing the spatial resolution of the high-quality image as in the case described in FIG. 3. The prediction tap is selected from the low-quality image, and the prediction tap and the tap coefficients are used to obtain (predict) the pixel value of the high-quality pixel that is a pixel of the high-quality image based on, for example, the linear first-order prediction computation of Formula (1).

Now, it is assumed that the tap coefficient wₙ is generated by the following formula using the seed coefficients and the parameter z.

$$\begin{matrix}[ Math . 9 ] & \\ {w}_{n} = {\sum }_{m = 1}^{M} {β}_{m , n} {z}^{m - 1} & ( 9 )\end{matrix}$$

Here, β_{m,n} in Formula (9) denotes an mth seed coefficient used for obtaining an nth tap coefficient wₙ. Note that in Formula (9), the tap coefficient wₙ is obtained by using M seed coefficients, β_{1,n}, β_{2,n}, . . . , β_{M,n}.

Here, the equation for obtaining the tap coefficient wₙ from the seed coefficient β_{m,n} and the parameter z is not limited to Formula (9).

Now, a new variable tₘ is introduced, and a value z^{m-1} determined by the parameter z in Formula (9) is defined by the following formula.

[Math. 10]

tₘ=z^{m-1} (m=1,2, . . . ,M) (10)

The following formula is obtained by assigning Formula (10) to Formula (9).

$$\begin{matrix}[ Math . 11 ] & \\ {w}_{n} = {\sum }_{m = 1}^{M} {β}_{m , n} {t}_{m} & ( 11 )\end{matrix}$$

According to Formula (11), the tap coefficient wₙ is obtained by a linear first-order equation of the seed coefficient β_{m,n} and the variable tₘ.

Incidentally, a prediction error eₖ between yₖ and y_{k′} is now represented by the following formula, where yₖ represents a true value of the pixel value of the high-quality pixel of a kth sample, and y_{k′} represents a predicted value of the true value yₖ obtained by Formula (1).

[Math. 12]

eₖ=yₖ−y_{k′} (12)

Now, the predicted value y_{k′} of Formula (12) is obtained according to Formula (1), and y_{k′} of Formula (12) is replaced according to Formula (1) to obtain the following formula.

$$\begin{matrix}[ Math . 13 ] & \\ {e}_{k} = {y}_{k} - ( {\sum }_{n = 1}^{N} {w}_{n} {x}_{n , k} ) & ( 13 )\end{matrix}$$

Here, x_{n,k} in Formula (13) represents an nth low-quality pixel included in the prediction tap for the high-quality pixel of the kth sample as a corresponding pixel.

The following formula is obtained by assigning Formula (11) to wₙ of Formula (13).

$$\begin{matrix}[ Math . 14 ] & \\ {e}_{k} = {y}_{k} - ( {\sum }_{n = 1}^{N} ( {\sum }_{m = 1}^{M} {β}_{m , n} {t}_{m} ) {x}_{n , k} ) & ( 14 )\end{matrix}$$

Although the seed coefficient β_{m,n} is optimal for predicting the high-quality pixel when the prediction error eₖ of Formula (14) is 0, it is generally difficult to obtain such a seed coefficient β_{m,n} for all the high-quality pixels.

Therefore, when, for example, a least-squares method is adopted as a standard indicating that the seed coefficient β_{m,n} is optimal, the optimal seed coefficient β_{m,n} can be obtained by minimizing a sum total E of square errors represented by the following formula.

$$\begin{matrix}[ Math . 15 ] & \\ E = {\sum }_{k = 1}^{K} {{e}_{k}}^{2} & ( 15 )\end{matrix}$$

Here, K in Formula (15) represents the number of samples (the number of samples for learning) of a set of the high-quality pixel yₖ as a corresponding pixel and low-quality pixels x_{1,k}, x_{2,k}, . . . , x_{N,k} included in the prediction tap for the high-quality pixel yₖ.

A minimum value (lowest value) of the sum total E of square errors in Formula (15) is provided by β_{m,n} where the partial derivative of the sum total E with respect to the seed coefficient β_{m,n} is 0 as indicated in Formula (16).

$$\begin{matrix}[ Math . 16 ] & \\ \frac{\partial E}{\partial {β}_{m , n}} = {\sum }_{k = 1}^{K} 2 \cdot \frac{\partial {e}_{k}}{\partial {β}_{m , n}} \cdot {e}_{k} = 0 & ( 16 )\end{matrix}$$

The following formula is obtained by assigning Formula (13) to Formula (16).

$$\begin{matrix}[ Math . 17 ] & \\ {\sum }_{k = 1}^{K} {t}_{m} {x}_{n , k} {e}_{k} = {\sum }_{k = 1}^{K} {t}_{m} {x}_{n , k} ( {y}_{k} - ( {\sum }_{n = 1}^{N} ( {\sum }_{m = 1}^{M} {β}_{m , n} {t}_{m} ) {x}_{n , k} ) = 0 & ( 17 )\end{matrix}$$

Now, X_{i,p,j,q} and Y_{i,p} are defined as indicated in Formulas (18) and (19).

$$\begin{matrix} [ Math . 18 ] & \\ {X}_{i , p , j , q} = {\sum }_{k = 1}^{K} {x}_{i , k} {t}_{p} {x}_{j , k} {t}_{q} \\ ( i = 1 , 2 , . . . , \text{N: j} = 1 , 2 , . . . , \\ \text{N: p} = 1 , 2 , . . . , \text{M: q} = 1 , 2 , . . . , M ) & ( 18 ) \\ [ Math . 19 ] & \\ {Y}_{i , p} = {\sum }_{k = 1}^{K} {x}_{i , k} {t}_{p} {y}_{k} & ( 19 )\end{matrix}$$

In this case, Formula (17) can be represented by a normal equation indicated in Formula (20) using X_{i,p,j,q} and

$$\begin{matrix} [ Math . 20 ] & \\ [ \begin{matrix}{X}_{1 , 1 , 1 , 1} & {X}_{1 , 1 , 1 , 2} & … & {X}_{1 , 1 , 1 , M} & {X}_{1 , 1 , 2 , 1} & … & {X}_{1 , 1 , N , M} \\ {X}_{1 , 2 , 1 , 1} & {X}_{1 , 2 , 1 , 2} & … & {X}_{1 , 2 , 1 , M} & {X}_{1 , 2 , 2 , 1} & … & {X}_{1 , 2 , N , M} \\ ⋮ & ⋮ & ⋱ & ⋮ & ⋮ & & ⋮ \\ {X}_{1 , M , 1 , 1} & {X}_{1 , M , 1 , 2} & … & {X}_{1 , M , 1 , M} & {X}_{1 , M , 2 , 1} & … & {X}_{1 , M , N , M} \\ {X}_{2 , 1 , 1 , 1} & {X}_{2 , 1 , 1 , 2} & … & {X}_{2 , M , 1 , M} & {X}_{2 , M , 2 , 1} & … & {X}_{2 , M , N , M} \\ ⋮ & ⋮ & & ⋮ & ⋮ & ⋱ & ⋮ \\ {X}_{N , M , 1 , 1} & {X}_{N , M , 1 , 2} & … & {X}_{N , M , 1 , M} & {X}_{N , M , 2 , M} & … & {X}_{N , M , N , M}\end{matrix} ] [ \begin{matrix}{β}_{1 , 1} \\ {β}_{2 , 1} \\ ⋮ \\ {β}_{M , 1} \\ {β}_{1 , 2} \\ ⋮ \\ {β}_{M , N}\end{matrix} ] = [ \begin{matrix}{Y}_{1 , 1} \\ {Y}_{1 , 2} \\ ⋮ \\ {Y}_{1 , M} \\ {Y}_{2 , 1} \\ ⋮ \\ {Y}_{N , M}\end{matrix} ] & ( 20 )\end{matrix}$$

The normal equation of Formula (20) can be solved for the seed coefficient β_{m,n} by using, for example, a sweep-out method (elimination method of Gauss-Jordan) or the like.

In the image conversion apparatus 20 of FIG. 5, a large number of high-quality pixels y₁, y₂, . . . , yₖ are set as teacher data, and the low-quality pixels x_{1,k}, x_{2,k}, . . . , x_{N,k} included in the prediction tap for each high-quality pixel yₖ are set as student data. The seed coefficient β_{m,n} of each class obtained by performing learning by establishing and solving the normal equation of Formula (20) for each class is stored in the coefficient acquisition unit 61. The coefficient acquisition unit 61 then generates the tap coefficient wₙ of each class according to Formula (9) based on the seed coefficient β_{m,n} and the parameter z provided from the outside. The prediction computation unit 24 uses the tap coefficient wₙ and the low-quality pixel (pixel of the first image) xₙ included in the prediction tap regarding the target pixel to calculate Formula (1) to thereby obtain the pixel value (predicted value close to the pixel value) of the high-quality pixel (corresponding pixel of the second image).

FIG. 6 is a diagram illustrating a configuration example of the learning apparatus that establishes and solves the normal equation of Formula (20) for each class to perform learning for obtaining the seed coefficient β_{m,n} of each class.

Note that in FIG. 6, the same reference signs are provided to the parts corresponding to the case of FIG. 3, and the description will be appropriately skipped.

In FIG. 6, the learning apparatus 40 includes the teacher data generation unit 41, a parameter generation unit 71, a student data generation unit 72, and a learning unit 73.

Therefore, the learning apparatus 40 of FIG. 6 is in common with the case of FIG. 3 in that the learning apparatus 40 includes the teacher data generation unit 41.

However, the learning apparatus 40 of FIG. 6 is different from the case of FIG. 3 in that the learning apparatus 40 additionally includes the parameter generation unit 71. Furthermore, the learning apparatus 40 of FIG. 6 is different from the case of FIG. 3 in that the learning apparatus 40 includes the student data generation unit 72 and the learning unit 73 in place of the student data generation unit 42 and the learning unit 43, respectively.

The parameter generation unit 71 generates some values in a possible range of the parameter z and supplies the values to the student data generation unit 72 and the learning unit 73.

For example, if the possible values of the parameter z are real numbers in a range of 0 to Z, the parameter generation unit 71 generates, for example, the parameter z with values of z=0, 1, 2, . . . , Z and supplies the parameter z to the student data generation unit 72 and the learning unit 73.

A learning image similar to the learning image supplied to the teacher data generation unit 41 is supplied to the student data generation unit 72.

The student data generation unit 72 generates student images from the learning image just like the student data generation unit 42 of FIG. 3 and supplies the student images as student data to the learning unit 73.

Here, in addition to the learning image, some values in the possible range of the parameter z are supplied from the parameter generation unit 71 to the student data generation unit 72.

The student data generation unit 72 uses, for example, an LPF with a cutoff frequency corresponding to the parameter z supplied to the student data generation unit 72 to filter the high-quality image as a learning image to thereby generate low-quality images as student images for some values of the parameter z, respectively.

That is, the student data generation unit 72 generates Z+1 types of low-quality images as student images with different spatial resolutions regarding the high-quality image as a learning image.

Note that here, for example, the larger the value of the parameter z, the higher the cutoff frequency of the LPF used. The LPF is used to filter the high-quality image to generate the low-quality images as student images. In this case, the higher the value of the parameter z, the higher the spatial resolution of the low-quality image as a student image.

The student data generation unit 72 can also generate low-quality images as student images in which the spatial resolution in one of or both the horizontal direction and the vertical direction of the high-quality image as a learning image is reduced according to the parameter z.

Furthermore, in the case of generating the low-quality images as student images in which the spatial resolution in both the horizontal direction and the vertical direction of the high-quality image as a learning image is reduced, the spatial resolution in the horizontal direction and the vertical direction of the high-quality image as a learning image can be separately reduced according to separate parameters, that is, two parameters z and z′.

In this case, the coefficient acquisition unit 23 of FIG. 5 receives two parameters z and z′ from the outside and uses the two parameters z and z′ and the seed coefficients to generate the tap coefficients.

In this way, the seed coefficients can be obtained that allow to generate the tap coefficients not only by using one parameter z, but also by using two parameters z and z′ or three or more parameters. However, an example of the seed coefficients for generating the tap coefficients by using one parameter z will be described in the present specification to simplify the description.

The learning unit 73 uses the teacher image as teacher data from the teacher data generation unit 41, the parameter z from the parameter generation unit 71, and the student images as student data from the student data generation unit 72 to obtain and output the seed coefficients of each class.

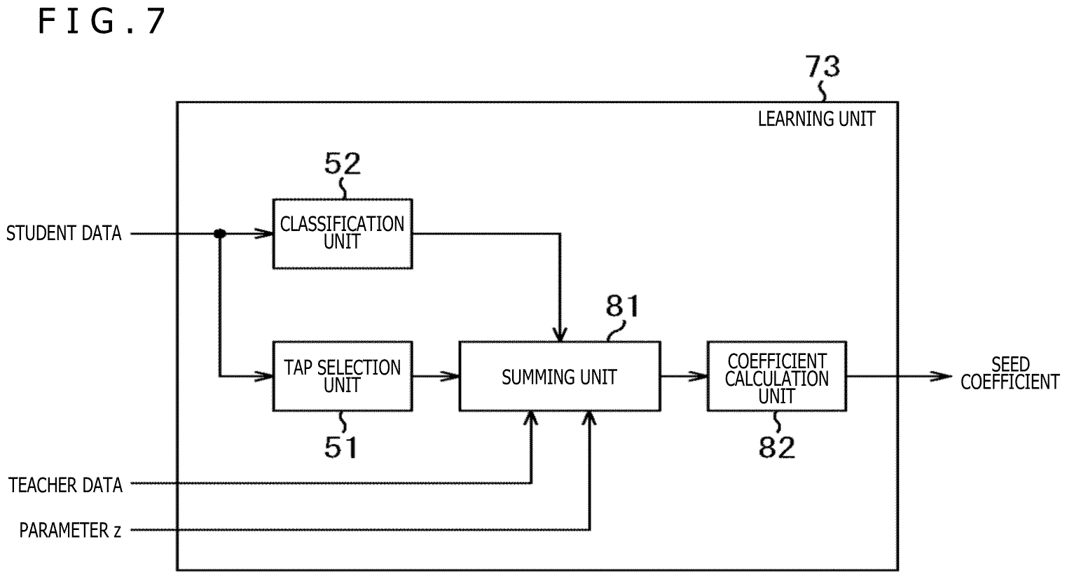

FIG. 7 is a block diagram illustrating a configuration example of the learning unit 73 of FIG. 6.

Note that in FIG. 7, the same reference signs are provided to the parts corresponding to the learning unit 43 of FIG. 4, and the description will be appropriately skipped.

In FIG. 7, the learning unit 73 includes the tap selection unit 51, the classification unit 52, a summing unit 81, and a coefficient calculation unit 82.

Therefore, the learning unit 73 of FIG. 7 is in common with the learning unit 43 of FIG. 4 in that the learning unit 73 includes the tap selection unit 51 and the classification unit 52.

However, the learning unit 73 is different from the learning unit 43 of FIG. 4 in that the learning unit 73 includes the summing unit 81 and the coefficient calculation unit 82 in place of the summing unit 53 and the coefficient calculation unit 54, respectively.

In FIG. 7, the tap selection unit 51 selects the prediction tap from the student image generated according to the parameter z generated by the parameter generation unit 71 of FIG. 6 (here, from the low-quality image as student data generated by using the LPF with a cutoff frequency corresponding to the parameter z) and supplies the prediction tap to the summing unit 81.

The summing unit 81 acquires a corresponding pixel corresponding to the target pixel from the teacher image from the teacher data generation unit 41 of FIG. 6, and for each class supplied from the classification unit 52, performs summing regarding the corresponding pixel, the student data (pixels of student image) included in the prediction tap regarding the target pixel supplied from the tap selection unit 51, and the parameter z in generating the student data.

That is, the teacher data yₖ as a corresponding pixel corresponding to the target pixel, the prediction tap x_{i,k}(x_{j,k}) regarding the target pixel output by the tap selection unit 51, and the class of the target pixel output by the classification unit 52 are supplied to the summing unit 81, and the parameter z in generating the student data included in the prediction tap regarding the target pixel is supplied from the parameter generation unit 71 to the summing unit 81.

In addition, for each class supplied from the classification unit 52, the summing unit 81 uses the prediction tap (student data) x_{i,k}(x_{j,k}) and the parameter z to perform computation equivalent to the multiplication (x_{i,k}tₚx_{j,k}t_{q}) of the student data and the parameter z for obtaining the component X_{i,p,j,q} and the summation (Σ) defined in Formula (18), in the matrix on the left-hand side of Formula (20). Note that tₚ of Formula (18) is calculated from the parameter z according to Formula (10). In Formula (18), t_{q} is also calculated in a similar way.

Furthermore, for each class supplied from the classification unit 52, the summing unit 81 also uses the prediction tap (student data) x_{i,k}, the teacher data yₖ, and the parameter z to perform computation equivalent to the multiplication (x_{1,k}tₚyₖ) of the student data x_{i,k}, the teacher data yₖ, and the parameter z for obtaining the component Y_{i,p} and the summation (Σ) defined in Formula (19), in the vector on the right-hand side of Formula (20). Note that tₚ of Formula (19) is calculated from the parameter z according to Formula (10).

That is, the summing unit 81 stores, in a built-in memory of the summing unit 81 (not illustrated), the component X_{i,p,j,q} of the matrix on the left-hand side and the component Y_{i,p} of the vector on the right-hand side in Formula (20) obtained for the corresponding pixel corresponding to the target pixel as teacher data of the last time. For the teacher data as a corresponding pixel corresponding to a new target pixel, the summing unit 81 sums the corresponding component x_{i,k}tₚx_{j,k}t_{q} or x_{i,k}tₚyₖ calculated by using the teacher data yₖ, the student data x_{i,k}(x_{j,k}), and the parameter z to the component x_{i,p,j,q} of the matrix or the component Y_{i,p} of the vector (performs the addition indicated by the summation for the component X_{i,p,j,q} of Formula (18) or the component Y_{i,p} of Formula (19)).

The summing unit 81 then sets all the pixels of the student image as target pixels and performs the summing for the parameter z of all the values of 0, 1, . . . , Z. In this way, the summing unit 81 establishes the normal equation indicated in Formula (20) for each class and supplies the normal equations to the coefficient calculation unit 82.

The coefficient calculation unit 82 solves the normal equation of each class supplied from the summing unit 81 to obtain and output the seed coefficient β_{m,n} of each class.

Incidentally, the learning apparatus 40 of FIG. 6 sets, as teacher data, the high-quality image that is a learning image and sets, as student data, the low-quality images in which the spatial resolution of the high-quality image is degraded according to the parameter z. The learning apparatus 40 performs the learning for obtaining the seed coefficient β_{m,n} for directly minimizing the sum total of the square errors of the predicted value y of the teacher data predicted by the linear first-order equation of Formula (1) based on the tap coefficient wₙ and the student data xₙ. However, for the learning of the seed coefficient β_{m,n}, the learning apparatus 40 can perform learning for obtaining the seed coefficient β_{m,n} for, so to say, indirectly minimizing the sum total of the square errors of the predicted value y of the teacher data.

That is, the high-quality image that is a learning image can be set as teacher data, and low-quality images can be set as student data in which the LPF with the cutoff frequency corresponding to the parameter z is used to filter the high-quality image to reduce the horizontal resolution and the vertical resolution of the high-quality image. The tap coefficient wₙ and the student data xₙ can be used to obtain, for each value of the parameter z (here, z=0, 1, . . . , Z), the tap coefficient wₙ that minimizes the sum total of the square errors of the predicted value y of the teacher data predicted by the linear first-order prediction equation of Formula (1). The tap coefficient wₙ obtained for each value of the parameter z can then be set as teacher data, and the parameter z can be set as student data. Formula (11) can be used to obtain the seed coefficient β_{m,n} that minimizes the sum total of the square errors of the predicted value of the tap coefficient wₙ as teacher data predicted from the seed coefficient β_{m,n} and the variable tₘ corresponding to the parameter z that is student data.

Here, the tap coefficient wₙ that minimizes (miniaturizes) the sum total E of the square errors of the predicted value y of the teacher data predicted by the linear first-order prediction equation of Formula (1) can be obtained for each value (z=0, 1, . . . , Z) of the parameter z in each class by establishing and solving the normal equation of Formula (8) as in the case of the learning apparatus 40 of FIG. 3.

Incidentally, as indicated in Formula (11), the tap coefficient is obtained from the seed coefficient β_{m,n} and the variable tₘ corresponding to the parameter z. In addition, assuming now that w_{n′} represents the tap coefficient obtained by Formula (11), the seed coefficient β_{m,n} is an optimal seed coefficient for obtaining the optimal tap coefficient wₙ when an error eₙ represented by the following Formula (21) between the optimal tap coefficient wₙ and the tap coefficient w_{n′} obtained by Formula (11) is 0. However, it is generally difficult to obtain such a seed coefficient β_{m,n} for all the tap coefficients wₙ.

[Math. 21]

eₙ=wₙ−w_{n′} (21)

Note that Formula (21) can be modified as in the following formula based on Formula (11).

$$\begin{matrix}[ Math . 22 ] & \\ {e}_{n} = {w}_{n} - ( {\sum }_{m = 1}^{M} {β}_{m , n} {t}_{m} ) & ( 22 )\end{matrix}$$

Therefore, when, for example, a least-squares method is also adopted as a standard indicating that the seed coefficient β_{m,n} is optimal, the optimal seed coefficient β_{m,n} can be obtained by minimizing the sum total E of the square errors represented by the following formula.

$$\begin{matrix}[ Math . 23 ] & \\ E = {\sum }_{n = 1}^{N} {{e}_{n}}^{2} & ( 23 )\end{matrix}$$

A minimum value (lowest value) of the sum total E of the square errors in Formula (23) is provided by β_{m,n} where the partial derivative of the sum total E with respect to the seed coefficient β_{m,n} is 0 as indicated in Formula (24).

$$\begin{matrix}[ Math . 24 ] & \\ \frac{\partial E}{\partial {β}_{m , n}} = {\sum }_{m = 1}^{M} 2 \frac{\partial {e}_{n}}{\partial {β}_{m , n}} \cdot {e}_{n} = 0 & ( 24 )\end{matrix}$$

The following formula can be obtained by assigning Formula (22) to Formula (24).

$$\begin{matrix}[ Math . 25 ] & \\ {\sum }_{m = 1}^{M} {t}_{m} ( {w}_{n} - ( {\sum }_{m = 1}^{M} {β}_{m , n} {t}_{m} ) ) = 0 & ( 25 )\end{matrix}$$

Now, X_{i,j} and Yᵢ are defined as indicated in Formulas (26) and (27).

$$\begin{matrix}[ Math . 26 ] & \\ \begin{matrix}{X}_{i , j} = {\sum }_{z = 0}^{Z} {t}_{i} {t}_{j} & ( i = 1 , 2 , . . . , \text{M: j} = 1 , 2 , . . . , M )\end{matrix} & ( 26 ) \\ [ Math . 27 ] & \\ {Y}_{i} = {\sum }_{z = 0}^{Z} {t}_{i} {w}_{n} & ( 27 )\end{matrix}$$

In this case, Formula (25) can be represented by a normal equation indicated in Formula (28) using X_{i,j} and Yᵢ.

$$\begin{matrix}[ Math . 28 ] & \\ [ \begin{matrix}{X}_{1 , 1} & {X}_{1 , 2} & … & {X}_{1 , M} \\ {X}_{2 , 1} & {X}_{2 , 1} & … & {X}_{2 , 2} \\ ⋮ & ⋮ & ⋱ & ⋮ \\ {X}_{M , 1} & {X}_{M , 2} & … & {X}_{M , M}\end{matrix} ] [ \begin{matrix}{β}_{1 , n} \\ {β}_{2 , n} \\ ⋮ \\ {β}_{M , n}\end{matrix} ] = [ \begin{matrix}{Y}_{1} \\ {Y}_{2} \\ ⋮ \\ {Y}_{M}\end{matrix} ] & ( 28 )\end{matrix}$$

The normal equation of Formula (28) can also be solved for the seed coefficient β_{m,n} by using, for example, a sweep-out method or the like.

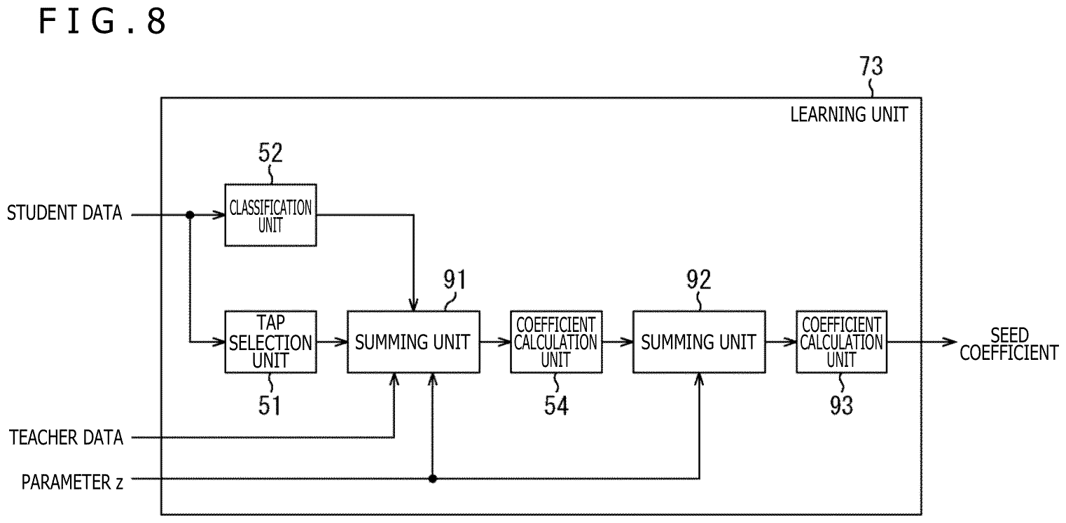

FIG. 8 is a block diagram illustrating another configuration example of the learning unit 73 of FIG. 6.

That is, FIG. 8 illustrates a configuration example of the learning unit 73 that establishes and solves the normal equation of Formula (28) to perform learning for obtaining the seed coefficient β_{m,n}.

Note that in FIG. 8, the same reference signs are provided to the parts corresponding to the case of FIG. 4 or 7, and the description will be appropriately skipped.

The learning unit 73 of FIG. 8 includes the tap selection unit 51, the classification unit 52, the coefficient calculation unit 54, summing units 91 and 92, and a coefficient calculation unit 93.

Therefore, the learning unit 73 of FIG. 8 is in common with the learning unit 43 of FIG. 4 in that the learning unit 73 includes the tap selection unit 51, the classification unit 52, and the coefficient calculation unit 54.

However, the learning unit 73 of FIG. 8 is different from the learning unit 43 of FIG. 4 in that the learning unit 73 includes the summing unit 91 in place of the summing unit 53 and additionally includes the summing unit 92 and the coefficient calculation unit 93.

The class of the target pixel output by the classification unit 52 and the parameter z output by the parameter generation unit 71 are supplied to the summing unit 91. The summing unit 91 performs summing regarding the teacher data as a corresponding pixel corresponding to the target pixel in the teacher image from the teacher data generation unit 41 and regarding the student data included in the predication tap in relation to the target pixel supplied from the tap selection unit 51, for each class supplied from the classification unit 52 and for each value of the parameter z output by the parameter generation unit 71.

That is, the teacher data yₖ, the prediction tap x_{n,k}, the class of the target pixel, and the parameter z in generating the student image included in the prediction tap x_{n,k} are supplied to the summing unit 91.

For each class of the target pixel and for each value of the parameter z, the summing unit 91 uses the prediction tap (student data) x_{n,k} to perform computation equivalent to the multiplication (x_{n,k}x_{n′,k}) of the student data and the summation (Σ) in the matrix on the left-hand side of Formula (8).

Furthermore, for each class of the target pixel and for each value of the parameter z, the summing unit 91 uses the prediction tap (student data) x_{n,k} and the teacher data yₖ to perform computation equivalent to the multiplication (x_{n,k}yₖ) of the student data x_{n,k} and the teacher data yₖ and the summation (Σ) in the vector on the right-hand side of Formula (8).

That is, the summing unit 91 stores, in a built-in memory of the summing unit 91 (not illustrated), the component (Σx_{n,k}x_{n′,k}) of the matrix on the left-hand side and the component (Σx_{n,k}yₖ) of the vector on the right-hand side in Formula (8) obtained for the corresponding pixel corresponding to the target pixel as teacher data of the last time. For the teacher data as a corresponding pixel corresponding to a new target pixel, the summing unit 91 sums the corresponding component x_{n,k+1}x_{n′,k+1} or x_{n,k+1}yₖ₊₁ calculated by using the teacher data yₖ₊₁ and the student data x_{n,k+1} to the component (Σx_{n,k}x_{n′,k}) of the matrix or the component (Σx_{n,k}yₖ) of the vector (performs the addition indicated by the summation of Formula (8)).

The summing unit 91 then sets all the pixels of the student image as target pixels and performs the summing. In this way, the summing unit 91 establishes the normal equation indicated in Formula (8) for each value of the parameter z in each class and supplies the normal equations to the coefficient calculation unit 54.

Therefore, the summing unit 91 establishes the normal equation of Formula (8) for each class just like the summing unit 53 of FIG. 4. However, the summing unit 91 is different from the summing unit 53 of FIG. 4 in that the summing unit 91 further establishes the normal equation of Formula (8) for each value of the parameter z.

The coefficient calculation unit 54 solves the normal equation for each value of the parameter z in each class supplied from the summing unit 91 to obtain the optimal tap coefficient wₙ of each value of the parameter z for each class and supplies the tap coefficients wₙ to the summing unit 92.

For each class, the summing unit 92 performs the summing regarding the parameter z (variable tₘ corresponding to the parameter z) supplied from the parameter generation unit 71 (FIG. 6) and regarding the optimal tap coefficient wₙ supplied from the coefficient calculation unit 54.

That is, for each class, the summing unit 92 uses the variables tᵢ(tⱼ) obtained by Formula (10) based on the parameter z supplied from the parameter generation unit 71 and performs computation equivalent to the multiplication (tᵢtⱼ) of the variables tᵢ(tⱼ) corresponding to the parameter z and the summation (Σ) for obtaining the component x_{i,j} defined by Formula (26) in the matrix on the left-hand side of Formula (28).

Here, the component X_{i,j} is determined only by the parameter z and is not related to the class. Therefore, the calculation of the component X_{i,j} actually does not have to be performed for each class, and the calculation needs to be performed just once.

Furthermore, for each class, the summing unit 92 uses the variable tᵢ obtained by Formula (10) based on the parameter z supplied from the parameter generation unit 71 and the optimal tap coefficient wₙ supplied from the coefficient calculation unit 54 to perform computation equivalent to the multiplication (tᵢwₙ) of the variable tᵢ corresponding to the parameter z and the optimal tap coefficient wₙ and the summation (Σ) for obtaining the component Yᵢ defined by Formula (27) in the vector on the right-hand side of Formula (28).

The summing unit 92 obtains the component X_{i,j} represented by Formula (26) and the component Yᵢ represented by Formula (27) for each class to thereby establish the normal equation of Formula (28) for each class and supplies the normal equations to the coefficient calculation unit 93.

The coefficient calculation unit 93 solves the normal equation of Formula (28) for each class supplied from the summing unit 92 to obtain and output the seed coefficient β_{m,n} of each class.

The coefficient acquisition unit 61 of FIG. 5 can store the seed coefficient β_{m,n} of each class obtained in this way.

Note that in the learning of the seed coefficients, seed coefficients for executing various image conversion processes can also be obtained depending on the method of selecting the images to be set as the student data corresponding to the first image and the teacher data corresponding to the second image, as in the case of learning the tap coefficients.

That is, in the case described above, the learning of the seed coefficients is performed by setting the learning image as the teacher data corresponding to the second image and setting the low-quality image obtained by degrading the spatial resolution of the learning image as the student data corresponding to the first image. This can obtain seed coefficients for executing an image conversion process as a spatial resolution creation process of converting the first image into the second image with improved spatial resolution.

In this case, the image conversion apparatus 20 of FIG. 5 can improve the horizontal resolution and the vertical resolution of the image to the resolution corresponding to the parameter z.

In addition, for example, the learning of the seed coefficients is performed by setting the high-quality image as the teacher data and superimposing noise in a level corresponding to the parameter z on the high-quality image as the teacher data to set the image as the student data. This can obtain seed coefficients for executing an image conversion process as a noise removal process of converting the first image into the second image in which the noise included in the first image is removed (reduced). In this case, the image conversion apparatus 20 of FIG. 5 can obtain an image with S/N corresponding to the parameter z (image after noise removal in a degree corresponding to the parameter z).

Note that in the case described above, the tap coefficient wₙ is defined by β_{1,n}z⁰+β_{2,n}z¹+ . . . +β_{M,n}z^{m-1} as indicated in Formula (9) to obtain the tap coefficient wₙ for improving the spatial resolution in both the horizontal and vertical directions according to the parameter z based on Formula (9). However, the tap coefficient wₙ can also be obtained to independently improve the horizontal resolution and the vertical resolution according to independent parameters zₓ and z_{y}, respectively.

That is, the tap coefficient wₙ is defined by, for example, a cubic equation β_{1,n}zₓ⁰z_{y}⁰+β_{2,n}zₓ¹z_{y}⁰+β_{3,n}zₓ²z_{y}⁰+β_{4,n}zₓ³z_{y}⁰+β_{5,n}zₓ⁰z_{y}¹+β_{6,n}zₓ⁰z_{y}²+β_{7,n}zₓ⁰z_{y}³+β_{8,n}zₓ¹z_{y}¹+β_{9,n}zₓ²z_{y}¹+β_{10,n}zₓ¹z_{y}² in place of Formula (9), and the variable tₘ defined in Formula (10) is defined by, for example, t₁=zₓ⁰z_{y}⁰, t₂=zₓ¹z_{y}⁰, t₃=zₓ²z_{y}⁰, t₄=zₓ³z_{y}⁰, t₅=zₓ⁰z_{y}¹, t₆=zₓ⁰z_{y}², t₇=zₓ⁰z_{y}³, t₈=zₓ¹z_{y}¹, t₉=zₓ²z_{y}¹, t₁₀=zₓ¹z_{y}², in place of Formula (10). In this case, the tap coefficient wₙ can also be ultimately represented by Formula (11). Therefore, the learning apparatus 40 of FIG. 6 can degrade the horizontal resolution and the vertical resolution of the teacher data according to the parameters zₓ and z_{y}, respectively, and use the image as student data to perform the learning to obtain the seed coefficient β_{m,n}. In this way, the learning apparatus 40 can obtain the tap coefficient wₙ for independently improving the horizontal resolution and the vertical resolution according to the independent parameters zₓ and z_{y}, respectively.

In addition, for example, a parameter zₜ corresponding to the resolution in the time direction can be further introduced in addition to the parameters zₓ and z_{y} corresponding to the horizontal resolution and the vertical resolution, respectively, to obtain the tap coefficient wₙ for independently improving the horizontal resolution, the vertical resolution, and the temporal resolution according to the independent parameters zₓ, z_{y}, and zₜ, respectively.

Furthermore, the learning apparatus 40 of FIG. 6 can degrade the horizontal resolution and the vertical resolution of the teacher data according to the parameter zₓ and add noise to the teacher data according to the parameter z_{y} to use the image as student data to perform the learning. In this way, the learning apparatus 40 can obtain the seed coefficient β_{m,n} to obtain the tap coefficient wₙ for improving the horizontal resolution and the vertical resolution according to the parameter zₓ and for removing the noise according to the parameter z_{y}.

### <First Configuration Example of Encoding Apparatus 11>

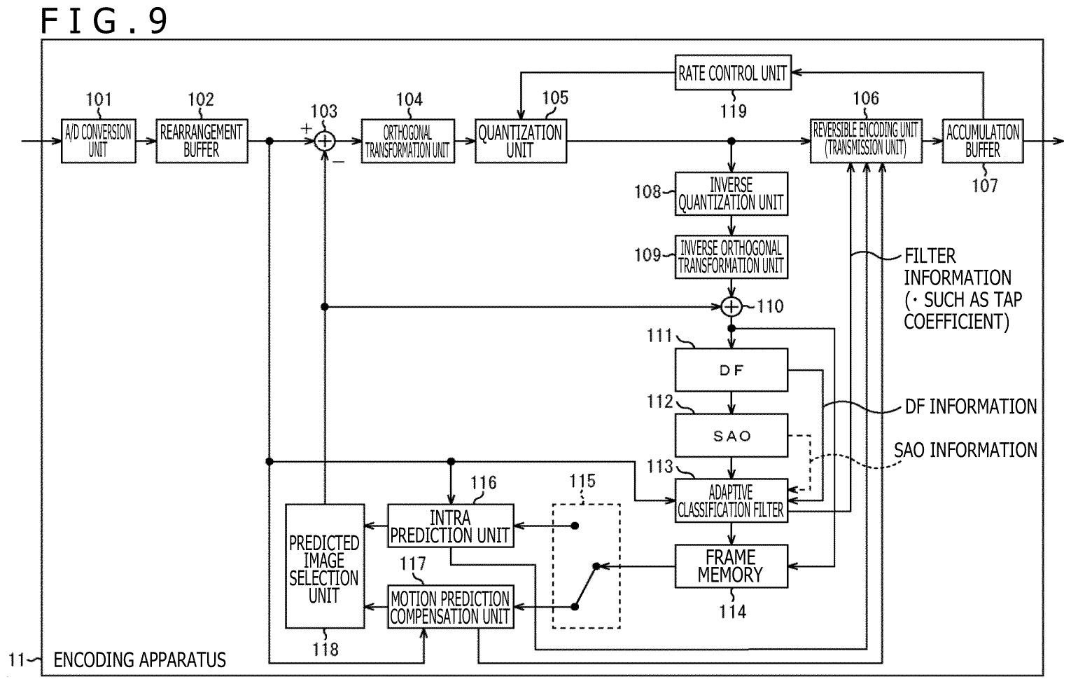

FIG. 9 is a block diagram illustrating a first configuration example of the encoding apparatus 11 of FIG. 1.

In FIG. 9, the encoding apparatus 11 includes an A/D conversion unit 101, a rearrangement buffer 102, a computation unit 103, an orthogonal transformation unit 104, a quantization unit 105, a reversible encoding unit 106, and an accumulation buffer 107. The encoding apparatus 11 further includes an inverse quantization unit 108, an inverse orthogonal transformation unit 109, a computation unit 110, a DF 111, an SAO 112, an adaptive classification filter 113, a frame memory 114, a selection unit 115, an intra prediction unit 116, a motion prediction compensation unit 117, a predicted image selection unit 118, and a rate control unit 119.

The A/D conversion unit 101 performs A/D conversion of an original image in an analog signal into an original image in a digital signal and supplies and stores the original image in the rearrangement buffer 102.

The rearrangement buffer 102 rearranges frames of the original image from an order of display to an order of encoding (decoding) according to GOP (Group Of Picture) and supplies the frames to the computation unit 103, the intra prediction unit 116, the motion prediction compensation unit 117, and the adaptive classification filter 113.

The computation unit 103 subtracts, from the original image from the rearrangement buffer 102, a predicted image supplied from the intra prediction unit 116 or the motion prediction compensation unit 117 through the predicted image selection unit 118 and supplies a residual (predicted residual) obtained by the subtraction to the orthogonal transformation unit 104.

For example, in a case of an image in inter encoding, the computation unit 103 subtracts the predicted image supplied from the motion prediction compensation unit 117 from the original image read from the rearrangement buffer 102.

The orthogonal transformation unit 104 applies an orthogonal transformation, such as a discrete cosine transform and a Karhunen-Loeve transform, to the residual supplied from the computation unit 103. Note that the method of the orthogonal transformation is arbitrary. The orthogonal transformation unit 104 supplies a transformation coefficient obtained by the orthogonal exchange to the quantization unit 105.

The quantization unit 105 quantizes the transformation coefficient supplied from the orthogonal transformation unit 104. The quantization unit 105 sets a quantization parameter QP based on a target value of a code amount (code amount target value) supplied from the rate control unit 119 and quantizes the transformation coefficient. Note that the method of the quantization is arbitrary. The quantization unit 105 supplies the quantized transformation coefficient to the reversible encoding unit 106.

The reversible encoding unit 106 uses a predetermined reversible encoding system to encode the transformation coefficient quantized by the quantization unit 105. The transformation coefficient is quantized under the control of the rate control unit 119, and the code amount of the encoded data obtained by the reversible encoding of the reversible encoding unit 106 is a code amount target value set by the rate control unit 119 (or close to the code amount target value).

The reversible encoding unit 106 also acquires, from each block, necessary encoded information in the encoded information regarding prediction encoding by the encoding apparatus 11.

Here, examples of the encoded information include a prediction mode of intra prediction or inter prediction, motion information such as a motion vector, the code amount target value, the quantization parameter QP, a picture type (I, P, B), information of CU (Coding Unit) or CTU (Coding Tree Unit), and the like.

For example, the prediction mode can be acquired from the intra prediction unit 116 or the motion prediction compensation unit 117. In addition, the motion information can be acquired from, for example, the motion prediction compensation unit 117.

Other than acquiring the encoded information, the reversible encoding unit 106 acquires filter information regarding the adaptive classification process in the adaptive classification filter 113 from the adaptive classification filter 113. In FIG. 9, the filter information includes the tap coefficients of each class as necessary.

The reversible encoding unit 106 uses an arbitrary reversible encoding system to encode the encoded information and the filter information and sets (multiplexes) the information as part of header information of the encoded data.

The reversible encoding unit 106 transmits the encoded data through the accumulation buffer 107. Therefore, the reversible encoding unit 106 functions as a transmission unit that transmits the encoded data, that is, the encoded information and the filter information included in the encoded data.

Examples of the reversible encoding system of the reversible encoding unit 106 that can be adopted include variable length coding and arithmetic coding. An example of the variable length coding includes CAVLC (Context-Adaptive Variable Length Coding) defined in an H.264/AVC system. An example of the arithmetic coding includes CABAC (Context-Adaptive Binary Arithmetic Coding).

The accumulation buffer 107 temporarily accumulates the encoded data supplied from the reversible encoding unit 106. The encoded data accumulated in the accumulation buffer 107 is read and transmitted at predetermined timing.

The transformation coefficient quantized by the quantization unit 105 is supplied to the reversible encoding unit 106 and is also supplied to the inverse quantization unit 108. The inverse quantization unit 108 uses a method corresponding to the quantization by the quantization unit 105 to perform inverse quantization of the quantized transformation coefficient. The method of inverse quantization can be any method as long as the method corresponds to the quantization process of the quantization unit 105. The inverse quantization unit 108 supplies the transformation coefficient obtained by the inverse quantization to the inverse orthogonal transformation unit 109.

The inverse orthogonal transformation unit 109 uses a method corresponding to the orthogonal transformation process of the orthogonal transformation unit 104 to perform an inverse orthogonal transformation of the transformation coefficient supplied from the inverse quantization unit 108. The method of inverse orthogonal transformation may be any method corresponding to the orthogonal transformation process of the orthogonal transformation unit 104. The output (restored residual) after the inverse orthogonal transformation is supplied to the computation unit 110.

The computation unit 110 adds the predicted image supplied from the intra prediction unit 116 or the motion prediction compensation unit 117 through the predicted image selection unit 118 to the inverse orthogonal transformation result supplied from the inverse orthogonal transformation unit 109, that is, the restored residual, and outputs the addition result as an image being decoded that is being decoded.

The image being decoded output by the computation unit 110 is supplied to the DF 111 or the frame memory 114.

The DF 111 applies a filtering process of DF to the image being decoded from the computation unit 110 and supplies the image being decoded after the filtering process to the SAO 112.

The SAO 112 applies a filtering process of SAO to the image being decoded from the DF 111 and supplies the image being decoded to the adaptive classification filter 113.

Through an adaptive classification process, the adaptive classification filter 113 uses a filter that functions as the ALF among the DF, the SAO, and the ALF that are ILFs and executes a filtering process equivalent to the ALF based on the adaptive classification process.

The image being decoded is supplied from the SAO 112 to the adaptive classification filter 113, and the original image corresponding to the image being decoded is supplied from the rearrangement buffer 102 to the adaptive classification filter 113. In addition, previous-stage filter related information regarding the filtering process of the DF 111 or the SAO 112 as a previous-stage filtering process executed in a previous stage of the filtering process of the adaptive classification filter 113 is supplied to the adaptive classification filter 113.

Here, the previous-stage filter related information regarding the filtering process of the DF 111 that executes the filtering process as a previous-stage filtering process will also be referred to as DF information, and the previous-stage filter related information regarding the filtering process of the SAO 112 that executes the filtering process as a previous-stage filtering process will also be referred to as SAO information.

The adaptive classification filter 113 uses the student image equivalent to the image being decoded from the SAO 112 and the teacher image equivalent to the original image from the rearrangement buffer 102 and also uses the DF information and the SAO information as previous-stage filtering process information as necessary to perform learning for obtaining the tap coefficients of each class.

That is, for example, the adaptive classification filter 113 performs learning for obtaining the tap coefficients of each class by setting the image being decoded from the SAO 112 as a student image, setting the original image from the rearrangement buffer 102 as a teacher image, and using the DF information or the SAO information as previous-stage filtering process information. The tap coefficients of each class are supplied as filter information from the adaptive classification filter 113 to the reversible encoding unit 106.

The adaptive classification filter 113 further sets the image being decoded from the SAO 112 as a first image and uses the DF information or the SAO information as previous-stage filtering process information to execute the adaptive classification process (image conversion based on the adaptive classification process) using the tap coefficients of each class to thereby convert the image being decoded as a first image into an image after filtering as a second image equivalent to the original image (generate the image after filtering) and output the image.

The image after filtering output by the adaptive classification filter 113 is supplied to the frame memory 114.

Here, as described above, the adaptive classification filter 113 sets the image being decoded as a student image and sets the original image as a teacher image to perform learning. The adaptive classification filter 113 uses the tap coefficients obtained by the learning to execute the adaptive classification process of converting the image being decoded into the image after filtering. Therefore, the image after filtering obtained by the adaptive classification filter 113 is an image very close to the original image.

The frame memory 114 temporarily stores the image being decoded supplied from the computation unit 110 or the image after filtering supplied from the adaptive classification filter 113 as a locally decoded image. The decoded image stored in the frame memory 114 is supplied at necessary timing to the selection unit 115 as a reference image used to generate a predicted image.

The selection unit 115 selects a supply destination of the reference image supplied from the frame memory 114. For example, in a case of intra prediction by the intra prediction unit 116, the selection unit 115 supplies the reference image supplied from the frame memory 114 to the intra prediction unit 116. In addition, for example, in a case of inter prediction by the motion prediction compensation unit 117, the selection unit 115 supplies the reference image supplied from the frame memory 114 to the motion prediction compensation unit 117.

The intra prediction unit 116 uses the original image supplied from the rearrangement buffer 102 and the reference image supplied from the frame memory 114 through the selection unit 115 to perform intra prediction (prediction in screen) in which, for example, PU (Prediction Unit) is the processing unit. The intra prediction unit 116 selects an optimal intra prediction mode based on a predetermined cost function (for example, RD (Rate-Distortion) cost) and supplies a predicted image generated in the optimal intra prediction mode to the predicted image selection unit 118. The intra prediction unit 116 also appropriately supplies a prediction mode indicating the intra prediction mode selected based on the cost function as described above to the reversible encoding unit 106 and the like.

The motion prediction compensation unit 117 uses the original image supplied from the rearrangement buffer 102 and the reference image supplied from the frame memory 114 through the selection unit 115 to perform motion prediction (inter prediction) in which, for example, PU is the processing unit. The motion prediction compensation unit 117 further performs motion compensation according to a motion vector detected by motion prediction to generate a predicted image. The motion prediction compensation unit 117 uses a plurality of prepared inter prediction modes to perform inter prediction to generate the predicted image.

The motion prediction compensation unit 117 selects an optimal inter prediction mode based on a predetermined cost function of the predicted image obtained for each of the plurality of inter prediction modes. The motion prediction compensation unit 117 further supplies the predicted image generated in the optimal inter prediction mode to the predicted image selection unit 118.

The motion prediction compensation unit 117 also supplies the prediction mode indicating the inter prediction mode selected based on the cost function, the motion information such as a motion vector necessary to decode the encoded data encoded in the inter prediction mode, and the like to the reversible encoding unit 106.

The predicted image selection unit 118 selects a supply source (intra prediction unit 116 or motion prediction compensation unit 117) of the predicted image to be supplied to the computation units 103 and 110 and supplies the predicted image supplied from the selected supply source to the computation units 103 and 110.

The rate control unit 119 controls the rate of the quantization operation of the quantization unit 105 based on the code amount of the encoded data accumulated in the accumulation buffer 107 to prevent the occurrence of an overflow or an underflow. That is, the rate control unit 119 sets a target code amount of the encoded data and supplies the target code amount to the quantization unit 105 to prevent an overflow and an underflow of the accumulation buffer 107.

### <Example of Previous-Stage Filter Related Information>

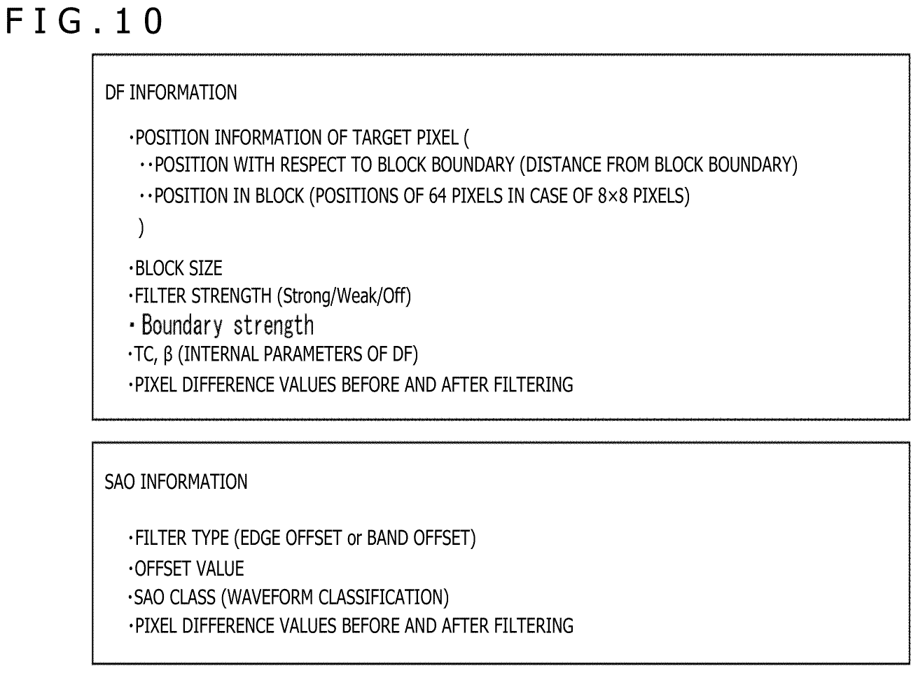

FIG. 10 is a diagram illustrating an example of the DF information and the SAO information as the previous-stage filter related information used by the adaptive classification filter 113 in the adaptive classification process (and learning).

Examples of the DF information that can be adopted include position information of the target pixel in a block including the target pixel (hereinafter, also referred to as target block), block size of the target pixel, information indicating whether the DF is applied (implemented) to the target pixel, filter strength of the DF in a case where the DF is applied to the target pixel (which one of a strong filter and a weak filter is applied), boundary strength of the DF, TC and R that are internal parameters of the DF, and difference between pixel values of the target pixel before and after the application of the DF (pixel difference values before and after filtering).

Examples of the position information of the target pixel that can be adopted include the position of the target pixel with respect to a block boundary of the target block (distance between the target pixel and the block boundary) and the position of the target pixel in the target block.

For example, in a case where the position of the target pixel with respect to the block boundary of the target block is adopted as the position information of the target pixel, the distance between the target pixel and the block boundary as position information of the target pixel adjacent to a block boundary in the target block is 0.

Furthermore, in a case where, for example, the position of the target pixel in the target block is adopted as position information of the target pixel, the position information of the target pixel indicates the position of the target pixel among 64 positions of 64 pixels (8×8 pixels) included in the target block when the target block includes, for example, 8×8 pixels.

Examples of the SAO information that can be adopted include the filter type of SAO (edge offset or band offset), the offset value, the SAO class, and the difference between the pixel values of the target pixel before and after the application of the SAO (pixel difference values before and after filtering).

Hereinafter, to simplify the description, the previous-stage filter related information used by the adaptive classification filter 113 in the adaptive classification process is, for example, the DF information.

### <Configuration Example of Adaptive Classification Filter 113>

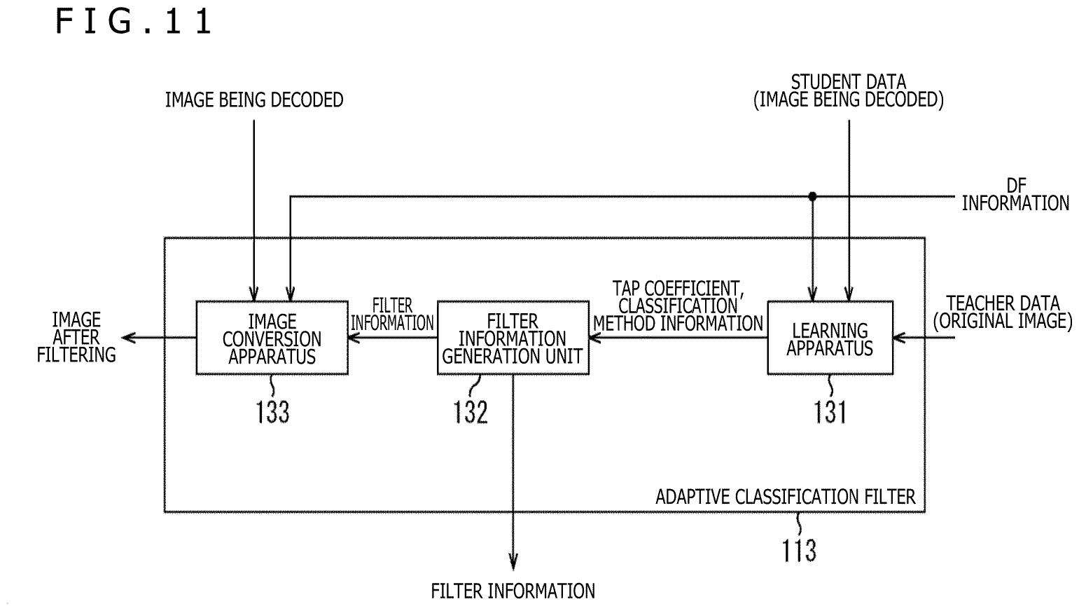

FIG. 11 is a block diagram illustrating a configuration example of the adaptive classification filter 113 of FIG. 9.

In FIG. 11, the adaptive classification filter 113 includes a learning apparatus 131, a filter information generation unit 132, and an image conversion apparatus 133.

The original image is supplied from the rearrangement buffer 102 (FIG. 9) to the learning apparatus 131, and the image being decoded is supplied from the SAO 112 (FIG. 9) to the learning apparatus 131. Furthermore, the DF information as previous-stage filter related information regarding the filtering process of the DF 111 as a previous-stage filtering process executed in a previous stage of the filtering process of the adaptive classification filter 113 is supplied from the DF 111 to the learning apparatus 131.

The learning apparatus 131 sets the image being decoded as student data and sets the original image as teacher data to perform classification using the DF information. The learning apparatus 131 performs learning for obtaining the tap coefficients of each class (hereinafter, also referred to as tap coefficient learning).

The learning apparatus 131 further supplies the tap coefficients of each class obtained by the tap coefficient learning and classification method information indicating the method of classification used to obtain the tap coefficients of each class to the filter information generation unit 132.

The filter information generation unit 132 generates filter information including the tap coefficients of each class and the classification method information from the learning apparatus 131 as necessary and supplies the filter information to the image conversion apparatus 133 and the reversible encoding unit 106 (FIG. 9).

The filter information is supplied from the filter information generation unit 132 to the image conversion apparatus 133. In addition, the image being decoded is supplied from the SAO 112 (FIG. 9) to the image conversion apparatus 133, and the DF information is supplied from the DF 111 to the image conversion apparatus 133.

The image conversion apparatus 133 sets, for example, the image being decoded as a first image and performs image conversion based on the adaptive classification process using the tap coefficients of each class included in the filter information from the filter information generation unit 132. In this way, the image conversion apparatus 133 converts the image being decoded as a first image into the image after filtering as a second image equivalent to the original image (generates the image after filtering) and supplies the image to the frame memory 114 (FIG. 9).

The image conversion apparatus 133 uses the DF information from the DF 111 to perform the classification in the adaptive classification process just like the learning apparatus 131. The image conversion apparatus 133 also performs, as classification using the DF information, the classification of the method indicated in the classification method information included in the filter information from the filter information generation unit 132.

Here, assuming that the DF 111 is, for example, a DF (LPF (Low Pass Filter) as DF) defined in the HEVC, the DF 111 is a filter of 5 taps used in a filtering process in which 5 pixels are continuously arranged in the horizontal or vertical direction. The block noise may not be sufficiently reduced in the DF 111 of 5 taps.

On the other hand, the adaptive classification filter 113 can use, as a prediction tap, pixels distributed in a wider range than the 5 pixels used by the DF 111 in the filtering process or use a large number of pixels to execute the filtering process. Therefore, for example, the block noise that cannot be sufficiently reduced in the DF 111 can be reduced.

The adaptive classification filter 113 applies the filtering process to the pixel according to the class of the pixel. Therefore, in a case where the pixel is appropriately classified, an appropriate filtering process can be applied to the pixel.

In other words, the pixel needs to be classified into an appropriate class in order to apply an appropriate filtering process to the pixel.

To sufficiently reduce the block noise that cannot be sufficiently reduced in the DF 111, it is desirable to, for example, classify the pixel through the filtering process of the DF 111 applied to the pixel.

Incidentally, the classification can be performed by using, for example, the image feature value of the target pixel, such as the ADRC code obtained from the class tap of the target pixel, as described in FIG. 2.

Although the target pixel is classified based on a waveform pattern (unevenness of pixel values) around the target pixel in the classification using the ADRC code, whether the target pixel is classified through the filtering process of the DF 111 applied to the pixels is not certain.

Therefore, the adaptive classification filter 113 can use the DF information regarding the filtering process of the DF 111 of the previous stage to perform the classification.

According to the classification using the DF information, the pixel is classified based on the filtering process of the DF 111 applied to the pixel. For example, the filtering process of the adaptive classification filter 113 along with the filtering process of the DF 111 can reduce the block noise that cannot be sufficiently reduced in the DF 111. As a result, the image after filtering and the S/N of the decoded image can be significantly improved.

In addition, the adaptive classification filter 113 can apply a separate appropriate filtering process to a part where the block noise is removed in the filtering process of the DF 111 (hereinafter, also referred to as noise removed part) and to a similar part that is not a noise removed part, but a part with the waveform pattern similar to the waveform pattern of the noise removed part. This can significantly improve the S/N of the image after filtering (and the decoded image).

However, the noise removed part and the similar part with similar waveform patterns are not classified into separate classes in the classification using only the image feature value of the target pixel such as the ADRC code. The noise removed part and the similar part are classified into the same class, and it is difficult to execute a separate appropriate filtering process.

On the other hand, according to the classification using the DF information, the noise removed part and the similar part that have similar waveform patterns can be classified into separate classes. As a result, separate appropriate filtering processes can be applied to the noise removed part and the similar part that have similar waveform patterns, and the S/N of the image after filtering can be significantly improved.

Note that the learning apparatus 131 in the adaptive classification filter 113 appropriately performs the tap coefficient learning, and the tap coefficients of each class are updated. The tap coefficients of each class after the update are then included in the filter information and transmitted from the encoding apparatus 11 to the decoding apparatus 12. In this case, frequent transmission of the tap coefficients increases the overhead, and the compression efficiency is degraded.

On the other hand, in a case where the correlation of the image being decoded (and the original image) in the time direction is high, the S/N of the image after filtering can be maintained even when the adaptive classification filter 113 executes the filtering process by using the same tap coefficients as the tap coefficients at the time of the preceding update of the tap coefficients.

Furthermore, in the case where the adaptive classification filter 113 executes the filtering process by using the same tap coefficients as the tap coefficients at the time of the update of the preceding tap coefficients, the decoding apparatus 12 can also continuously use the preceding tap coefficients. In this case, the tap coefficients do not have to be newly transmitted from the encoding apparatus 11 to the decoding apparatus 12, and the compression efficiency can be improved.

To improve the compression efficiency as described above, the filter information generation unit 132 can include, in the filter information, a flag or the like as copy information indicating whether to use the same classification method and tap coefficients as the classification method and the tap coefficients at the time of the preceding update instead of the tap coefficients of each class and the classification method information (the syntax of the encoded data can include the syntax of the copy information in addition to the syntax of the tap coefficients of each class and the classification method information).

The copy information can be included in the filter information instead of the tap coefficients and the classification method information, and this can significantly reduce the amount of data of the filter information and improve the compression efficiency compared to the case where the tap coefficients and the classification method information are included.

The filter information generation unit 132 can include, in the filter information, the copy information indicating to use the same classification method and tap coefficients as the classification method and the tap coefficients at the time of the preceding update in a case where, for example, the latest classification method information supplied from the learning apparatus 131 coincides with the classification method information of the last time supplied from the learning apparatus 131 or in a case where, for example, the correlation in the time direction between the sequence of the original image used for the tap coefficient learning of this time and the sequence of the original image used for the tap coefficient learning of the last time is high.

An arbitrary picture sequence, such as, for example, a plurality of frames (pictures), one frame, CU, and other blocks, can be adopted for the unit of update in updating the classification method and the tap coefficients, and at timing of the unit of update as a minimum unit, the classification method and the tap coefficients can be updated.

For example, in a case where the present technique is applied to the HEVC (or encoding system in compliance with the HEVC), the filter information can be included as, for example, Sequence parameter set syntax in the encoded data when a plurality of frames are adopted as the unit of update. In addition, the filter information can be included as, for example, Picture parameter set syntax in the encoded data when one frame is adopted as the unit of update. Furthermore, the filter information can be included as, for example, Slice data syntax in the encoded data in a case where a block, such as CU, is adopted as the unit of update.

In addition, the filter information can be included in a plurality of arbitrary tiers of the Sequence parameter set syntax, the Picture parameter set syntax, and the Slice data syntax. In this case, filter information of a tier with smaller particle size in the filter information included in the plurality of tiers can be preferentially applied for a certain block. For example, when the filter information is included in both the Sequence parameter set syntax and the Slice data syntax for a certain block, the filter information included in the Slice data syntax can be preferentially applied for the block.

### <Configuration Example of Learning Apparatus 131>

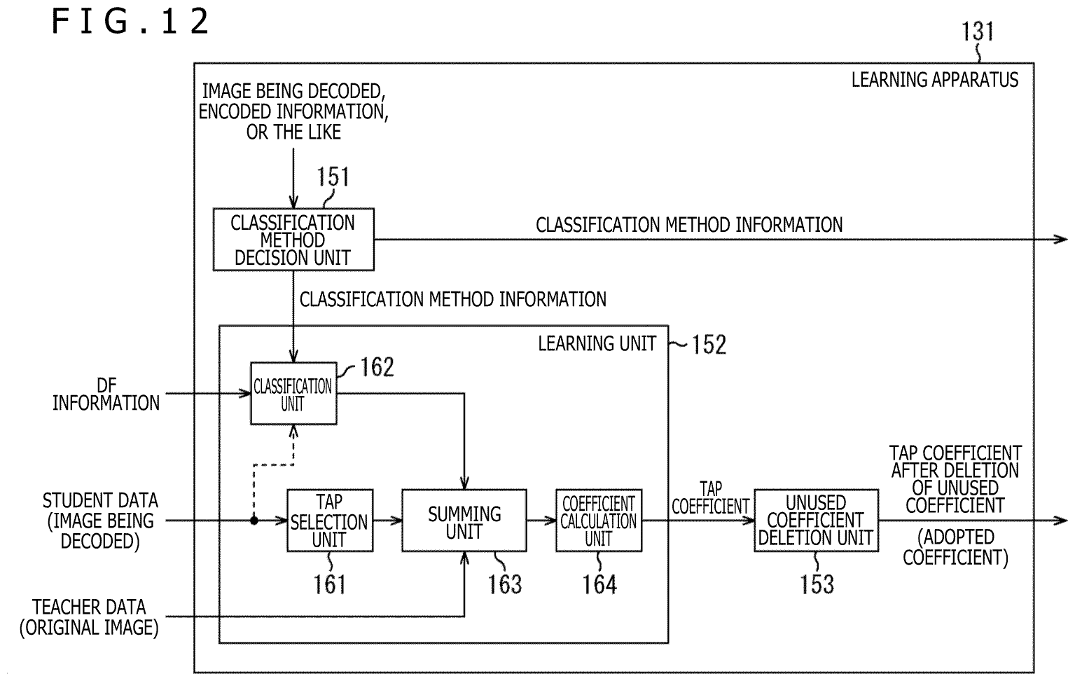

FIG. 12 is a block diagram illustrating a configuration example of the learning apparatus 131 of FIG. 11.

In FIG. 12, the learning apparatus 131 includes a classification method decision unit 151, a learning unit 152, and an unused coefficient deletion unit 153.

The classification method decision unit 151 stores, for example, a plurality of predetermined methods of classification (hereinafter, also referred to as classification methods) (information of the methods).

The classification method decision unit 151 decides a classification method (hereinafter, also referred to as adopted classification method) to be used by the learning unit 152 (classification unit 162 of the learning unit 152) from among the plurality of classification methods at, for example, the start of the tap coefficient learning and supplies classification method information indicating the adopted classification method to the learning unit 152 (classification unit 162 of the learning unit 152).

The classification method decision unit 151 further supplies (outputs) the classification method information to the filter information generation unit 132 (FIG. 11) as a unit outside of the learning apparatus 131. The classification method information supplied to the filter information generation unit 132 by the classification method decision unit 151 is included in the filter information and supplied and transmitted to the reversible encoding unit 106 (FIG. 9).

Here, the adopted classification method is decided from among the plurality of classification methods stored in the classification method decision unit 151 as described above, and therefore, it can be stated that the classification methods stored in the classification method decision unit 151 are candidates for the adopted classification method.

Examples of the candidate (a plurality of candidates) for the adopted classification method stored in the classification method decision unit 151 include methods, such as classification (one or two or more classifications) using the DF information, classification (zero or one or more classifications) using other information (for example, image feature value, encoded information, or the like) without using the DF information, and classification (zero or one or more classifications) using the DF information and other information.

Furthermore, examples of the method of classification using the DF information as candidates for the adopted classification method include a method of, so to say, rough classification into general classes (few classes) and a method of, so to say, detailed classification into detailed classes (many classes).

The classification method decision unit 151 can decide the adopted classification method according to, for example, acquirable information that can be acquired from the encoded data obtained in the prediction encoding of the original image by the encoding apparatus 11, such as the image being decoded and the encoded information, that is, acquirable information that can be acquired by either one of the encoding apparatus 11 and the decoding apparatus 12.

In addition, the classification method decision unit 151 can decide the adopted classification method according to, for example, information that can be acquired only by the encoding apparatus 11, such as the original image.

Specifically, the classification method decision unit 151 can decide the adopted classification method according to, for example, the quality of the decoded image, that is, according to, for example, the quantization parameter QP that is one of the pieces of encoded information.

Here, in a case where the quantization parameter QP is large, the quantization error (distortion) becomes large, and the block noise tends to be large in the decoded image. On the other hand, in a case where the quantization parameter QP is small, the quantization error becomes small, and the block noise becomes small or is not generated in the decoded image. Therefore, the quantization parameter QP indicates the quality (image quality) of the decoded image.

Therefore, in a case where the quantization parameter QP is larger than a threshold, the block noise tends to be large in the decoded image (therefore, the filtering process of the DF 111 is likely to be applied to many pixels), and the method of classification using the DF information can be decided as the adopted classification method in order to classify the pixels through the filtering process of the DF 111.

Furthermore, in this case, when the candidates for the adopted classification method include the method of classification for performing rough classification and the method of classification for performing detailed classification as methods of classification using the DF information, the method of classification for performing detailed classification can be decided as the adopted classification method.

On the other hand, in a case where the quantization parameter QP is not larger than the threshold, the method of classification using other information (for example, image feature value, encoded information, or the like) without using the DF information or the method of classification for performing rough classification among the classifications using the DF information can be decided as the adopted classification method

In addition, the classification method decision unit 151 can decide the adopted classification method according to, for example, the image feature values of the image being decoded.

For example, in a case where the image being decoded is an image including many pixel values with minute variations in amplitude so that there are many areas with step-wise level differences in pixel values, it is estimated that the image being decoded includes much block noise (therefore, the filtering process of the DF 111 is applied to many pixels). Therefore, to classify the pixels through the filtering process of the DF 111, the method of classification using the DF information, particularly, the method of classification for detailed classification, can be decided as the adopted classification method.

On the other hand, in a case where the image being decoded is not an image with many areas with minute amplitude and step-wise level differences in pixel values, the method of classification using other information without using the DF information and the method of classification for performing rough classification among the classifications using the DF classification can be decided as the adopted classification method.

Here, for the variations in amplitude of pixel values, for example, a class tap of pixels of the image being decoded can be formed. A DR (Dynamic Range) that is a difference between the maximum value and the minimum value of the pixel values, such as luminance of the pixels included in the class tap, can be obtained as an image feature value of the pixel of the image being decoded, and the DR can be used as an index of the variations in amplitude of pixel values.

That is, a small DR indicates that the variations in amplitude of pixel values are small, and a large DR indicates that the variations in amplitude of pixel values is large.

In addition, for the step-wise level difference in pixel values, for example, DiffMax/DR using DiffMax that is a maximum value of difference absolute values of the pixel values of the pixels adjacent in the horizontal, vertical, and diagonal directions in the class tap of the pixels of the image being decoded can be obtained as image feature values of the pixels of the image being decoded, and the DiffMax/DR can be used as an index of the step-wise level difference in pixel values.

The DiffMax/DR indicates the number of pixels in the rising of the amplitude of the DR in the class tap. The larger the slope of the pixel values of the pixels included in the class tap, the closer the value of the DiffMax/DR to 1. The fact that the slope is large is equivalent to the presence of a step-wise level difference in the pixel values.

Whether the image being decoded is an image including many pixel values with minute variations in amplitude and including many areas with step-wise level difference in pixel values can be determined by, for example, obtaining the DR as image feature values and the histogram of the DiffMax/DR on the basis of a predetermined unit, such as a unit of picture of the image being decoded, and can be determined based on the histogram.

Furthermore, the classification method decision unit 151 can decide the adopted classification method according to, for example, the proportion of pixels subjected to the filtering process of the DF 111 in the image being decoded.

For example, in a case where the proportion of pixels subjected to the strong filter or the weak filter of the DF 111 is larger than a threshold in a picture of the image being decoded, the method of classification using the DF information, particularly, the method of classification for performing detailed classification, can be decided as the adopted classification method in order to classify the pixels through the filtering process of the DF 111.

On the other hand, in a case where the proportion of pixels subjected to the strong filter or the weak filter of the DF 111 is not larger than the threshold in the picture of the image being decoded, the method of classification using other information without using the DF information or the method of classification for performing rough classification among the classifications using the DF information can be decided as the adopted classification method.

Note that other than deciding the adopted classification method according to the quantization parameter QP, the image feature values of the image being decoded, or the proportion of the pixels subjected to the strong filter or the weak filter as described above, the classification method decision unit 151 can also randomly select one classification method from the plurality of classification methods and decide the candidate as the adopted classification method.

The classification method decision unit 151 can also select a candidate that optimizes the image quality of the decoded image and the amount of data of the encoded data, that is, for example, the classification method that optimizes the RD cost, from the plurality of classification methods and decide the candidate as the adopted classification method.

Furthermore, the classification method used in the adaptive classification filter 113 can be fixed to a specific method of specification using the DF information, instead of deciding the classification method from among the plurality of classification methods.

In this case, the learning apparatus 131 may not include the classification method decision unit 151. Furthermore, in this case, the classification method information may not be included in the filter information before the transmission.

Here, although the adopted classification method decided by the classification method decision unit 151 is not limited to the method of classification using the DF, it is assumed hereinafter that in order to simplify the description, the adopted classification method is the method of classification using the DF information unless otherwise specified.

The learning unit 152 includes a tap selection unit 161, the classification unit 162, a summing unit 163, and a coefficient calculation unit 164.

The components from the tap selection unit 161 to the coefficient calculation unit 164 execute processes similar to the processes of the components from the tap selection unit 51 to the coefficient calculation unit 54 included in the learning unit 43 of FIG. 4, respectively.

The image being decoded as student data, the original image as teacher data, and the DF information from the DF 111 are supplied to the learning unit 152. The learning unit 152 then uses the image being decoded as student data and the original image as teacher data to perform the tap coefficient learning similar to the tap coefficient learning of the learning unit 43 of FIG. 4 to obtain the tap coefficients of each class.

However, in the learning unit 152, the classification unit 162 uses the DF information from the DF 111 to perform the classification.

That is, in the learning unit 152, the classification method information is supplied to the classification unit 162 from the classification method decision unit 151, and the DF information is supplied to the classification unit 162 from the DF 111.

The classification unit 162 uses the DF information to classify the target pixel based on the classification method (adopted classification method) indicated in the classification method information from the classification method decision unit 151 and supplies the class of the target pixel obtained as a result of the classification to the summing unit 163.

Note that the classification unit 162 can perform the classification of each of the plurality of classification methods stored in the classification method decision unit 151.

Therefore, in the case where the classification method decision unit 151 stores the plurality of classification methods including, for example, the methods, such as the classification using the DF information as well as the classification using other information (for example, image feature values, encoded information, or the like) without using the DF information and the classification using the DF information and other information, the other information that can be used for the classification (including information used to obtain the other information) is also supplied to the classification unit 162 in addition to the DF information.

For example, in the case where one of the plurality of classification methods stored in the classification method decision unit 151 is the method of classification using the DF information and the image feature values of the image being decoded as acquirable information, the image being decoded is supplied to the classification unit 162 as indicated by a dotted line in FIG. 12 in order for the classification unit 162 to obtain the image feature values of the image being decoded.

In addition, one of the plurality of classification methods that can be stored in the classification method decision unit 151 includes the method of classification using the DF information and the encoded information as acquirable information. In this case, the encoded information is supplied to the classification unit 162.

Examples of the encoded information of the target pixel used for the classification include a block phase representing the position of the target pixel in a block, such as a CU and a PU, including the target pixel, a picture type of the picture including the target pixel, and the quantization parameter QP of the PU including the target pixel.

Once the learning unit 152 obtains the tap coefficients of each class in the tap coefficient learning, the coefficient calculation unit 164 supplies the tap coefficients of each class to the unused coefficient deletion unit 153.

The unused coefficient deletion unit 153 detects, as candidates for a removed class to be removed from the target of the adaptive classification process, zero or one or more classes (of pixels) with small effect of image quality improvement from among the tap coefficients of each class (hereinafter, also referred to as initial coefficients) obtained by the tap coefficient learning from the learning unit 152.

Furthermore, the unused coefficient deletion unit 153 selects a removed class (candidate for the removed class) from the candidates for the removed class. The removed class is selected from the candidates for the removed class so as to optimize the image quality of the decoded image and the amount of data of the encoded data, that is, to optimize, for example, the RD cost. The unused coefficient deletion unit 153 then determines that the tap coefficients of the removed class are unused coefficients and deletes the tap coefficients from the initial coefficients. The unused coefficient deletion unit 153 outputs the tap coefficients after the deletion of the unused coefficients as adopted coefficients to be used for the adaptive classification process (filtering process of the adaptive classification process).

The adopted coefficients output by the unused coefficient deletion unit 153 are supplied to the filter information generation unit 132 (FIG. 11) along with the classification method information output by the classification method decision unit 151.

In this way, in the case where the tap coefficients of the removed class are determined as unused coefficients and deleted from the initial coefficients, the amount of data of the tap coefficients (adopted coefficients) transmitted from the encoding apparatus 11 to the decoding apparatus 12 is reduced by the amount equivalent to the unused coefficients. As a result, the compression efficiency can be improved.

Note that the learning apparatus 131 can use the image being decoded, the original image, and the like including the unit of update to decide the adopted classification method or perform the tap coefficient learning.

### <Classification Using DF Information>

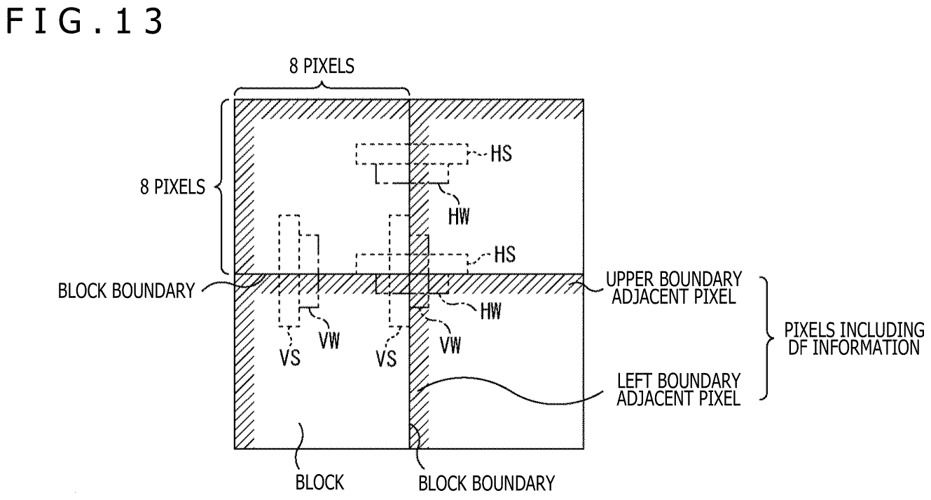

FIG. 13 is a diagram describing an example of the filtering process executed by the DF 111.

In the image being decoded, for example, eight left boundary adjacent pixels adjacent to a left block boundary (eight pixels in the block) and eight upper boundary adjacent pixels adjacent to an upper block boundary among upper, lower, left, and right block boundaries of a block including 8×8 (horizontal×vertical) pixels are DF information pixels including the DF information.

Here, the upper left pixel of the block is a left boundary adjacent pixel and is also an upper boundary adjacent pixel.

In the DF 111, the filtering process is applied to pixels in a range HW of 4×1 (horizontal×vertical) pixels including a left boundary adjacent pixel, in a range HS of 6×1 pixels including a left boundary adjacent pixel, in a range VW of 1×4 pixels including an upper boundary adjacent pixel, and in a range VW of 1×6 pixels including an upper boundary adjacent pixel.

Here, the range HW is a range of four pixels lined up in the horizontal direction including a left boundary adjacent pixel, one pixel adjacent to and on the right of the left boundary adjacent pixel, and two pixels adjacent to and on the left of the left boundary adjacent pixel. The range HS is a range of six pixels lined up in the horizontal direction including a left boundary adjacent pixel, two pixels adjacent to and on the right of the left boundary adjacent pixel, and three pixels adjacent to and on the left of the left boundary adjacent pixel.

The range VW is a range of four pixels lined up in the vertical direction including an upper boundary adjacent pixel, two pixels adjacent to and above the upper boundary adjacent pixel, and one pixel adjacent to and below the upper boundary adjacent pixel. The range VS is a range of six pixels lined up in the vertical direction including an upper boundary adjacent pixel, three pixels adjacent to and above the upper boundary adjacent pixel, and two pixels adjacent to and below the upper boundary adjacent pixel.

In the DF 111, in a case where there is an edge (it is determined that there is an edge) in the vertical direction in a left boundary adjacent pixel (near a left boundary adjacent pixel), a horizontal filter that is a filter in the horizontal direction is applied to each pixel of the range HS or HW including the left boundary adjacent pixel.

Furthermore, in the DF 111, in a case where there is an edge in the horizontal direction in an upper boundary adjacent pixel, a vertical filter that is a filter in the vertical direction is applied to each pixel of the range VS or VW including the upper boundary adjacent pixel.

Here, the horizontal filter applied in the DF 111 is a filter of 5 taps that uses five pixels lined up in the horizontal direction to execute the filtering process. Similarly, the vertical filter applied in the DF 111 is a filter of 5 taps that uses five pixels lined up in the vertical direction to execute the filtering process.

The filter applied to each pixel in the range HW or VW of four pixels is called a weak filter, and the filter applied to each pixel in the range HS or VS of six pixels is called a strong filter.

The DF information included in the DF information pixel allows to recognize whether the DF (horizontal filter or vertical filter as DF) is applied to the pixel of the block and whether the DF (type of DF) applied to the pixel subjected to the DF is a strong filter or a weak filter.

Note that in the DF 111, both the horizontal filter and the vertical filter are applied to a pixel near four corners of a block in some cases. The application of both the horizontal filter and the vertical filter in this way can be taken into account in adopting the classification using the DF information.

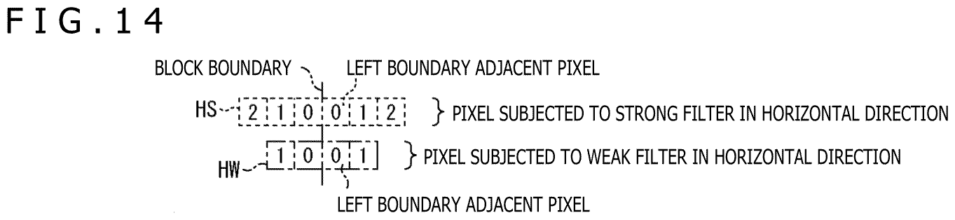

FIG. 14 is a diagram illustrating an example of position information of the pixels of the image being decoded that can be subjected to the DF.

An example of the position information of the pixel that can be adopted includes the position of the target pixel with respect to the block boundary of the block including the pixel (distance between the target pixel and the block boundary).

For example, for a pixel subjected to the strong filter or the weak filter as a horizontal filter, the distance in the horizontal direction from the block boundary in the vertical direction closest to the pixel can be defined as a horizontal position as position information of the pixel in the horizontal direction.

FIG. 14 illustrates the horizontal positions of the pixels.

That is, the left boundary adjacent pixel and the pixel adjacent to and on the left of the left boundary adjacent pixel in the range HW of the pixels subjected to the weak filter as a horizontal filter are adjacent to the block boundary in the vertical direction, and the distance in the horizontal direction from the block boundary is 0 (pixel). Therefore, the horizontal positions are 0.

In addition, the pixel adjacent to and on the right of the left boundary adjacent pixel and the pixel adjacent to and on the left of the pixel adjacent to and on the left of the left boundary adjacent pixel in the range HW of the pixels subjected to the weak filter as a horizontal filter are one pixel away in the horizontal direction from the block boundary in the vertical direction. Therefore, the horizontal positions are 1.

Furthermore, the horizontal positions of the left boundary adjacent pixel and the pixel adjacent to and on the left of the left boundary adjacent pixel in the range HS of the pixels subjected to the strong filter as a horizontal filter are 0 as in the case of the range HW.

In addition, the horizontal positions of the pixel adjacent to and on the right of the left boundary adjacent pixel and the pixel adjacent to and on the left of the pixel adjacent to and on the left of the left boundary adjacent pixel in the range HS of the pixels subjected to the strong filter as a horizontal filter are also 1 as in the case of the range HW.

Furthermore, the pixel adjacent to and on the right of the pixel adjacent to and on the right of the left boundary adjacent pixel and the pixel adjacent to and on the left of the pixel adjacent to and on the left of the pixel adjacent to and on the left of the left boundary adjacent pixel in the range HS of the pixels subjected to the strong filter as a horizontal filter are two pixels away in the horizontal direction from the block boundary in the vertical direction, and the horizontal positions are 2.

Similarly, for a pixel subjected to the strong filter or the weak filter as a vertical filter, the distance in the vertical direction from the block boundary in the horizontal direction closest to the pixel can be defined as a vertical position as position information in the vertical direction of the pixel.

The horizontal positions and the vertical positions as position information of the pixels are symmetric with respect to the block boundaries.

Note that the position information is not defined for the pixels not subjected to the DF.

The classification using the horizontal positions and the vertical positions as position information of the pixels can be adopted as the classification using the DF information.

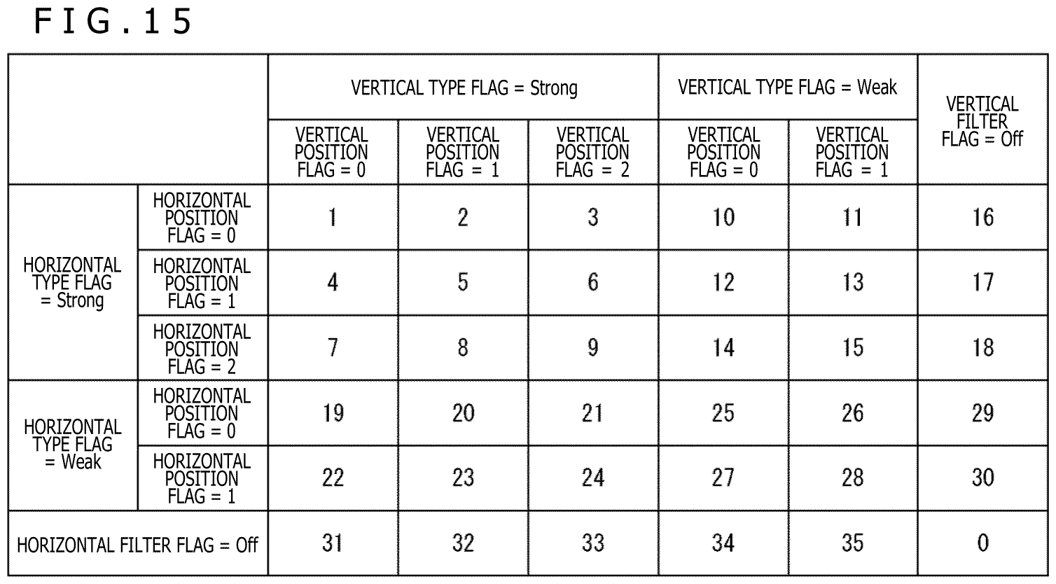

FIG. 15 is a diagram illustrating an example of the classification using the DF information.

In the classification using the DF information of FIG. 15, a vertical filter flag, a vertical type flag, a vertical position flag, a horizontal filter flag, a horizontal type flag, and a horizontal position flag are appropriately obtained from the DF information, and the classification is performed according to necessary flags among the vertical filter flag, the vertical type flag, the vertical position flag, the horizontal filter flag, the horizontal type flag, and the horizontal position flag.

The vertical filter flag indicates whether the vertical filter as a DF is applied to the target pixel, and the vertical filter flag is set to Off in a case where the vertical filter is not applied.

The horizontal filter flag indicates whether the horizontal filter as a DF is applied to the target pixel, and the horizontal filter flag is set to Off in a case where the horizontal filter is not applied.

The vertical type flag indicates whether the vertical filter as a DF is a strong filter or a weak filter in the case where the vertical filter is applied to the target pixel. The vertical type flag is set to Strong in a case where the strong filter is applied to the target pixel, and the vertical type flag is set to Weak in a case where the weak filter is applied to the target pixel.

The horizontal type flag indicates whether the horizontal filter as a DF is a strong filter or a weak filter in the case where the horizontal filter is applied to the target pixel. The horizontal type flag is set to Strong in a case where the strong filter is applied to the target pixel, and the horizontal type flag is set to Weak in a case where the weak filter is applied to the target pixel.

The vertical position described in FIG. 14 as position information of the target pixel subjected to the DF is set in the vertical position flag. The horizontal position described in FIG. 14 as position information of the target pixel subjected to the DF is set in the horizontal position flag.

In FIG. 15, the target pixel is classified into class 0 in a case where, for example, both the horizontal filter flag and the vertical filter flag of the target pixel are Off.

In addition, the target pixel is classified into one of classes 31 to 35 according to the vertical type flag and the vertical position flag in a case where, for example, the horizontal filter flag of the target pixel is Off and the vertical filter flag is not Off, that is, in a case where the vertical type filter is Strong or Weak.

That is, the target pixel is classified into class 31 in a case where, for example, the vertical type filter is Strong and the vertical position flag is 0.

In addition, the target pixel is classified into class 34 in a case where, for example, the vertical type filter is Weak and the vertical position flag is 0.

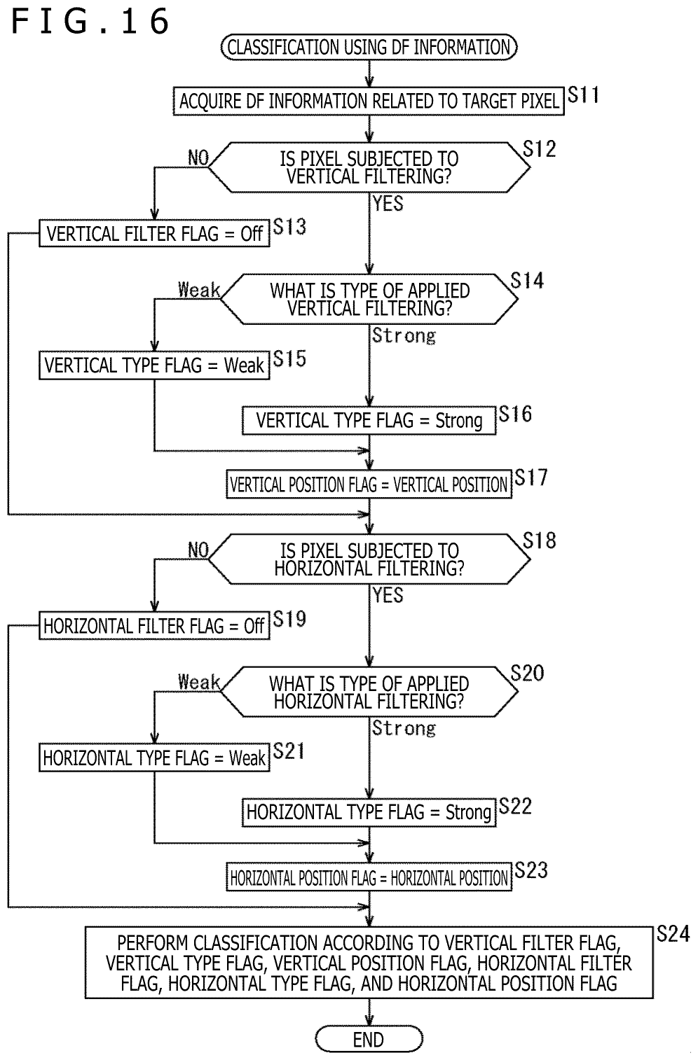

FIG. 16 is a flow chart describing an example of the process in the case where the classification unit 162 of FIG. 12 performs the classification using the DF information of FIG. 15.

In step S11, the classification unit 162 acquires the DF information related to the target pixel from the DF information from the DF 111, and the process proceeds to step S12.

In step S12, the classification unit 162 determines whether the target pixel is a pixel subjected to the vertical filter as a DF based on the DF information related to the target pixel.

In a case where the classification unit 162 determines that the target pixel is not a pixel subjected to the vertical filter as a DF in step S12, the process proceeds to step S13, and the classification unit 162 sets the vertical filter flag of the target pixel to Off. The process proceeds to step S18.

Furthermore, in a case where the classification unit 162 determines that the target pixel is a pixel subjected to the vertical filter as a DF in step S12, the process proceeds to step S14, and the classification unit 162 determines whether the type of vertical filter applied to the target pixel is a strong filter or a weak filter.

In a case where the classification unit 162 determines that the vertical filter applied to the target pixel is a weak filter in step S14, the process proceeds to step S15, and the classification unit 162 sets the vertical type flag to Weak. The process proceeds to step S17.

Furthermore, in a case where the classification unit 162 determines that the vertical filter applied to the target pixel is a strong filter in step S14, the process proceeds to step S16, and the classification unit 162 sets the vertical type flag to Strong. The process proceeds to step S17.

In step S17, the classification unit 162 obtains the vertical position of the target pixel subjected to the vertical filter and sets the vertical position in the vertical position flag. The process proceeds to step S18.

In step S18, the classification unit 162 determines whether the target pixel is a pixel subjected to the horizontal filter as a DF based on the DF information related to the target pixel.

In a case where the classification unit 162 determines that the target pixel is not a pixel subjected to the horizontal filter as a DF in step S18, the process proceeds to step S19, and the classification unit 162 sets the horizontal filter flag of the target pixel to Off. The process proceeds to step S24.

Furthermore, in a case where the classification unit 162 determines that the target pixel is a pixel subjected to the horizontal filter as a DF in step S18, the process proceeds to step S20, and the classification unit 162 determines whether the type of horizontal filter subjected to the target pixel is a strong filter or a weak filter.

In a case where the classification unit 162 determines that the horizontal filter subjected to the target pixel is a weak filter in step S20, the process proceeds to step S21, and the classification unit 162 sets the horizontal type flag to Weak. The process proceeds to step S23.

Furthermore, in a case where the classification unit 162 determines that the horizontal filter subjected to the target pixel is a strong filter in step S20, the process proceeds to step S22, and the classification unit 162 sets the horizontal type flag to Strong. The process proceeds to step S23.

In step S23, the classification unit 162 obtains the horizontal position of the target pixel subjected to the horizontal filter and sets the horizontal position in the horizontal position flag. The process proceeds to step S24.

In step S24, the classification unit 162 performs the classification of the classification method indicated in the classification method information from the classification method decision unit 151 according to the vertical filter flag, the vertical type flag, the vertical position flag, the horizontal filter flag, the horizontal type flag, and the horizontal position flag obtained for the target pixel. The classification unit 162 outputs the class of the target pixel obtained by the classification and ends the process of classification.

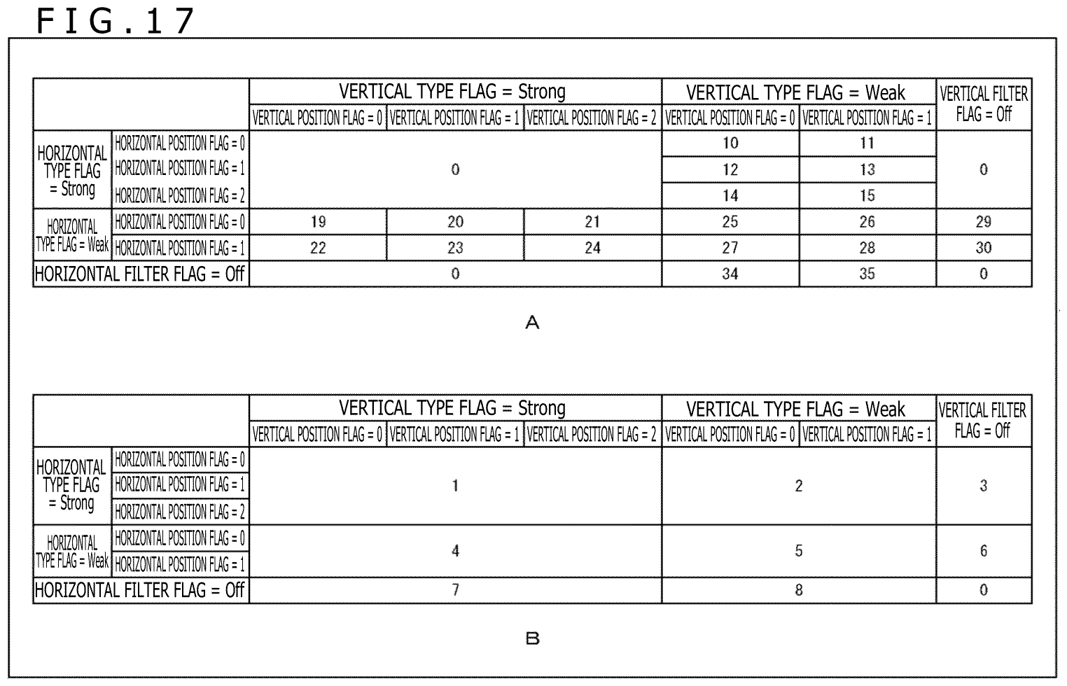

FIG. 17 is a diagram illustrating another example of the classification using the DF information.

Other than the classification method described in FIG. 15, the classification method illustrated in FIG. 17 can be stored as a classification method of the classification using the DF information in the classification method decision unit 151.

A of FIG. 17 illustrates a first another example of the classification using the DF information, and B of FIG. 17 illustrates a second another example of the classification using the DF information.

In A and B of FIG. 17, the classification is performed according to necessary flags among the vertical filter flag, the vertical type flag, the vertical position flag, the horizontal filter flag, the horizontal type flag, and the horizontal position flag obtained from the DF information as in the case of FIG. 15.

However, although the target pixel is classified into class 0 only in the case where both the horizontal filter flag and the vertical filter flag of the target pixel are Off in FIG. 15, the target pixel is also classified into class 0 in a case where the vertical filter or the horizontal filter applied to the target pixel is a strong filter, that is, in a case where the vertical type flag or the horizontal type flag is Strong, in A of FIG. 17.

Therefore, in A of FIG. 17, the target pixel is classified without using the position information of the target pixel, that is, the vertical position flag and the horizontal position flag, in the case where the vertical type flag or the horizontal type flag is Strong.

In B of FIG. 17, the target pixel is classified without using the position information of the target pixel, that is, the vertical position flag and the horizontal position flag.

Specifically, in B of FIG. 17, the target pixel is classified into classes 1, 2, and 3, respectively, when the vertical type flag is Strong, when the vertical type flag is Weak, and when the vertical filter flag is Off in the case where the horizontal type flag is Strong.

Furthermore, the target pixel is classified into classes 4, 5, and 6, respectively, when the vertical type flag is Strong, when the vertical type flag is Weak, and when the vertical filter flag is Off in the case where the horizontal type flag is Weak.

In addition, the target pixel is classified into classes 7, 8, and 0, respectively, when the vertical type flag is Strong, when the vertical type flag is Weak, and when the vertical filter flag is Off in the case where the horizontal filter flag is Off.

Here, in FIG. 15, the position information (vertical position flag or horizontal position flag) of the target pixel is used to perform the classification in the cases other than the case in which both the horizontal filter flag and the vertical filter flag of the target pixel are Off.

On the other hand, in A of FIG. 17, the target pixel is classified without using the position information of the target pixel only in the case where the vertical type flag or the horizontal type flag is Strong.

Furthermore, in B of FIG. 17, the target pixel is always classified without using the position information of the target pixel.

Therefore, it can be stated that among the classifications of FIG. 15 and A and B of FIG. 17, the classification of FIG. 15 is a classification for performing the most detailed classification, and the classification of B of 17 is a classification for performing the roughest classification.

Other than the classification method of the classification using the DF information, the method of classification using the DF information and other information (for example, image feature value, encoded information, or the like) can be stored in the classification method decision unit 151.

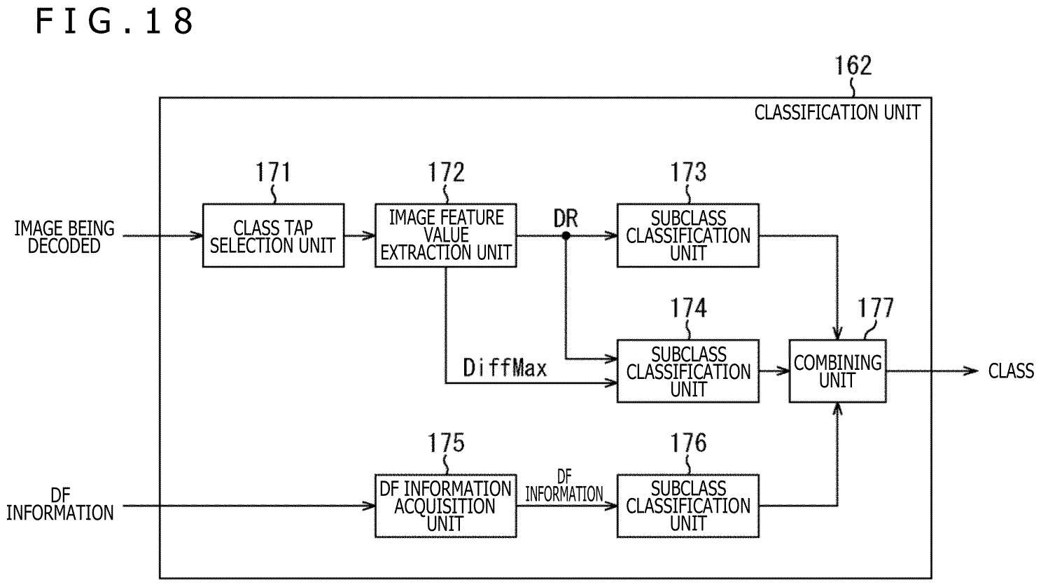

FIG. 18 is a block diagram illustrating a configuration example of the classification unit 162 in a case of using the DF information and the image feature value as other information to perform the classification.

In FIG. 18, the classification unit 162 includes a class tap selection unit 171, an image feature value extraction unit 172, subclass classification units 173 and 174, a DF information acquisition unit 175, and a subclass classification unit 176.

The image being decoded from the SAO 112 (FIG. 9) is supplied to the class tap selection unit 171. The class tap selection unit 171 selects, from the image being decoded from the SAO 112, some pixels spatially or temporally close to the target pixel as a class tap to be used to classify the target pixel (class tap of target pixel) and supplies the class tap to the image feature value extraction unit 172.

The image feature value extraction unit 172 uses the class tap of the target pixel from the class tap selection unit 171 to extract the image feature value of the target pixel (around the target pixel) and supplies the image feature value to the subclass classification units 173 and 174.

For example, the image feature value extraction unit 172 extracts, as the image feature value of the target pixel, the DR that is the difference between the maximum value and the minimum value of the pixel values of the pixels included in the class tap, the DiffMax that is the maximum value of the difference absolute values of the pixel values of the pixels adjacent in the horizontal, vertical, and diagonal directions in the class tap, or the like.

The image feature value extraction unit 172 supplies the DR to the subclass classification units 173 and 174 and supplies the DiffMax to the subclass classification unit 174.

The subclass classification unit 173 uses the DR from the image feature value extraction unit 172 to apply, for example, threshold processing to the DR to thereby classify the target pixel into a first subclass and supplies the first subclass of the target pixel obtained as a result of the classification to a combining unit 177.

The subclass classification unit 174 uses the DR and the DiffMax from the image feature value extraction unit 172 to apply, for example, threshold processing to the DiffMax/DR to thereby classify the target pixel into a second subclass and supplies the second subclass of the target pixel obtained as a result of the classification to the combining unit 177.

The DF information acquisition unit 175 acquires the DF information related to the target pixel from the DF information supplied from the DF 111 (FIG. 9) and supplies the DF information to the subclass classification unit 176.

The subclass classification unit 176 uses the DF information from the DF information acquisition unit 175 to perform, for example, the classification of the classification method illustrated in FIG. 15 or A or B of FIG. 17 to thereby classify the target pixel into a third subclass and supplies the third subclass of the target pixel to the combining unit 177.

The combining unit 177 combines the first subclass, the second subclass, and the third subclass from the subclass classification units 173, 174, and 176, respectively, to obtain a class (final class) of the target pixel and supplies the class to the summing unit 163 (FIG. 12).

For example, the combining unit 177 can sequentially line up the bit strings indicating the first to third subclasses and obtain the value indicated by the bit string as the class of the target pixel.

Here, the DR represents the variations in amplitude of pixel values, and the DiffMax/DR represents the slope of the pixel values.

In an area with block noise, the variations in amplitude of pixel values are small, but the slope of the pixel values is steep.

Therefore, the first subclass obtained by the classification (clustering) using the DR and the second subclass obtained by the classification using the DR and the DiffMax allow to classify the target pixel according to whether there is block noise and according to the size of the block noise. As a result, in the case where there is block noise, a filtering process for appropriately reducing the block noise can be executed according to the size of the block noise.

When the DF 111 applies the filtering process to the image being decoded, the DF 111 determines whether there is block noise and determines the type of DF to be applied (strong filter or weak filter). However, there may be an error in the determination, and the block noise generated in the image being decoded may not be sufficiently reduced.

In the case of the classification using the image feature value in addition to the DF information, the target pixel can be classified according to whether there is block noise and according to the size of the block noise as described above. In the case where there is block noise, the filtering process for appropriately reducing the block noise can be executed according to the size of the block noise. Therefore, in the case where there is an error in the determination of whether there is block noise or the like so that the block noise generated in the image being decoded cannot be sufficiently reduced in the DF 111, the adaptive classification filter 113 can correct the error of the DF 111 to sufficiently reduce the block noise.

### <Process of Learning Apparatus 131>

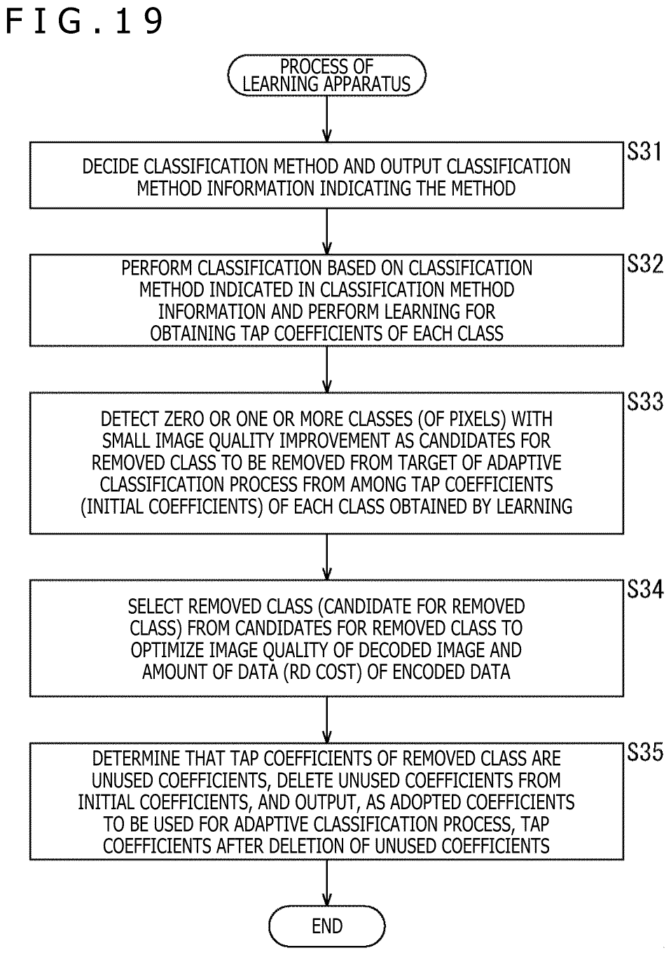

FIG. 19 is a flow chart describing an example of the process of the learning apparatus 131 in FIG. 12.

In step S31, the classification method decision unit 151 decides the adopted classification method from among the plurality of predetermined classification methods and outputs the classification method information indicating the adopted classification method. The process proceeds to step S32.

The classification method information output by the classification method decision unit 151 is supplied to the filter information generation unit 132 (FIG. 11) and the classification unit 162 of the learning unit 152 (FIG. 12).

In step S32, the classification unit 162 of the learning unit 152 uses the DF information from the DF 111 (FIG. 9) and performs the classification according to the classification method (adopted classification method) indicated in the classification method information from the classification method decision unit 151. The learning unit 152 then performs the tap coefficient learning for calculating the tap coefficients of each class obtained by the classification. The learning unit 152 further supplies the initial coefficients that are the tap coefficients of each class obtained by the tap coefficient learning to the unused coefficient deletion unit 153, and the process proceeds from step S32 to step S33.

In step S33, the unused coefficient deletion unit 153 detects zero or one or more classes (of pixels) with small effect of image quality improvement as candidates for the removed class to be removed from the target of the adaptive classification process from among the initial coefficients from the learning unit 152. The process proceeds to step S34.

In step S34, the unused coefficient deletion unit 153 selects a removed class (candidate for removed class) from the candidates for the removed class to optimize the image quality of the decoded image and the amount of data of the encoded data, that is, to optimize, for example, the RD cost. The process proceeds to step S35.

In step S35, the unused coefficient deletion unit 153 determines that the tap coefficients of the removed class are unused coefficients and deletes the unused coefficients from the initial coefficients. The unused coefficient deletion unit 153 outputs, as adopted coefficients to be used for the adaptive classification process (filtering process of adaptive classification process), the tap coefficients after the deletion of the unused coefficients. The process ends.

The adopted coefficients output by the unused coefficient deletion unit 153 are supplied to the filter information generation unit 132.

### <Configuration Example of Image Conversion Apparatus 133>

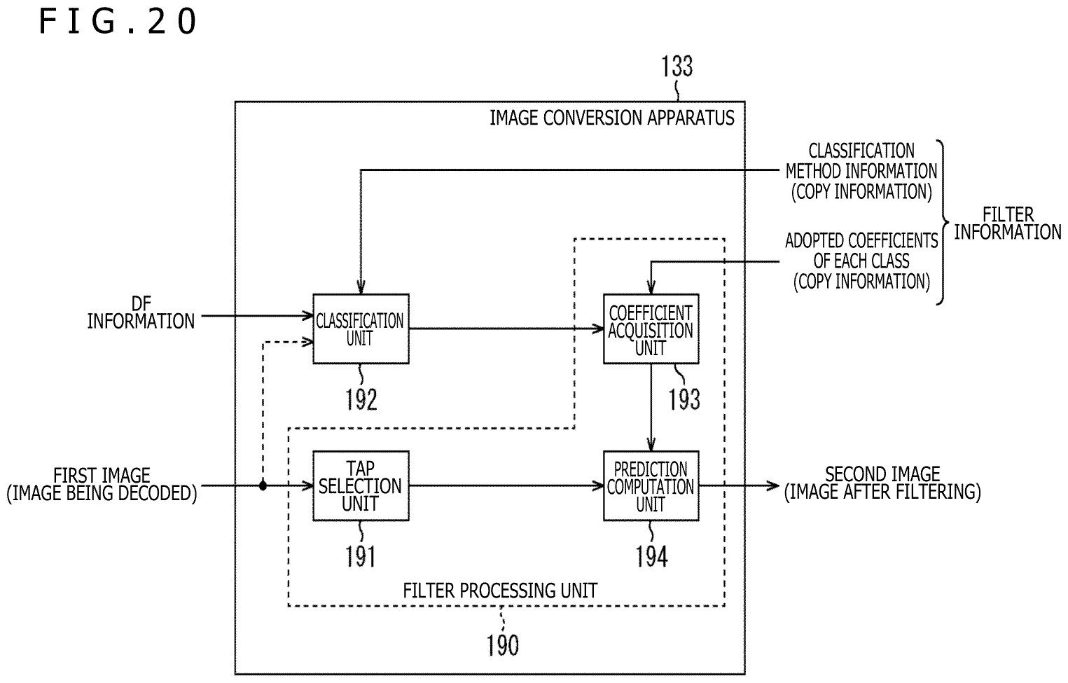

FIG. 20 is a block diagram illustrating a configuration example of the image conversion apparatus 133 of FIG. 11.

In FIG. 20, the image conversion apparatus 133 includes a tap selection unit 191, a classification unit 192, a coefficient acquisition unit 193, and a prediction computation unit 194.

The components from the tap selection unit 191 to the prediction computation unit 194 execute processes similar to the processes of the components from the tap selection unit 21 to the prediction computation unit 24 of the image conversion apparatus 20 of FIG. 2, respectively.

That is, the image being decoded as a first image and the DF information similar to the image being decoded and the DF information supplied to the learning apparatus 131 (FIG. 11) are supplied to the image conversion apparatus 133. The image conversion apparatus 133 uses the image being decoded as a first image and the DF information to execute the adaptive classification process similar to the adaptive classification process of the image conversion apparatus 20 of FIG. 2 and obtains the image after filtering as a second image equivalent to the original image.

However, the filter information is supplied to the image conversion apparatus 133 from the filter information generation unit 132.

In the image conversion apparatus 133, the classification unit 192 uses the DF information to classify the target pixel of the image being decoded based on the classification method indicated in the classification method information included in the filter information. That is, the classification unit 192 performs the same classification as the classification of the classification unit 162 (FIG. 12) of the learning apparatus 131. Therefore, in the case where the classification unit 162 of the learning apparatus 131 uses the image feature values and the encoded information of the image being decoded in addition to the DF information to perform the classification, the classification unit 192 also uses the image feature values and the encoded information of the image being decoded in addition to the DF information to perform the classification.

In addition, the coefficient acquisition unit 193 in the image conversion apparatus 133 stores the tap coefficients (adopted coefficients) included in the filter information and acquires, from the tap coefficients, the tap coefficients of the class of the target pixel obtained by the classification unit 192. The coefficient acquisition unit 193 supplies the tap coefficients to the prediction computation unit 194.

The prediction computation unit 194 then uses the prediction tap of the target pixel supplied from the tap selection unit 191 and the tap coefficients of the class of the target pixel supplied from the coefficient acquisition unit 193 to perform the prediction computation and obtains the predicted value of the pixel value of the corresponding pixel in the original image corresponding to the target pixel just like the prediction computation unit 24 of FIG. 2.

It can be stated that the prediction computation performed by the prediction computation unit 194 is a type of filtering process applied to the target pixel by using the prediction tap and the tap coefficients. Therefore, it can be stated that the tap selection unit 191 that forms the prediction tap used in the filtering process, the coefficient acquisition unit 193 that acquires the tap coefficients used in the filtering process, and the prediction computation unit 194 that preforms the prediction computation as a type of filtering process form the filter processing unit 190 that executes the filtering process.

In the filter processing unit 190, the prediction computation as a filtering process of the prediction computation unit 194 is a filtering process that varies according to the tap coefficients of the class of the target pixel acquired by the coefficient acquisition unit 193. Therefore, it can be stated that the filtering process of the filter processing unit 190 is a filtering process corresponding to the class of the target pixel.

Note that the filtering process of the filter processing unit 190 is not limited to the prediction computation, that is, the product-sum computation of the tap coefficients of the class of the target pixel and the prediction tap.

In addition, the copy information indicating whether to use the same classification method and tap coefficients as the classification method and the tap coefficients at the time of the preceding update of the classification method and the tap coefficients can be included in the filter information supplied from the filter information generation unit 132 to the image conversion apparatus 133 as described in FIG. 11.

Now, the use of the same classification method and tap coefficients as the classification method and the tap coefficients at the time of the preceding update of the classification method and the tap coefficients will be referred to as a copy mode.

In a case where the copy information included in the latest filter information supplied from the filter information generation unit 132 to the image conversion apparatus 133 does not indicate the copy mode, the classification unit 192 adopts, in subsequent classification, the classification method indicated in the classification method information included in the latest filter information instead of the classification method indicated in the classification method information included in the filter information of the last time supplied from the filter information generation unit 132 to the image conversion apparatus 133.

Furthermore, the coefficient acquisition unit 193 stores the tap coefficients of the class included in the latest filter information by overwriting the tap coefficients of each class included in the filter information of the last time.

On the other hand, in a case where the copy information included in the latest filter information indicates the copy mode (latest filter information does not include the classification method information and the tap coefficients of each class), the classification unit 192 adopts, in subsequent classification, the classification method indicated in the classification method information included in the filter information of the last time.

Furthermore, the coefficient acquisition unit 193 maintains the storage of the tap coefficients of each class included in the filter information of the last time.

Therefore, in the case where the copy information included in the latest filter information indicates the copy mode, the preceding classification method and tap coefficients of each class are maintained.

Note that the copy information can be separately provided for each of the classification method information and the tap coefficients of each class.

### <Encoding Process>

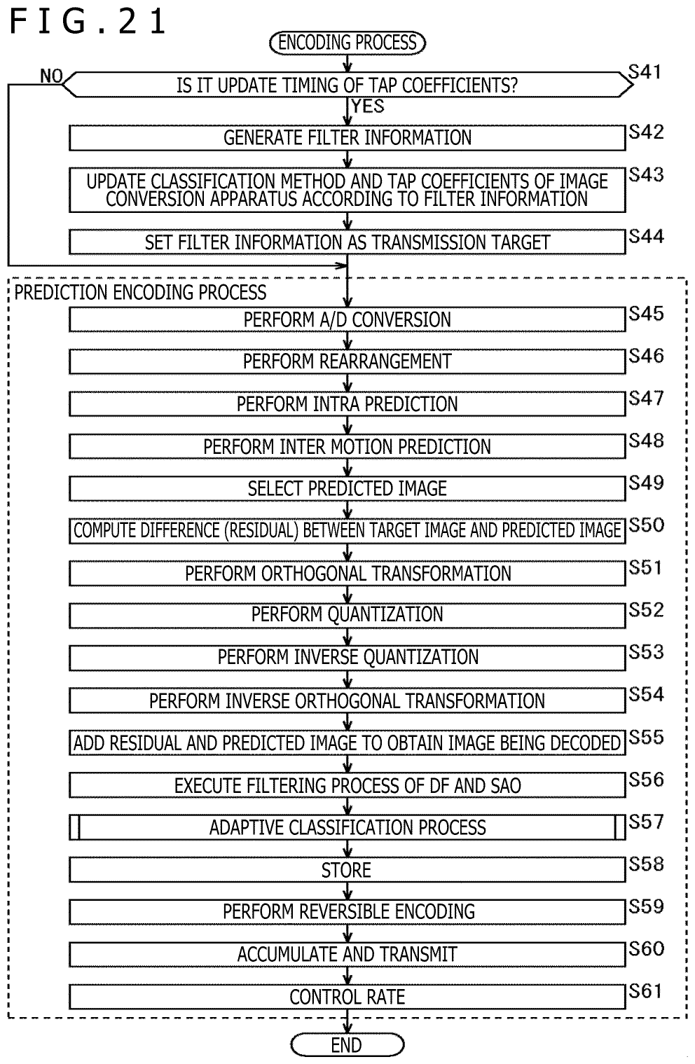

FIG. 21 is a flow chart describing an example of an encoding process of the encoding apparatus 11 in FIG. 9.

Note that the order of steps in the encoding process illustrated in FIG. 21 is an order for the convenience of description, and the steps of the actual encoding process are appropriately executed in parallel in a necessary order. This also similarly applies to encoding processes described later.

In the encoding apparatus 11, the learning apparatus 131 (FIG. 11) of the adaptive classification filter 113 sets, as student data, the images being decoded in a unit of update, such as a plurality of frames, one frame, and blocks, among the images being decoded supplied to the learning apparatus 131. The learning apparatus 131 sets the original images corresponding to the images being decoded as teacher data and sequentially performs the tap coefficient learning. The learning apparatus 131 then determines whether the current timing is update timing as predetermined timing of updating the tap coefficients and the classification method, that is, whether the current timing is timing of an end point or a start point of the unit of update, such as a plurality of frames, one frame, and blocks, in step S41.

In a case where the learning apparatus 131 determines that it is not the update timing of the tap coefficients and the classification method in step S41, the process skips steps S42 to S44 and proceeds to step S45.

Furthermore, in a case where the learning apparatus 131 determines that it is the update timing of the tap coefficients and the classification method in step S41, the process proceeds to step S42.

In step S42, the filter information generation unit 132 (FIG. 11) generates filter information including the classification method information and the tap coefficients of each class (or copy information) generated by the learning apparatus 131 through the latest tap coefficient learning and supplies the filter information to the image conversion apparatus 133 (FIG. 11) and the reversible encoding unit 106 (FIG. 9). The process proceeds to step S43.

Note that the encoding apparatus 11 can detect the correlation of the original image in the time direction and generate the filtering information at update timing only in a case where the correlation is low (equal to or smaller than a threshold) to execute processes of steps S43 and S44 described later.

In step S43, the image conversion apparatus 133 updates the method of classification (classification method) performed by the classification unit 192 (FIG. 20) and the tap coefficients of each class stored in the coefficient acquisition unit 193 (FIG. 20) according to the filter information from the filter information generation unit 132, and the process proceeds to step S44.

In step S44, the reversible encoding unit 106 sets the filter information supplied from the filter information generation unit 132 as a transmission target, and the process proceeds to step S45. The filter information set as the transmission target is included in the encoded data in step S59 described later and transmitted.

From step S45, a prediction encoding process of the original image is executed.

That is, the A/D conversion unit 101 performs A/D conversion of the original image and supplies the original image to the rearrangement buffer 102 in step S45, and the process proceeds to step S46.

In step S46, the rearrangement buffer 102 stores the original image from the A/D conversion unit 101 and rearranges and outputs the original image in order of encoding. The process proceeds to step S47.

In step S47, the intra prediction unit 116 executes an intra prediction process in an intra prediction mode, and the process proceeds to step S48. In step S48, the motion prediction compensation unit 117 executes an inter motion prediction process of performing motion prediction and motion compensation in an inter prediction mode, and the process proceeds to step S49.

In the intra prediction process of the intra prediction unit 116 and the inter motion prediction process of the motion prediction compensation unit 117, cost functions in various prediction modes are computed, and predicted images are generated.

In step S49, the predicted image selection unit 118 decides an optimal prediction mode based on each cost function obtained by the intra prediction unit 116 and the motion prediction compensation unit 117. The predicted image selection unit 118 then selects a predicted image in the optimal prediction mode among the predicted images generated by the intra prediction unit 116 and the predicted images generated by the motion prediction compensation unit 117 and outputs the predicted image. The process proceeds from step S49 to step S50.

In step S50, the computation unit 103 computes the residual between the target image to be encoded that is the original image output by the rearrangement buffer 102 and the predicted image output by the predicted image selection unit 118 and supplies the residual to the orthogonal transformation unit 104. The process proceeds to step S51.

In step S51, the orthogonal transformation unit 104 performs an orthogonal transformation of the residual from the computation unit 103 and supplies transformation coefficients obtained as a result of the orthogonal transformation to the quantization unit 105. The process proceeds to step S52.

In step S52, the quantization unit 105 quantizes the transformation coefficients from the orthogonal transformation unit 104 and supplies quantization coefficients obtained by the quantization to the reversible encoding unit 106 and the inverse quantization unit 108. The process proceeds to step S53.

In step S53, the inverse quantization unit 108 performs inverse quantization of the quantization coefficients from the quantization unit 105 and supplies the transformation coefficients obtained as a result of the inverse quantization to the inverse orthogonal transformation unit 109. The process proceeds to step S54. In step S54, the inverse orthogonal transformation unit 109 performs an inverse orthogonal transformation of the transformation coefficients from the inverse quantization unit 108 and supplies the residual obtained as a result of the inverse orthogonal transformation to the computation unit 110. The process proceeds to step S55.

In step S55, the computation unit 110 adds the residual from the inverse orthogonal transformation unit 109 and the predicted image output by the predicted image selection unit 118 to generate an image being decoded corresponding to the original image as the target of the computation of residual in the computation unit 103. The computation unit 110 supplies the image being decoded to the DF 111 or the frame memory 114, and the process proceeds from step S55 to step S56.

In the case where the image being decoded is supplied from the computation unit 110 to the DF 111, the DF 111 applies the filtering process of DF to the image being decoded from the computation unit 110 and supplies the image being decoded to the SAO 112 in step S56. The DF 111 also supplies the DF information regarding the filtering process of DF applied to the image being decoded to the adaptive classification filter 113. Furthermore, in step S56, the SAO 112 applies the filtering process of SAO to the image being decoded from the DF 111 and supplies the image being decoded to the adaptive classification filter 113. The process proceeds to step S57.

In step S57, the adaptive classification filter 113 applies the adaptive classification process (adaptive classification filtering process) equivalent to the ALF to the image being decoded from the SAO 112 and obtains an image after filtering closer to the original image than in the case of filtering the image being decoded by using the general ALF.

The adaptive classification filter 113 supplies the image after filtering obtained in the adaptive classification process to the frame memory 114, and the process proceeds from step S57 to step S58.

In step S58, the frame memory 114 stores, as a decoded image, the image being decoded supplied from the computation unit 110 or the image after filtering supplied from the adaptive classification filter 113, and the process proceeds to step S59. The decoded image stored in the frame memory 114 is used as a reference image as a source of generating the predicted image in step S48 or S49.

In step S59, the reversible encoding unit 106 encodes the quantization coefficients from the quantization unit 105. The reversible encoding unit 106 further encodes the encoded information, such as the quantization parameter QP used in the quantization by the quantization unit 105, the prediction mode obtained in the intra prediction process of the intra prediction unit 116, and the prediction mode and the motion information obtained in the inter motion prediction process of the motion prediction compensation unit 117, as necessary and includes the encoded information in the encoded data.

The reversible encoding unit 106 also encodes the filter information set as the transmission target in step S44 as necessary and includes the filter information in the encoded data. The reversible encoding unit 106 then supplies the encoded data to the accumulation buffer 107, and the process proceeds from step S59 to step S60.

In step S60, the accumulation buffer 107 accumulates the encoded data from the reversible encoding unit 106, and the process proceeds to step S61. The encoded data accumulated in the accumulation buffer 107 is appropriately read and transmitted.

In step S61, the rate control unit 119 controls the rate (quantization step) of the quantization operation of the quantization unit 105 based on the code amount (generated code amount) of the encoded data accumulated in the accumulation buffer 107 to prevent the occurrence of an overflow or an underflow, and the encoding process ends.

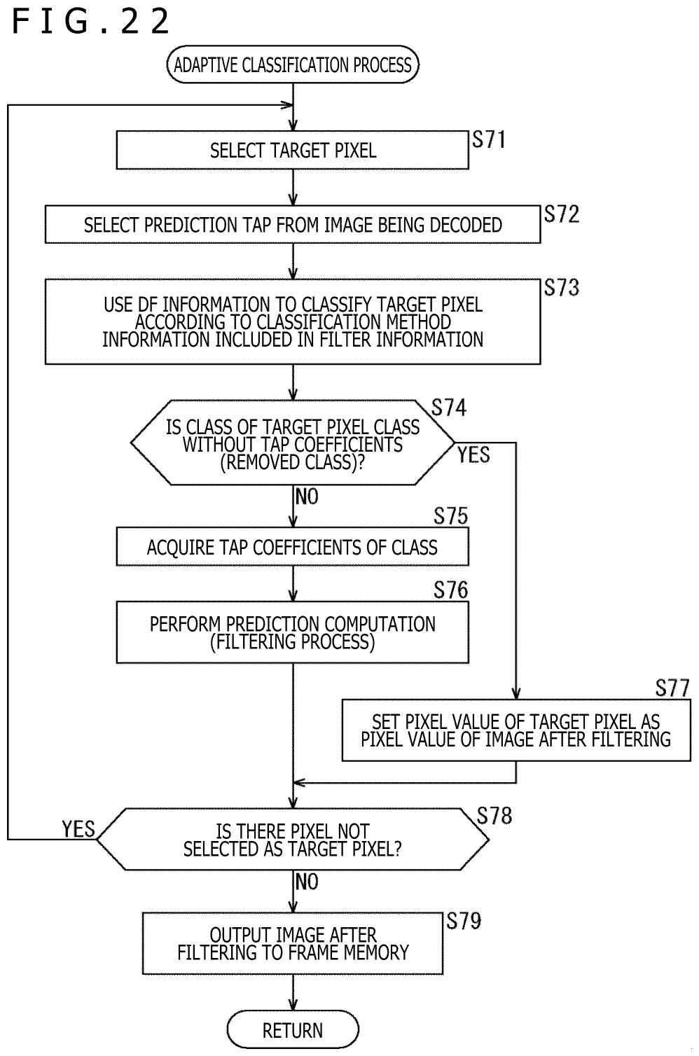

FIG. 22 is a flow chart describing an example of the adaptive classification process executed in step S57 of FIG. 21.

In the image conversion apparatus 133 (FIG. 20) of the adaptive classification filter 113, the tap selection unit 191 selects, as a target pixel, a pixel that has not been the target pixel yet among the pixels of the image being decoded (block as the image being decoded) supplied from the SAO 112 (FIG. 9) in step S71. The process proceeds to step S72.

In step S72, the tap selection unit 191 selects pixels to be a prediction tap regarding the target pixel from the image being decoded supplied from the SAO 112 and forms the prediction tap. The tap selection unit 191 then supplies the prediction tap to the prediction computation unit 194, and the process proceeds to step S73.

In step S73, the classification unit 192 uses the DF information from the DF 111 to classify the target pixel based on the classification method indicated in the classification method information included in the filter information from the filter information generation unit 132 (FIG. 11). The classification unit 192 supplies the class of the target pixel obtained by the classification to the coefficient acquisition unit 193, and the process proceeds from step S73 to step S74.

Note that the method of classification performed by the classification unit 192 is updated in the preceding update of the classification method of step S43 in FIG. 21, and the classification unit 192 performs the classification of the classification method after the update.

In step S74, the coefficient acquisition unit 193 determines whether the class of the target pixel from the classification unit 192 is the removed class without tap coefficients.

That is, the coefficient acquisition unit 193 stores the tap coefficients of each class included in the filter information supplied from the filter information generation unit 132, that is, the adopted coefficients in which the tap coefficients of the removed class are deleted from the initial coefficients by the unused coefficient deletion unit 153 (FIG. 12), in the preceding update of the tap coefficients of step S43 in FIG. 21.

In step S74, the coefficient acquisition unit 193 determines whether the class of the target pixel from the classification unit 192 is the removed class without tap coefficients among the stored adopted coefficients.

In a case where the coefficient acquisition unit 193 determines that the class of the target pixel is not the removed class in step S74, that is, in a case where the tap coefficients of the class of the target pixel are included in the adopted coefficients stored in the coefficient acquisition unit 193, the process proceeds to step S75.

In step S75, the coefficient acquisition unit 193 acquires, from the stored adopted coefficients, the tap coefficients of the class of the target pixel from the classification unit 192 and supplies the tap coefficients to the prediction computation unit 194. The process proceeds to step S76.

In step S76, the prediction computation unit 194 uses the prediction tap from the tap selection unit 191 and the tap coefficients from the coefficient acquisition unit 193 to perform the prediction computation of Formula (1) as a filtering process. As a result, the prediction computation unit 194 obtains, as a pixel value of the image after filtering, the predicted value of the pixel value of the corresponding pixel of the original image corresponding to the target pixel. The process proceeds to step S78.

On the other hand, in a case where the coefficient acquisition unit 193 determines that the class of the target pixel is the removed class in step S74, that is, in a case where the tap coefficients of the class of the target pixel are not included in the adopted coefficients stored in the coefficient acquisition unit 193, the process proceeds to step S77.

In step S77, the prediction computation unit 194 sets, for example, the pixel value of the target pixel included in the prediction tap from the tap selection unit 191 as the pixel value of the corresponding pixel of the image after filtering, and the process proceeds to step S78.

In step S78, the tap selection unit 191 determines whether there is a pixel that has not been the target pixel yet among the pixels of the image being decoded (block as the image being decoded) from the SAO 112. In a case where the tap selection unit 191 determines that there is a pixel that has not been the target pixel yet in step S78, the process returns to step S71, and thereafter, a similar process is repeated.

Furthermore, in a case where the tap selection unit 191 determines that there is no pixel that has not been the target pixel yet in step S78, the process proceeds to step S79, and the prediction computation unit 194 supplies, to the frame memory 114 (FIG. 9), the image after filtering including the pixel values obtained for the image being decoded (block as the image being decoded) from the SAO 112. The adaptive classification process then ends, and the process returns.

### <First Configuration Example of Decoding Apparatus 12>

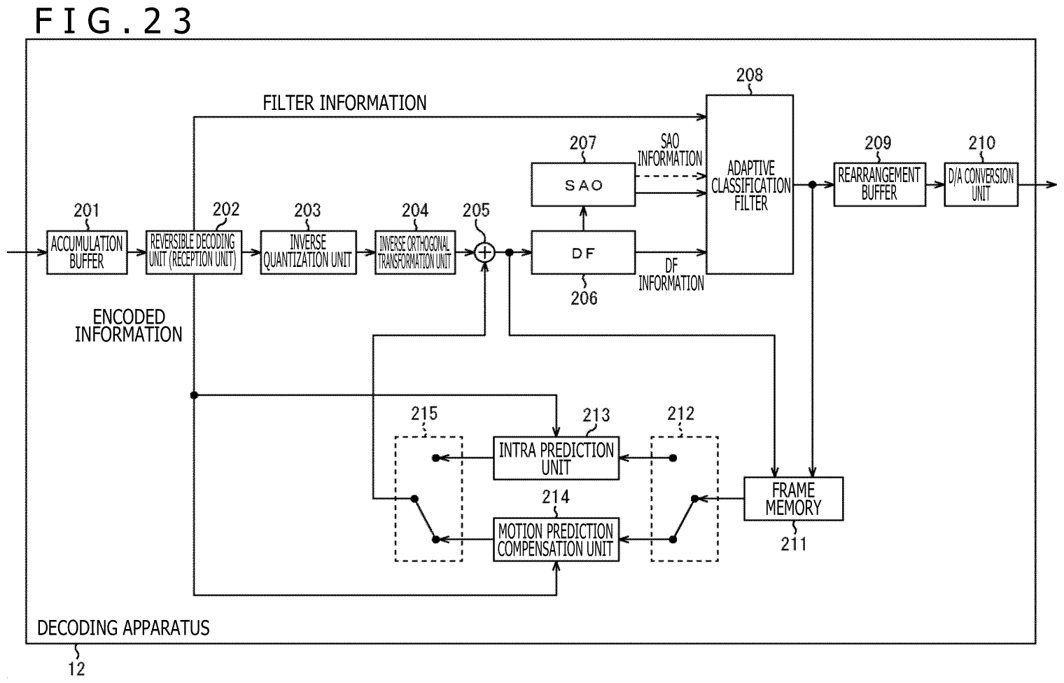

FIG. 23 is a block diagram illustrating a first configuration example of the decoding apparatus 12 of FIG. 1.

In FIG. 23, the decoding apparatus 12 includes an accumulation buffer 201, a reversible decoding unit 202, an inverse quantization unit 203, an inverse orthogonal transformation unit 204, a computation unit 205, a DF 206, an SAO 207, an adaptive classification filter 208, a rearrangement buffer 209, and a D/A conversion unit 210. The decoding apparatus 12 also includes a frame memory 211, a selection unit 212, an intra prediction unit 213, a motion prediction compensation unit 214, and a selection unit 215.

The accumulation buffer 201 temporarily accumulates the encoded data transmitted from the encoding apparatus 11 and supplies the encoded data to the reversible decoding unit 202 at predetermined timing.

The reversible decoding unit 202 acquires the encoded data from the accumulation buffer 201. Therefore, the reversible decoding unit 202 functions as a collection unit that collects the encoded data transmitted from the encoding apparatus 11, that is, the encoded information and the filter information included in the encoded data.

The reversible decoding unit 202 uses a system corresponding to the encoding system of the reversible encoding unit 106 of FIG. 9 to decode the encoded data acquired from the accumulation buffer 201.

The reversible decoding unit 202 then supplies the quantization coefficients obtained by decoding the encoded data to the inverse quantization unit 203.

In addition, in a case where the encoded information and the filter information are obtained by decoding the encoded data, the reversible decoding unit 202 supplies necessary encoded information to the intra prediction unit 213, the motion prediction compensation unit 214, and other necessary blocks.

The reversible decoding unit 202 further supplies the filter information to the adaptive classification filter 208.

The inverse quantization unit 203 uses a system corresponding to the quantization system of the quantization unit 105 of FIG. 9 to perform inverse quantization of the quantization coefficients from the reversible decoding unit 202 and supplies the transformation coefficients obtained by the inverse quantization to the inverse orthogonal transformation unit 204.

The inverse orthogonal transformation unit 204 uses a system corresponding to the orthogonal transformation system of the orthogonal transformation unit 104 of FIG. 9 to perform an inverse orthogonal transformation of the transformation coefficients supplied from the inverse quantization unit 203 and supplies the residual obtained as a result of the inverse orthogonal transformation to the computation unit 205.

The residual is supplied from the inverse orthogonal transformation unit 204 to the computation unit 205, and the predicted image is also supplied from the intra prediction unit 213 or the motion prediction compensation unit 214 to the computation unit 205 through the selection unit 215.

The computation unit 205 adds the residual from the inverse orthogonal transformation unit 204 and the predicted image from the selection unit 215 to generate an image being decoded and supplies the image being decoded to the DF 206 or the frame memory 211.

The DF 206 applies the filtering process similar to the filtering process of the DF 111 (FIG. 9) to the image being decoded from the computation unit 205 and supplies the image being decoded after the filtering process to the SAO 207.

The SAO 207 applies the filtering process similar to the filtering process of the SAO 112 (FIG. 9) to the image being decoded from the DF 206 and supplies the image being decoded to the adaptive classification filter 208.

Through the adaptive classification process, the adaptive classification filter 208 uses the filter that functions as the ALF among the DF, the SAO, and the ALF that are ILFs and executes the filtering process equivalent to the ALF based on the adaptive classification process.

The image being decoded is supplied from the SAO 207 to the adaptive classification filter 208. In addition, the DF information and the SAO information as previous-stage filter related information regarding the filtering process of the DF 206 or the SAO 207 as a previous-stage filtering process executed in the previous stage of the filtering process of the adaptive classification filter 208 is supplied to the adaptive classification filter 208.

Through the adaptive classification process, the adaptive classification filter 208 uses the filter that functions as the ALF to execute the filtering process equivalent to the ALF just like the adaptive classification filter 113 (FIG. 9).

That is, the adaptive classification filter 208 sets the image being decoded from the SAO 207 as a first image and uses the tap coefficients of each class included in the filter information from the reversible decoding unit 202 to execute the adaptive classification process (image conversion in the adaptive classification process). In this way, the adaptive classification filter 208 converts the image being decoded as a first image into the image after filtering as a second image equivalent to the original image (generates the image after filtering) and outputs the image after filtering.

Here, the adaptive classification filter 208 uses the DF information from the DF 206 to perform the classification of the classification method indicated in the classification method information included in the filter information from the reversible decoding unit 202 in the adaptive classification process just like the adaptive classification filter 113 of FIG. 9 (image conversion apparatus 133 (FIG. 20) of adaptive classification filter 113).

Note that in the present embodiment, although the DF information is adopted as the previous-stage filter related information used by the adaptive classification filter 113 for the classification in order to simplify the description, the adaptive classification filter 208 also uses the DF information and the SAO information to perform the classification in the case where, for example, the adaptive classification filter 113 uses the DF information and the SAO information to perform the classification.

The image after filtering output by the adaptive classification filter 208 is an image similar to the image after filtering output by the adaptive classification filter 113, and the image after filtering is supplied to the rearrangement buffer 209 and the frame memory 211.

The rearrangement buffer 209 temporarily stores, as a decoded image, the image after filtering supplied from the adaptive classification filter 208. The rearrangement buffer 209 rearranges the order of frames (pictures) of the decoded image from the order of encoding (decoding) to the order of display and supplies the decoded image to the D/A conversion unit 210.

The D/A conversion unit 210 performs D/A conversion of the decoded image supplied from the rearrangement buffer 209 and outputs and displays the decoded image on a display not illustrated.

The frame memory 211 temporarily stores, as a decoded image, the image being decoded supplied from the computation unit 205 or the image after filtering supplied from the adaptive classification filter 208. Furthermore, the frame memory 211 supplies the decoded image as a reference image used for generating the predicted image to the selection unit 212 at predetermined timing or based on an external request from the intra prediction unit 213, the motion prediction compensation unit 214, or the like.

The selection unit 212 selects the supply destination of the reference image supplied from the frame memory 211. In the case of decoding the image after intra encoding, the selection unit 212 supplies the reference image supplied from the frame memory 211 to the intra prediction unit 213. Furthermore, in the case of decoding the image after inter encoding, the selection unit 212 supplies the reference image supplied from the frame memory 211 to the motion prediction compensation unit 214.

The intra prediction unit 213 uses the reference image supplied from the frame memory 211 through the selection unit 212 to perform intra prediction in the intra prediction mode used by the intra prediction unit 116 of FIG. 9 according to the prediction mode included in the encoded information supplied from the reversible decoding unit 202. The intra prediction unit 213 then supplies the predicted image obtained by the intra prediction to the selection unit 215.

The motion prediction compensation unit 214 uses the reference image supplied from the frame memory 211 through the selection unit 212 to perform the inter prediction in the inter prediction mode used by the motion prediction compensation unit 117 of FIG. 9 according to the prediction mode included in the encoded information supplied from the reversible decoding unit 202. The inter prediction is performed by using the motion information or the like included in the encoded information supplied from the reversible decoding unit 202 as necessary.

The motion prediction compensation unit 214 supplies the predicted image obtained by the inter prediction to the selection unit 215.

The selection unit 215 selects the predicted image supplied from the intra prediction unit 213 or the predicted image supplied from the motion prediction compensation unit 214 and supplies the predicted image to the computation unit 205.

### <Configuration Example of Adaptive Classification Filter 208>

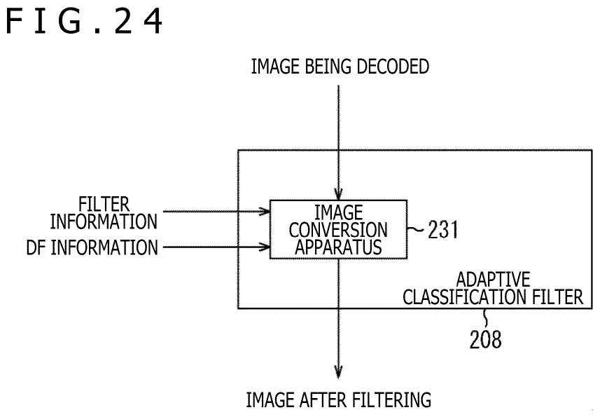

FIG. 24 is a block diagram illustrating a configuration example of the adaptive classification filter 208 of FIG. 23.

In FIG. 24, the adaptive classification filter 208 includes an image conversion apparatus 231.

The image being decoded is supplied from the SAO 207 (FIG. 23) to the image conversion apparatus 231, and the filter information is supplied from the reversible decoding unit 202 to the image conversion apparatus 231. Furthermore, the DF information is supplied from the DF 206 to the image conversion apparatus 231.

Similar to the image conversion apparatus 133 of FIG. 11, the image conversion apparatus 231 sets the image being decoded as a first image and performs the classification of the classification method indicated in the classification method information included in the filter information, that is, the same classification as the classification performed by the image conversion apparatus 133, by using the DF information from the DF 206 as well as necessary image feature values and encoded information of the image being decoded. The image conversion apparatus 231 further performs, as a filtering process corresponding to the class obtained as a result of the classification, image conversion in the adaptive classification process of performing the prediction computation that is a filtering process using the tap coefficients (adopted coefficients) of each class included in the filter information. In this way, the image conversion apparatus 231 converts the image being decoded as a first image into the image after filtering as a second image equivalent to the original image (generates the image after filtering) and supplies the image after filtering to the rearrangement buffer 209 and the frame memory 211 (FIG. 23).

### <Configuration Example of Image Conversion Apparatus 231>

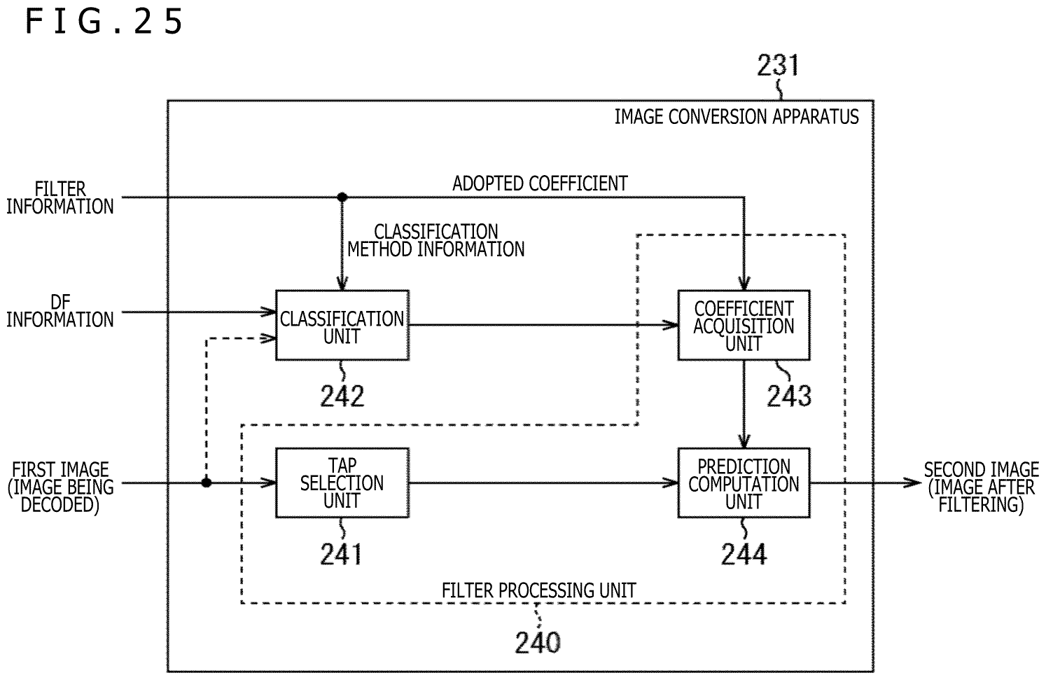

FIG. 25 is a block diagram illustrating a configuration example of the image conversion apparatus 231 of FIG. 24.

In FIG. 25, the image conversion apparatus 231 includes a tap selection unit 241, a classification unit 242, a coefficient acquisition unit 243, and a prediction computation unit 244.

The configurations of the components from the tap selection unit 241 to the prediction computation unit 244 are similar to the configurations of the components from the tap selection unit 191 to the prediction computation unit 194 included in the image conversion apparatus 133 (FIG. 20), respectively.

That is, the image being decoded is supplied from the SAO 207 (FIG. 23) to the tap selection unit 241.

The tap selection unit 241 sets the image being decoded from the SAO 207 as a first image and sequentially selects the pixels of the image being decoded as target pixels.

The tap selection unit 241 further selects, from the image being decoded, the prediction tap in the same structure as the prediction tap selected by the tap selection unit 191 of FIG. 20 regarding the target pixel and supplies the prediction tap to the prediction computation unit 244.

The filter information is supplied from the reversible decoding unit 202 (FIG. 23) to the classification unit 242, and the DF information is supplied from the DF 206 to the classification unit 242.

For the target pixel, the classification unit 242 uses the DF information from the DF 206 to perform the classification of the classification method indicated in the classification method information included in the filter information from the reversible decoding unit 202 to thereby perform classification similar to the classification of the classification unit 192 (FIG. 20).

Therefore, in the case where, for example, the classification unit 192 uses the image feature values and the encoded information of the image being decoded in addition to the DF information to perform the classification, the classification unit 242 also uses the image feature values and the encoded information of the image being decoded in addition to the DF information to perform the classification.

The coefficient acquisition unit 243 stores the tap coefficients (adopted coefficients) included in the filter information from the reversible decoding unit 202 (FIG. 23) and acquires, from the tap coefficients, the tap coefficients of the class of the target pixel obtained by the classification unit 242 to supply the tap coefficients to the prediction computation unit 244.

The prediction computation unit 244 uses the prediction tap from the tap selection unit 241 and the tap coefficients from the coefficient acquisition unit 243 to perform the prediction computation of Formula (1) as a filtering process and obtains and outputs, as a pixel value of the pixel of the image after filtering that is the second image, a predicted value of the pixel value of the corresponding pixel of the original image corresponding to the target pixel of the image being decoded.

Here, it can be stated that in the image conversion apparatus 231 of FIG. 25, the tap selection unit 241, the coefficient acquisition unit 243, and the prediction computation unit 244 form the filter processing unit 240 that executes the filtering process corresponding to the class of the target pixel just like the tap selection unit 191, the coefficient acquisition unit 193, and the prediction computation unit 194 of the image conversion apparatus 133 of FIG. 20.

Note that the copy information indicating whether to use the same classification method information and tap coefficients of each class as the classification method information and the tap coefficients of each class at the time of the preceding update of the classification method information and the tap coefficients of each class can be included in the filter information supplied from the reversible decoding unit 202 to the image conversion apparatus 231 as described in FIG. 11.

In the case where the copy information included in the latest filter information supplied from the reversible decoding unit 202 to the image conversion apparatus 231 does not indicate the copy mode, the classification unit 242 performs the classification by adopting the classification method indicated in the classification method information included in the latest filter information instead of the classification method indicated in the classification method information included in the filter information of the last time supplied from the reversible decoding unit 202 to the image conversion apparatus 231.

Furthermore, the coefficient acquisition unit 243 stores the tap coefficients of each class included in the latest filter information by overwriting the tap coefficients of each class included in the filter information of the last time.

On the other hand, in the case where the copy information included in the latest filter information indicates the copy mode, the classification unit 242 performs the classification by adopting the classification method indicated in the classification method information included in the filter information of the last time.

Furthermore, the coefficient acquisition unit 243 maintains the storage of the tap coefficients of each class included in the filter information of the last time.

Therefore, in the case where the copy information included in the latest filter information indicates the copy mode, the classification method and the tap coefficients of each class indicated in the preceding classification method information are also maintained in the image conversion apparatus 231 as in the image conversion apparatus 133 (FIG. 11) (FIG. 20).

### <Decoding Process>

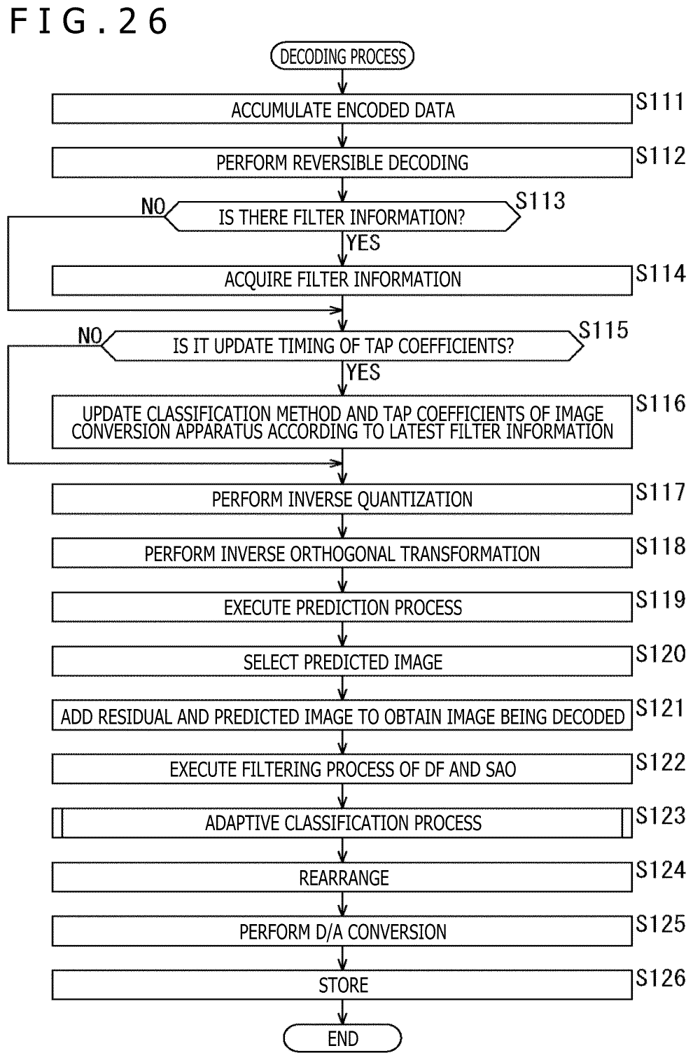

FIG. 26 is a flow chart describing an example of the decoding process of the decoding apparatus 12 in FIG. 23.

Note that the order of steps in the decoding process illustrated in FIG. 26 is an order for the convenience of description, and the steps of the actual decoding process are appropriately executed in parallel in a necessary order. This also similarly applies to decoding processes described later.

In the decoding process, the accumulation buffer 201 temporarily accumulates the encoded data transmitted from the encoding apparatus 11 and appropriately supplies the encoded data to the reversible decoding unit 202 in step S111. The process proceeds to step S112.

In step S112, the reversible decoding unit 202 collects and decodes the encoded data supplied from the accumulation buffer 201 and supplies the quantization coefficients obtained by the decoding to the inverse quantization unit 203.

Furthermore, in a case where the encoded information or the filter information is obtained by decoding the encoded data, the reversible decoding unit 202 supplies necessary encoded information to the intra prediction unit 213, the motion prediction compensation unit 214, and other necessary blocks.

The reversible decoding unit 202 further supplies the filter information to the adaptive classification filter 208.

Subsequently, the process proceeds from step S112 to step S113, and the adaptive classification filter 208 determines whether the filter information is supplied from the reversible decoding unit 202.

In a case where the adaptive classification filter 208 determines that the filter information is not supplied in step S113, the process skips step S114 and proceeds to step S115.

Furthermore, in a case where the adaptive classification filter 208 determines that the filter information is supplied in step S113, the process proceeds to step S114. The image conversion apparatus 231 (FIG. 25) of the adaptive classification filter 208 acquires the filter information from the reversible decoding unit 202, and the process proceeds to step S115.

In step S115, the image conversion apparatus 231 determines whether it is update timing of the classification method and the tap coefficients, that is, for example, whether it is timing of an end point or a start point of the unit of update, such as a plurality of frames, one frame, and blocks.

Here, the unit of update can be recognized from, for example, the tier (for example, Sequence parameter set syntax, Picture parameter set syntax, Slice data syntax, or the like) of the encoded data provided with (including) the filter information.

For example, in a case where the filter information is provided as the Picture parameter set syntax of the encoded data, it can be recognized that the unit of update is one frame.

In addition, the unit of update can be determined in advance between the encoding apparatus 11 and the decoding apparatus 12.

In a case where the image conversion apparatus 231 determines that it is not the update timing of the classification method and the tap coefficients in step S115, the process skips step S116 and proceeds to step S117.

Furthermore, in a case where the image conversion apparatus 231 determines that it is the update timing of the classification method and the tap coefficients in step S115, the process proceeds to step S116.

In step S116, the image conversion apparatus 231 updates the classification method of the classification performed by the classification unit 242 (FIG. 25) and the tap coefficients of each class stored in the coefficient acquisition unit 243 (FIG. 25) according to the filter information acquired in the preceding step S114, and the process proceeds to step S117.

In step S117, the inverse quantization unit 203 performs inverse quantization of the quantization coefficients from the reversible decoding unit 202 and supplies the transformation coefficients obtained as a result of the inverse quantization to the inverse orthogonal transformation unit 204. The process proceeds to step S118.

In step S118, the inverse orthogonal transformation unit 204 performs the inverse orthogonal transformation of the transformation coefficients from the inverse quantization unit 203 and supplies the residual obtained as a result of the inverse orthogonal transformation to the computation unit 205. The process proceeds to step S119.

In step S119, the intra prediction unit 213 or the motion prediction compensation unit 214 executes the prediction process of generating the predicted image by using the reference image supplied from the frame memory 211 through the selection unit 212 and the encoded information supplied from the reversible decoding unit 202. The intra prediction unit 213 or the motion prediction compensation unit 214 then supplies the predicted image obtained in the prediction process to the selection unit 215, and the process proceeds from step S119 to step S120.

In step S120, the selection unit 215 selects the predicted image supplied from the intra prediction unit 213 or the motion prediction compensation unit 214 and supplies the predicted image to the computation unit 205. The process proceeds to step S121.

In step S121, the computation unit 205 adds the residual from the inverse orthogonal transformation unit 204 and the predicted image from the selection unit 215 to generate the image being decoded. The computation unit 205 then supplies the image being decoded to the DF 206 or the frame memory 211, and the process proceeds from step S121 to step S122.

In the case where the image being decoded is supplied from the computation unit 205 to the DF 206, the DF 206 applies the filtering process of DF to the image being decoded from the computation unit 205 in step S122. The DF 206 supplies the image being decoded to the SAO 207 and supplies the DF information regarding the filtering process of DF applied to the image being decoded to the adaptive classification filter 208. Furthermore, the SAO 207 applies the filtering process of SAO to the image being decoded from the DF 206 in step S122 and supplies the image being decoded to the adaptive classification filter 208. The process proceeds to step S123.

In step S123, the adaptive classification filter 208 applies the adaptive classification process equivalent to the ALF to the image being decoded from the SAO 207. The application of the adaptive classification process to the image being decoded can obtain the image after filtering closer to the original image than in the case of using the ALF to filter the image being decoded, as in the case of the encoding apparatus 11.

Note that the adaptive classification filter 208 uses the DF information from the DF 206 to perform the classification of the classification method indicated in the classification method information included in the filter information from the reversible decoding unit 202. The adaptive classification filter 208 also uses the tap coefficients included in the filter information from the reversible decoding unit 202 to execute the adaptive classification process.

The adaptive classification filter 208 supplies the image after filtering obtained in the adaptive classification process to the rearrangement buffer 209 and the frame memory 211, and the process proceeds from step S123 to step S124.

In step S124, the rearrangement buffer 209 temporarily stores, as a decoded image, the image after filtering supplied from the adaptive classification filter 208. The rearrangement buffer 209 further rearranges the stored decoded image in the order of display and supplies the decoded image to the D/A conversion unit 210. The process proceeds from step S124 to step S125.

In step S125, the D/A conversion unit 210 performs the D/A conversion of the decoded image from the rearrangement buffer 209, and the process proceeds to step S126. The decoded image after the D/A conversion is output to and displayed by a display not illustrated.

In step S126, the frame memory 211 stores, as a decoded image, the image being decoded supplied from the computation unit 205 or the image after filtering supplied from the adaptive classification filter 208, and the decoding process ends. The decoded image stored in the frame memory 211 is used as a reference image as a source of generating the predicted image in the prediction process of step S119.

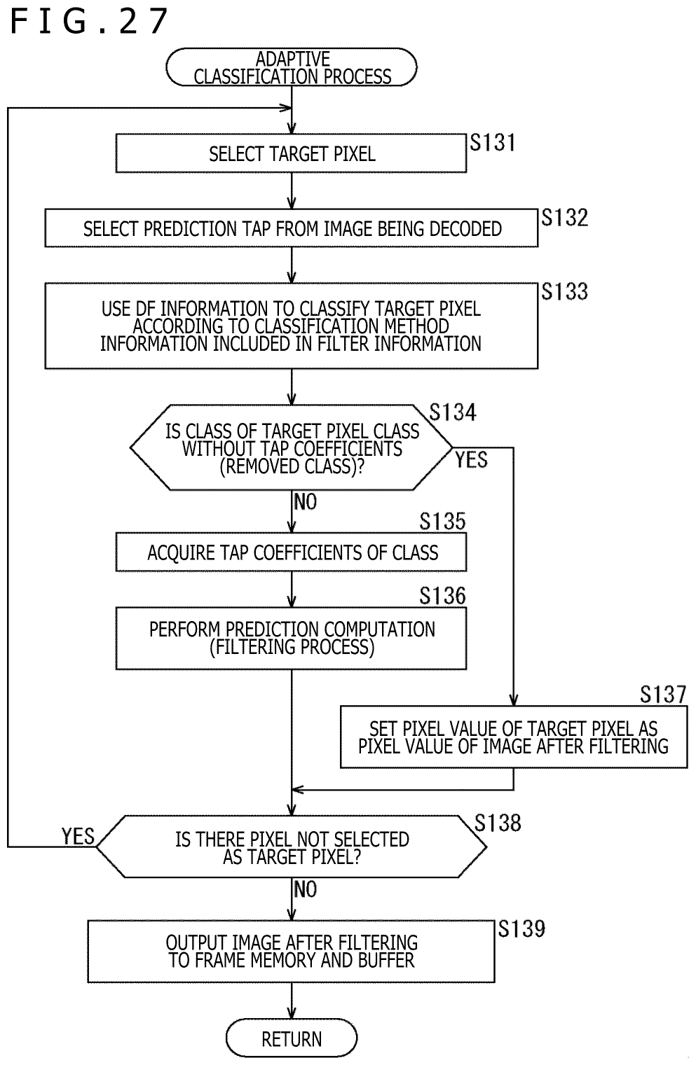

FIG. 27 is a flow chart describing an example of the adaptive classification process executed in step S123 of FIG. 26.

In the image conversion apparatus 231 (FIG. 25) of the adaptive classification filter 208, the tap selection unit 241 selects, as a target pixel, a pixel that has not been the target pixel yet among the pixels of the image being decoded (block as the image being decoded) supplied from the SAO 207 (FIG. 23) in step S131. The process proceeds to step S132.

In step S132, the tap selection unit 241 selects pixels to be a prediction tap regarding the target pixel from the image being decoded supplied from the SAO 207 and forms the prediction tap. The tap selection unit 241 then supplies the prediction tap to the prediction computation unit 244, and the process proceeds from step S132 to S133.

In step S133, the classification unit 242 uses the DF information from the DF 206 to classify the target pixel based on the classification method indicated in the classification method information included in the filter information from the reversible decoding unit 202 (FIG. 23). The classification unit 242 supplies the class of the target pixel obtained by the classification to the coefficient acquisition unit 243, and the process proceeds from step S133 to step S134.

Note that the method of classification performed by the classification unit 242 is updated in the preceding update of the classification method of step S116 in FIG. 26, and the classification unit 242 performs the classification of the classification method after the update.

In step S134, the coefficient acquisition unit 243 determines whether the class of the target pixel from the classification unit 242 is the removed class without tap coefficients.

That is, the coefficient acquisition unit 243 stores the tap coefficients of each class included in the filter information supplied from the reversible decoding unit 202 (FIG. 23), that is, the adopted coefficients in which the tap coefficients of the removed class are deleted from the initial coefficients by the unused coefficient deletion unit 153 (FIG. 12), in the preceding update of the tap coefficients of step S116 in FIG. 26.

In step S134, the coefficient acquisition unit 243 determines whether the class of the target pixel from the classification unit 242 is the removed class without tap coefficients among the stored adopted coefficients.

In a case where the coefficient acquisition unit 243 determines that the class of the target pixel is not the removed class in step S134, that is, in a case where the tap coefficients of the class of the target pixel are included in the adopted coefficients stored in the coefficient acquisition unit 243, the process proceeds to step S135.

In step S135, the coefficient acquisition unit 243 acquires, from the stored adopted coefficients, the tap coefficients of the class of the target pixel from the classification unit 242 and supplies the tap coefficients to the prediction computation unit 244. The process proceeds to step S136.

In step S136, the prediction computation unit 244 uses the prediction tap from the tap selection unit 241 and the tap coefficients from the coefficient acquisition unit 243 to perform the prediction computation of Formula (1) as a filtering process. As a result, the prediction computation unit 244 obtains, as a pixel value of the image after filtering, the predicted value of the pixel value of the corresponding pixel of the original image corresponding to the target pixel. The process proceeds to step S138.

On the other hand, in a case where the coefficient acquisition unit 243 determines that the class of the target pixel is the removed class in step S134, that is, in a case where the tap coefficients of the class of the target pixel are not included in the adopted coefficients stored in the coefficient acquisition unit 243, the process proceeds to step S137.

In step S137, the prediction computation unit 244 sets, for example, the pixel value of the target pixel included in the prediction tap from the tap selection unit 241 as the pixel value of the corresponding pixel of the image after filtering, and the process proceeds to step S138.

In step S138, the tap selection unit 241 determines whether there is a pixel that has not been the target pixel yet among the pixels of the image being decoded (block as the image being decoded) from the SAO 207. In a case where the tap selection unit 241 determines that there is a pixel that has not been the target pixel yet in step S138, the process returns to step S131, and thereafter, a similar process is repeated.

Furthermore, in a case where the tap selection unit 241 determines that there is no pixel that has not been the target pixel yet in step S138, the process proceeds to step S139, and the prediction computation unit 244 supplies, to the rearrangement buffer 209 and the frame memory 211 (FIG. 23), the image after filtering including the pixel values obtained for the image being decoded (block as the image being decoded) from the SAO 207. The adaptive classification process then ends, and the process returns.

In this way, the encoding apparatus 11 and the decoding apparatus 12 classify the image being decoded by using the DF information as previous-stage filter related information regarding the filtering process of DF as a previous-stage filtering process executed before the adaptive classification process.

Therefore, each pixel of the image being decoded is classified based on whether the DF applied to the image being decoded is a string filter or a weak filter and based on the position of the pixel subjected to the DF (for example, the position adjacent to the block boundary and the position near the block boundary). Therefore, the filtering process of DF as a previous-stage filtering process can be taken into account to obtain statistically optimal tap coefficients in the tap coefficient learning. As a result, a PSNR (Peak signal-to-noise ratio) can be significantly improved.

In addition, the classification method that optimizes the RD cost can be adopted as the method of classification to improve the image quality of the decoded image and reduce the amount of data of the encoded data.

Note that although the adaptive classification filter 113 is provided in place of the ALF among the DF, the SAO, and the ALF that are ILFs in the encoding apparatus 11, the adaptive classification filter 113 can be provided in place of the DF or the SAO, or the adaptive classification filter 113 can be provided in place of two or more or all of the DF, the SAO, and the ALF.

In the case where the adaptive classification filter 113 is provided in place of one or more filters among the DF, the SAO, and the ALF that are ILFs, the adaptive classification filter 113 can use the previous-stage filter related information regarding the previous-stage filtering process to perform the classification when a previous-stage filtering process is executed in the previous stage of the adaptive classification filter 113.

In addition, the order of arrangement of the DF, the SAO, and the ALF that are ILFs is not limited to the order of DF, SAO, and ALF.

For example, the ILFs can be arranged in the order of ALF, DF, and SAO, and the adaptive classification filter can be provided in place of the ALF among the ILFs arranged in the order of ALF, DF, and SAO. In this case, the classification can be performed by using, as previous-stage filter related information, the information regarding the filtering process executed by the adaptive classification filter in, for example, the DF in the later stage of the adaptive classification filter, and the filtering process of DF corresponding to the class obtained as a result of the classification can be executed.

Furthermore, the ILFs are not limited to the DF, the SAO, and the ALF, and another new filter can be provided as an ILF. The adaptive classification filter can be provided in place of the new filter.

These are similarly applied to the decoding apparatus 12.

### <Reduction of Tap Coefficients>

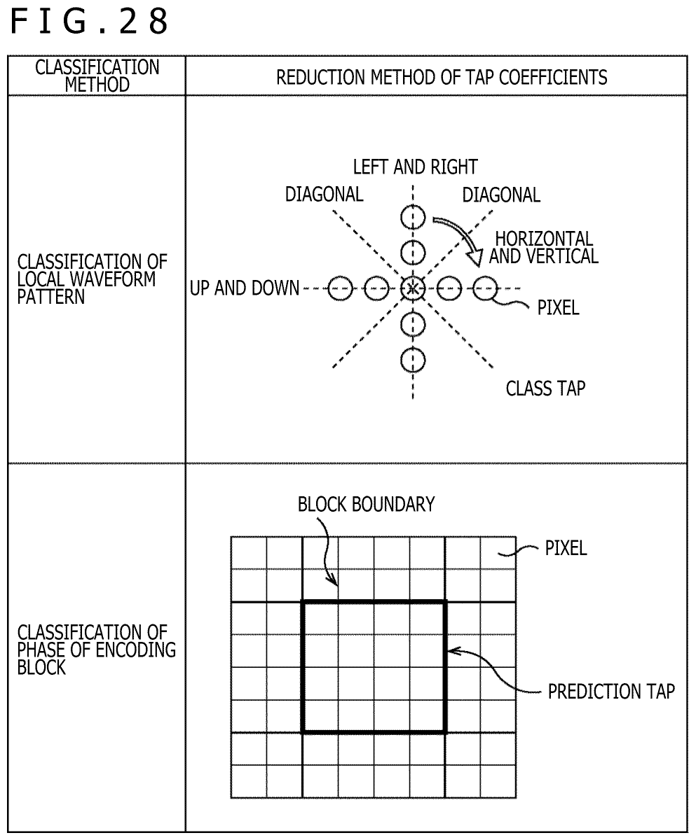

FIG. 28 is a diagram describing an example of a reduction method of reducing the tap coefficients of each class obtained by the tap coefficient learning.

The tap coefficients become an overhead of encoded data. Therefore, even if the tap coefficients can be obtained such that the image after filtering is an image very close to the original image, the improvement of the compression efficiency is hindered if the amount of data of the tap coefficients is large.

Therefore, the tap coefficients (the number of tap coefficients) obtained by the tap coefficient learning can be reduced as necessary.

For example, in a case where the class tap includes a total of nine pixels in a cross shape around the target pixel including the target pixel, two pixels adjacent to and above the target pixel, two pixels adjacent to and below the target pixel, two pixels adjacent to and on the left of the target pixel, and two pixels adjacent to and on the right of the target pixel, and the classification is performed in the 1-bit ADRC process as illustrated in FIG. 28, each bit of the ADRC code with 1 in the most significant bit (ADRC result of target pixel) can be inverted to reduce the number of classes from 512=2⁹ classes to 256=2⁸ classes, for example. In the 256 classes after the reduction of the classes, the amount of data of the tap coefficients is reduced to ½ compared to the case where the ADRC code of the class tap (1-bit ADRC process of the class tap) of nine pixels is used as the class code.

Furthermore, classes with the same ADRC results in the pixels in a line-symmetric positional relationship in an up and down direction, a left and right direction, or a diagonal direction among the nine pixels in a cross shape included in the class tap can be integrated into one class to reduce the classes, and the number of classes can be 100 classes. In this case, the amount of data of the tap coefficients of 100 classes is approximately 39% of the amount of data of the tap coefficients of 256 classes.

Additionally, classes with the same ADRC results in the pixels in a point-symmetric positional relationship among the nine pixels in a cross shape included in the class tap can be integrated into one class to reduce the classes, and the number of classes can be 55 classes. In this case, the amount of data of the tap coefficients of 55 classes is approximately 21% of the amount of data of the tap coefficients of 256 classes.

In addition, the classes can be reduced by, for example, calculating an integration index for integrating the classes and integrating a plurality of classes into one class based on the integration index.

For example, the sums of squares of differences between the tap coefficients of a class C1 and the tap coefficients of another class C2 can be defined as differences between coefficients of the tap coefficients, and the distances between coefficients can be used as integration indices to integrate, into one class C, the classes C1 and C2 in which the distances between coefficients as integration indices are equal to or smaller than a threshold. In the case where the classes are integrated, the tap coefficients of the class 1 or the tap coefficients of the class C2 before the integration can be adopted as tap coefficients of the class after the integration. In addition, the tap coefficients of the class after the integration can be obtained again in the tap coefficient learning.

Furthermore, for example, the RD cost can be used as an integration index, and a class C1 and another class C2 can be integrated into one class C in a case where the RD cost after the integration of the classes C1 and C2 is improved from the RD cost before the integration of the classes C1 and C2.

Note that in the case where a plurality of classes are integrated into one class based on the integration index as described above, the tap coefficients of each class after the integration are transmitted as filter information from the encoding apparatus 11 to the decoding apparatus 12. Furthermore, information indicating the correspondence between the classes after the integration and the class after the integration (information that allows the decoding apparatus 12 side to recognize the correspondence) needs to be transmitted as filter information from the encoding apparatus 11 to the decoding apparatus 12.

Other than the reduction of the classes as described above, the tap coefficients can also be reduced by reducing the tap coefficients.

That is, for example, in a case where the prediction tap and the encoding block include the same pixels, the tap coefficients can be reduced based on the block phase.

For example, as illustrated in FIG. 28, in a case where the prediction tap and the encoding block include 4×4 pixels, the tap coefficients of upper left 2×2 pixels of the prediction tap can be rearranged according to the positional relationship between the upper left 2×2 pixels and upper right 2×2 pixels in a line-symmetric positional relationship in the left and right direction, the positional relationship between the upper left 2×2 pixels and lower left 2×2 pixels in a line-symmetric positional relationship in the up and down direction, and the positional relationship between the upper left 2×2 pixels and lower right 2×2 pixels in a point-symmetric positional relationship, and the rearranged tap coefficients can be adopted for the respective 2×2 pixels. In this case, sixteen tap coefficients for the 4×4 pixels included in the prediction tap can be reduced to four tap coefficients for the upper left 2×2 pixels.

In addition, tap coefficients of 4×2 pixels on the upper half of the prediction tap can be rearranged according to the positional relationship between the 4×2 pixels on the upper half and 4×2 pixels on the lower half in a line-symmetric positional relationship in the up and down direction, and the rearranged tap coefficients can be adopted for the tap coefficients of the 4×2 pixels on the lower half. In this case, sixteen tap coefficients for the 4×4 pixels included in the prediction tap can be reduced to eight tap coefficients for the 4×2 pixels on the upper half.

Additionally, the tap coefficients can be reduced by adopting the same tap coefficients for the pixels in the line-symmetric positional relationship in the left and right direction of the prediction tap or for the pixels in a line-symmetric positional relationship in the diagonal direction.

### <Second Configuration Example of Encoding Apparatus 11>

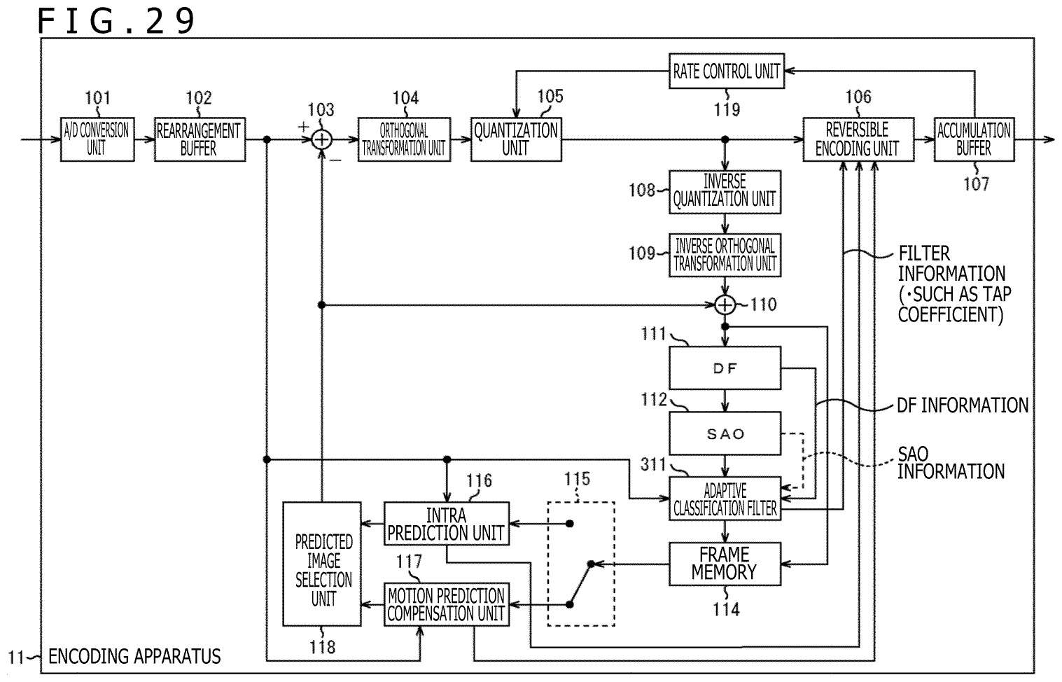

FIG. 29 is a block diagram illustrating a second configuration example of the encoding apparatus 11 of FIG. 1.

Note that in FIG. 29, the same reference signs are provided to the parts corresponding to the case of FIG. 9, and the description will be appropriately skipped.

In FIG. 29, the encoding apparatus 11 includes the components from the A/D conversion unit 101 to the SAO 112, the components from the frame memory 114 to the rate control unit 119, and an adaptive classification filter 311.

Therefore, the encoding apparatus 11 of FIG. 29 is in common with the case of FIG. 9 in that the encoding apparatus 11 includes the components from the A/D conversion unit 101 to the SAO 112 and the components from the frame memory 114 to the rate control unit 119.

However, the encoding apparatus 11 of FIG. 29 is different from the case of FIG. 9 in that the encoding apparatus 11 includes the adaptive classification filter 311 in place of the adaptive classification filter 113.

Similar to the adaptive classification filter 113 of FIG. 9, the adaptive classification filter 311 is a filter that functions as the ALF in the adaptive classification process, and the adaptive classification filter 311 executes a filtering process equivalent to the ALF in the adaptive classification process.

### <Configuration Example of Adaptive Classification Filter 311>

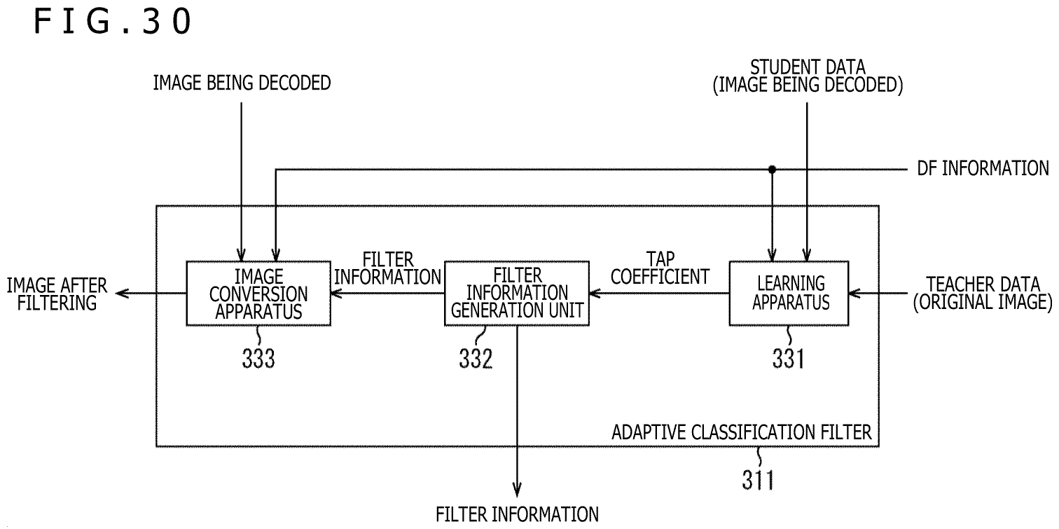

FIG. 30 is a block diagram illustrating a configuration example of the adaptive classification filter 311 of FIG. 29.

In FIG. 30, the adaptive classification filter 311 includes a learning apparatus 331, a filter information generation unit 332, and an image conversion apparatus 333.

The original image is supplied from the rearrangement buffer 102 (FIG. 29) to the learning apparatus 331, and the image being decoded is supplied from the SAO 112 (FIG. 29) to the learning apparatus 331. Furthermore, the DF information as previous-stage filter related information regarding the filtering process of the DF 111 as a previous-stage filtering process executed in the previous stage of the filtering process of the adaptive classification filter 113 is supplied from the DF 111 to the learning apparatus 331.

The learning apparatus 331 sets the image being decoded as student data and sets the original image as teacher data to perform the classification using the DF information. The learning apparatus 331 performs the tap coefficient learning for obtaining the tap coefficients of each class.

The learning apparatus 331 supplies the tap coefficients of each class obtained by the tap coefficient learning to the filter information generation unit 332.

Note that the learning apparatus 331 decides the classification method (adopted classification method) using the DF information performed in the tap coefficient learning from among, for example, a plurality of predetermined classification methods.

The learning apparatus 331 decides the adopted classification method according to, for example, acquirable information that can be acquired from the encoded data obtained in the prediction encoding of the original image by the encoding apparatus 11, such as the image being decoded (image feature values of the image being decoded) and the encoded information, that is, acquirable information that can be acquired by either one of the encoding apparatus 11 and the decoding apparatus 12.

Here, the learning apparatus 131 of FIG. 11 supplies the classification method information indicating the adopted classification method used to obtain the tap coefficients of each class in the tap coefficient learning to the filter information generation unit 132. In the learning apparatus 331 of FIG. 30, although the tap coefficients of each class are supplied to the filter information generation unit 332, the classification method information is not supplied to the filter information generation unit 332.

The filter information generation unit 332 generates filter information including the tap coefficients of each class from the learning apparatus 331 as necessary and supplies the filter information to the image conversion apparatus 333 and the reversible encoding unit 106 (FIG. 29).

Note that as described in FIG. 11, the filter information can include the copy information.

The filter information is supplied from the filter information generation unit 332 to the image conversion apparatus 333. In addition, the image being decoded is supplied from the SAO 112 (FIG. 29) to the image conversion apparatus 333, and the DF information is supplied from the DF 111 to the image conversion apparatus 333.

The image conversion apparatus 333 sets the image being decoded as a first image and uses the tap coefficients of each class included in the filter information from the filter information generation unit 332 to perform image conversion in the adaptive classification process. In this way, the image conversion apparatus 333 converts the image being decoded as a first image into the image after filtering as a second image equivalent to the original image (generates the image after filtering) and supplies the image after filtering to the frame memory 114 (FIG. 29).

The image conversion apparatus 333 uses the DF information from the DF 111 to perform the classification in the adaptive classification process just like the learning apparatus 331. In addition, the image conversion apparatus 333 decides, as the adopted classification method, the same classification method as the classification using the DF information performed by the learning apparatus 131 according to the acquirable information and uses the DF information to perform the classification of the adopted classification method.

### <Configuration Example of Learning Apparatus 331>

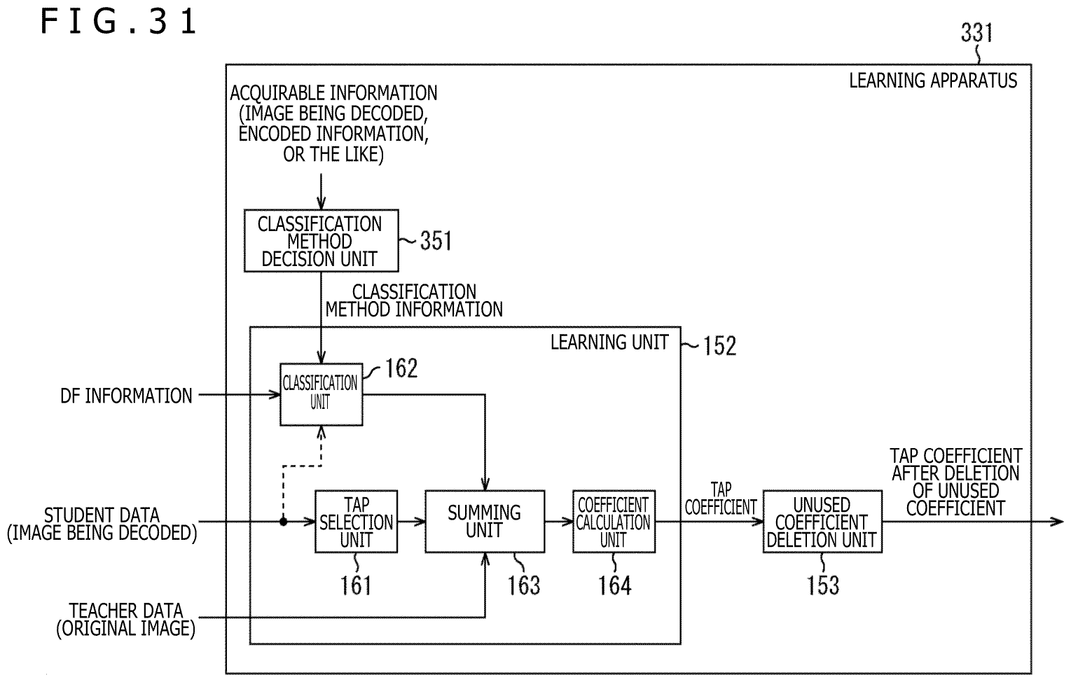

FIG. 31 is a block diagram illustrating a configuration example of the learning apparatus 331 of FIG. 30.

Note that in FIG. 31, the same reference signs are provided to the parts corresponding to the case of FIG. 12, and the description will be appropriately skipped.

In FIG. 31, the learning apparatus 331 includes the learning unit 152, the unused coefficient deletion unit 153, and a classification method decision unit 351.

Therefore, the learning apparatus 331 is in common with the learning apparatus 131 of FIG. 12 in that the learning apparatus 331 includes the learning unit 152 and the unused coefficient deletion unit 153.

However, the learning apparatus 331 is different from the learning apparatus 131 of FIG. 12 in that the learning apparatus 331 includes the classification method decision unit 351 in place of the classification method decision unit 151.

The classification method decision unit 351 stores, for example, a plurality of predetermined classification methods (information of classification methods).

That is, the classification method decision unit 351 stores, for example, a plurality of classification methods including the classification using the DF information, the classification using other information, such as image feature values and encoded information, without using the DF information, the classification using both the DF information and other information, and the like just like the classification method decision unit 151 of FIG. 12.

In addition, the classification method for performing rough classification, the classification method for performing detailed classification, and the like can be included as classification methods using at least the DF information stored as a plurality of classification methods in the classification method decision unit 351.

The classification method decision unit 351 decides the adopted classification method that is the classification method used by the classification unit 162 of the learning unit 152 from among the plurality of classification methods at the start of the tap coefficient learning just like the classification method decision unit 151 of FIG. 12, for example. The classification method decision unit 351 supplies the classification method information indicating the adopted classification method to the classification unit 162 of the learning unit 152.

However, the classification method decision unit 351 decides the adopted classification method according to the acquirable information, such as the image being decoded and the encoded information.

For example, the classification method decision unit 351 can decide the adopted classification method according to the quality of the decoded image, that is, according to, for example, the quantization parameter QP that is one of the pieces of encoded information.

Specifically, in a case where the quantization parameter QP is larger than a threshold, the classification method decision unit 351 can decide, as the adopted classification method, the method of classification using the DF information (hereinafter, also referred to as DF classification) as illustrated in FIGS. 15 and 17.

Particularly, the classification method decision unit 351 can decide, as the adopted classification method, the method of DF classification for performing detailed classification as illustrated in FIG. 15.

On the other hand, in a case where the quantization parameter QP is not larger than the threshold, the classification method decision unit 351 can decide, as the adopted classification method, the method of classification using other information without using the DF information or the method of DF classification for performing rough classification as illustrated in B of FIG. 17.

In addition, for example, the classification method decision unit 351 can extract the image feature values of the image being decoded and decide the adopted classification method according to the image feature values.

Here, as described in FIG. 12, the DR as an image feature value can be an index of the variations in amplitude of pixel values, and the DiffMax/DR as an image feature value can be an index of the step-wise level difference in pixel values. Therefore, threshold processing can be applied to the DR or the DiffMax/DR to recognize whether the image being decoded includes many pixel values with minute variations in amplitude or includes many areas with step-wise level differences in pixel values.

For example, in a case where the image being decoded is an image including many pixel values with minute variations in amplitude so that there are many areas with step-wise level differences in pixel values, the classification method decision unit 351 can decide, as the adopted classification method, one of the methods of DF classification as illustrated in FIGS. 15 and 17, particularly, the method of DF classification for performing detailed classification as illustrated in FIG. 15.

On the other hand, in a case where the image being decoded is not an image with many areas with minute amplitude and step-wise level differences in pixel values, the classification method decision unit 351 can decide, as the adopted classification method, the method of classification using other information without using the DF information or the method of DF classification for performing rough classification as illustrated in B of FIG. 17.

In addition, the classification method decision unit 351 can decide the adopted classification method according to, for example, the proportion of pixels subjected to the DF in the DF 111 in the image being decoded as acquirable information.

For example, in a case where the proportion of pixels subjected to the strong filter or the weak filter of the DF 111 is larger than a threshold in a picture of the image being decoded, the classification method decision unit 351 can decide, as the adopted classification method, one of the methods of DF classification as illustrated in FIGS. 15 and 17, particularly, the method of DF classification for performing detailed classification as illustrated in FIG. 15.

On the other hand, in a case where the proportion of pixels subjected to the strong filter or the weak filter of the DF 111 is not larger than the threshold in a picture of the image being decoded, the classification method decision unit 351 can decide, as the adopted classification method, the method of classification using other information without using the DF information or the method of DF classification for performing rough classification as illustrated in B of FIG. 15.

Here, although the classification method decision unit 151 of FIG. 12 supplies the classification method information indicating the adopted classification method to the filter information generation unit 132 as a unit outside of the learning apparatus 131, the classification method decision unit 351 does not supply the classification method information to the filter information generation unit 132 as a unit outside of the learning apparatus 131. Therefore, the classification method information is not transmitted to the decoding apparatus 12 in the encoding apparatus 11 of FIG. 29.

### <Process of Learning Apparatus 331>

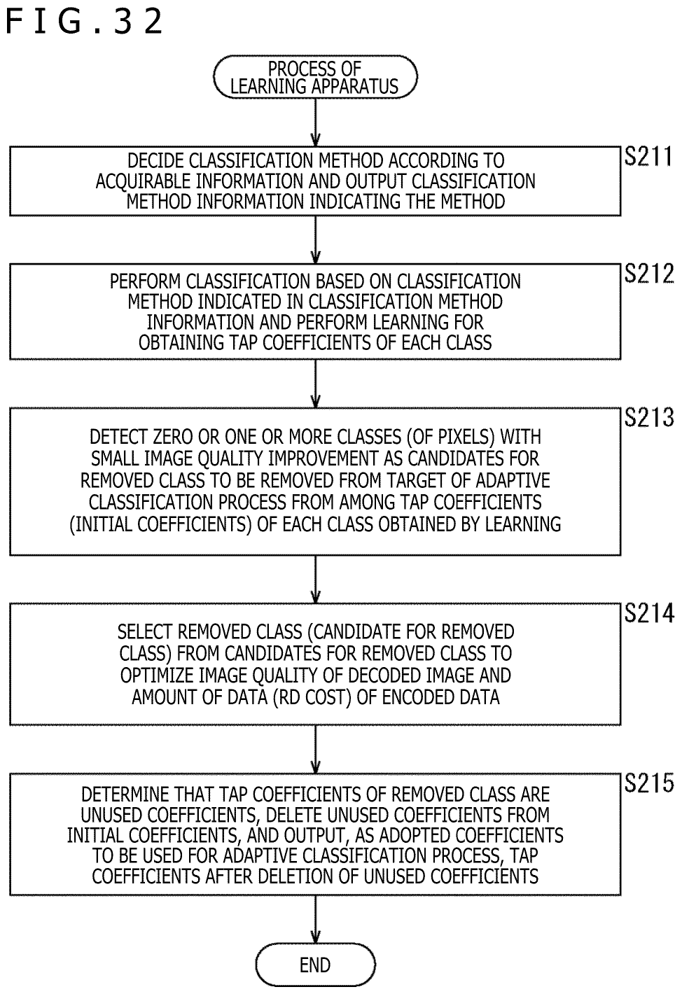

FIG. 32 is a flow chart describing an example of the process of the learning apparatus 331 in FIG. 31.

In step S211, the classification method decision unit 351 decides the adopted classification method from among the plurality of predetermined classification methods according to the acquirable information, such as the image being decoded as student data used for the tap coefficient learning and the encoded information for the image being decoded (encoded information generated in encoding of the original image corresponding to the image being decoded). The classification method decision unit 351 then supplies the classification method information indicating the adopted classification method to the classification unit 162 of the learning unit 152 (FIG. 31), and the process proceeds to step S212.

In steps S212 to S215, processes similar to steps S32 to S35 of FIG. 19 are executed, respectively. As a result, the unused coefficient deletion unit 153 (FIG. 31) determines that the tap coefficients of the removed class are unused coefficients and deletes the unused coefficients from the initial coefficient to obtain adopted coefficients. The adopted coefficients are output to the filter information generation unit 332 (FIG. 30), and the process ends.

### <Configuration Example of Image Conversion Apparatus 333>

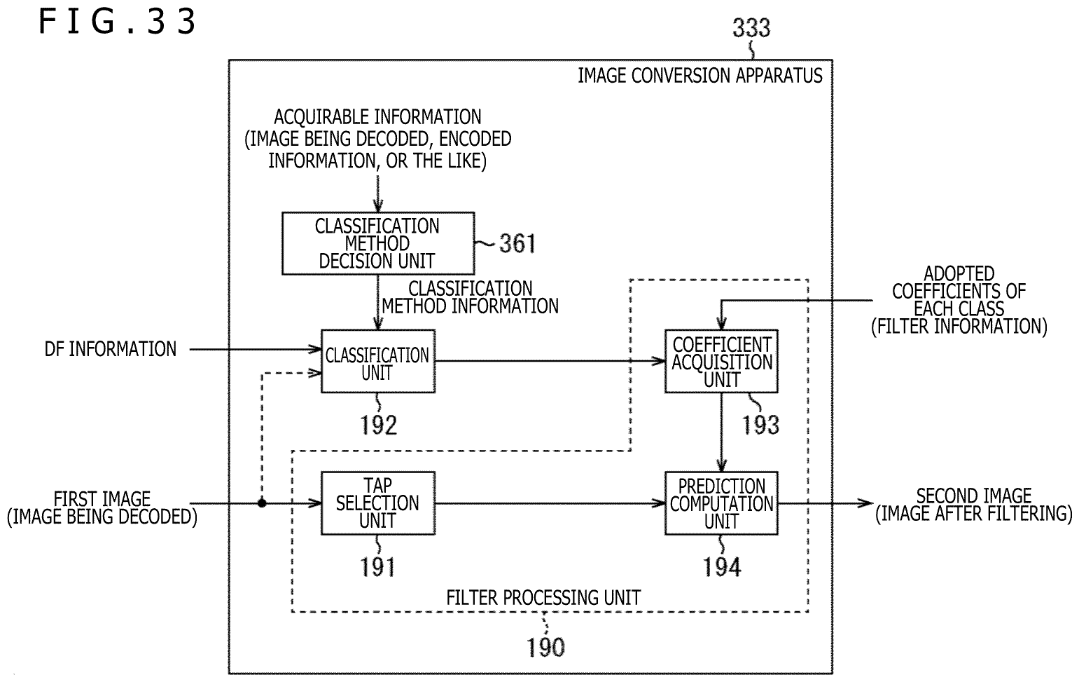

FIG. 33 is a block diagram illustrating a configuration example of the image conversion apparatus 333 of FIG. 31.

Note that in FIG. 33, the same reference signs are provided to the parts corresponding to the case of FIG. 20, and the description will be appropriately skipped.

In FIG. 33, the image conversion apparatus 333 includes the tap selection unit 191, the classification unit 192, the coefficient acquisition unit 193, the prediction computation unit 194, and a classification method decision unit 361.

Therefore, the image conversion apparatus 333 is in common with the image conversion apparatus 133 of FIG. 20 in that the image conversion apparatus 333 includes the components from the tap selection unit 191 to the prediction computation unit 194.

However, the image conversion apparatus 333 is different from the image conversion apparatus 133 of FIG. 20 in that the classification method decision unit 361 is newly provided.

The classification method decision unit 361 stores a plurality of classification methods (information of classification methods) that are the same as the classification methods stored in the classification method decision unit 351 of FIG. 31.

The classification method decision unit 361 decides one classification method as the adopted classification method from among the plurality of classification methods according to the acquirable information, such as the image being decoded and the encoded information, just like the classification method decision unit 351 of FIG. 31.

Therefore, the classification method decision unit 361 decides, as the adopted classification method, the same classification method as the classification method decided as the adopted classification method by the classification method decision unit 351 of FIG. 31.

The classification method decision unit 361 supplies the classification method information indicating the adopted classification method decided from among the plurality of classification methods to the classification unit 192.

The image conversion apparatus 333 then executes a process similar to the process of the image conversion apparatus 133 in FIG. 20.

That is, the classification unit 192 uses the DF information from the DF 111 to perform the DF classification of the classification method indicated in the classification method information from the classification method decision unit 361. The classification unit 192 obtains the class of the target pixel and supplies the class to the coefficient acquisition unit 193.

The coefficient acquisition unit 193 stores the tap coefficients (adopted coefficients) included in the filter information supplied from the filter information generation unit 332 (FIG. 30). The coefficient acquisition unit 193 acquires, from the tap coefficients, the tap coefficients of the class of the target pixel obtained by the classification unit 192 and supplies the tap coefficients to the prediction computation unit 194.

The prediction computation unit 194 uses the prediction tap of the target pixel supplied from the tap selection unit 191 and the tap coefficients of the class of the target pixel supplied from the coefficient acquisition unit 193 to perform the prediction computation and obtains the predicted value of the pixel value of the corresponding pixel in the original image corresponding to the target pixel.

### <Encoding Process>

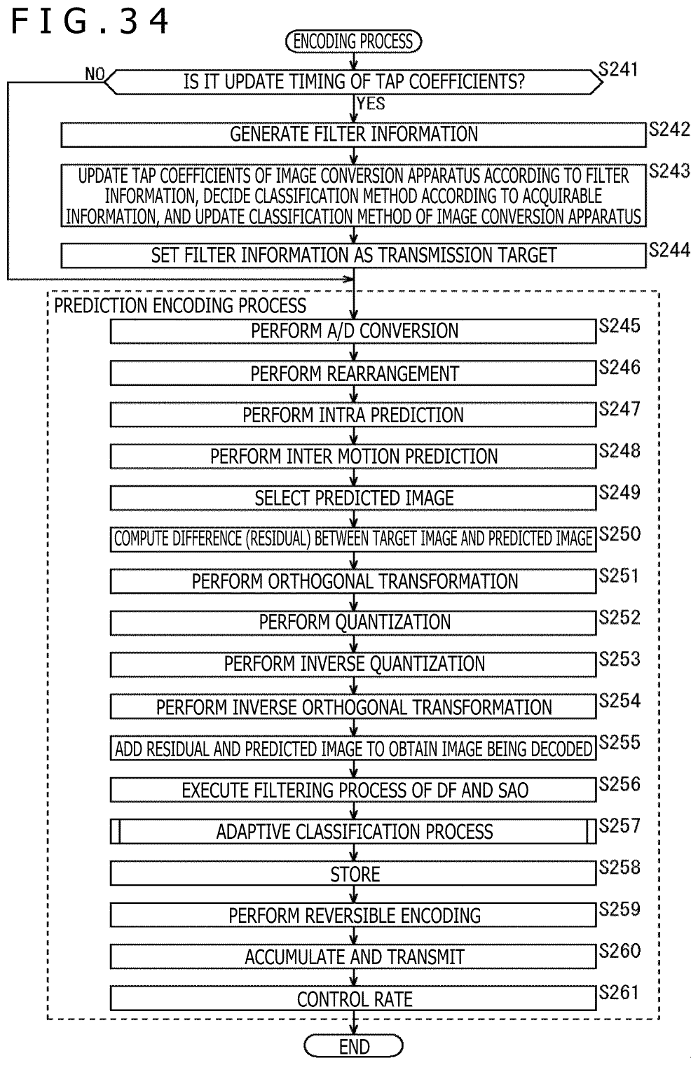

FIG. 34 is a flow chart describing an example of the encoding process of the encoding apparatus 11 in FIG. 29.

In the encoding apparatus 11, the learning apparatus 331 (FIG. 30) of the adaptive classification filter 311 sets, as student data, the images being decoded in a unit of update, such as a plurality of frames, one frame, and blocks, among the images being decoded supplied to the learning apparatus 331. The learning apparatus 331 sets the original images corresponding to the images being decoded as teacher data and sequentially performs the tap coefficient learning. The learning apparatus 331 then determines whether the current timing is update timing that is predetermined timing of updating the tap coefficients and the classification method in step S241 as in step S41 of FIG. 21.

In a case where the learning apparatus 331 determines that it is not the update timing of the tap coefficients and the classification method in step S241, the process skips steps S242 to S244 and proceeds to step S245.

Furthermore, in a case where the learning apparatus 331 determines that it is the update timing of the tap coefficients and the classification method in step S241, the process proceeds to step S242.

In step S242, the filter information generation unit 332 (FIG. 30) generates filter information including the tap coefficients of each class (or copy information) generated by the learning apparatus 331 through the latest tap coefficient learning and supplies the filter information to the image conversion apparatus 333 (FIG. 30) and the reversible encoding unit 106 (FIG. 29). The process proceeds to step S243.

In step S243, the image conversion apparatus 333 (FIG. 33) updates the tap coefficients of each class stored in the coefficient acquisition unit 193 to the adopted coefficients included in the filter information according to the filter information from the filter information generation unit 332.

Furthermore, in step S243, the classification method decision unit 361 of the image conversion apparatus 333 (FIG. 33) decides the adopted classification method from among the plurality of classification methods according to the acquirable information and supplies the classification method information indicating the adopted classification method to the classification unit 192 to thereby update the method of classification performed by the classification unit 192 to the adopted classification method indicated in the classification method information. The process proceeds from step S243 to step S244.

In step S244, the reversible encoding unit 106 sets the filter information supplied from the filter information generation unit 332 as a transmission target, and the process proceeds to step S245. The filter information set as the transmission target is included in the encoded data in step S259 and transmitted.

In steps S245 to S261, processes similar to steps S45 to S61 of FIG. 21 are executed, respectively.

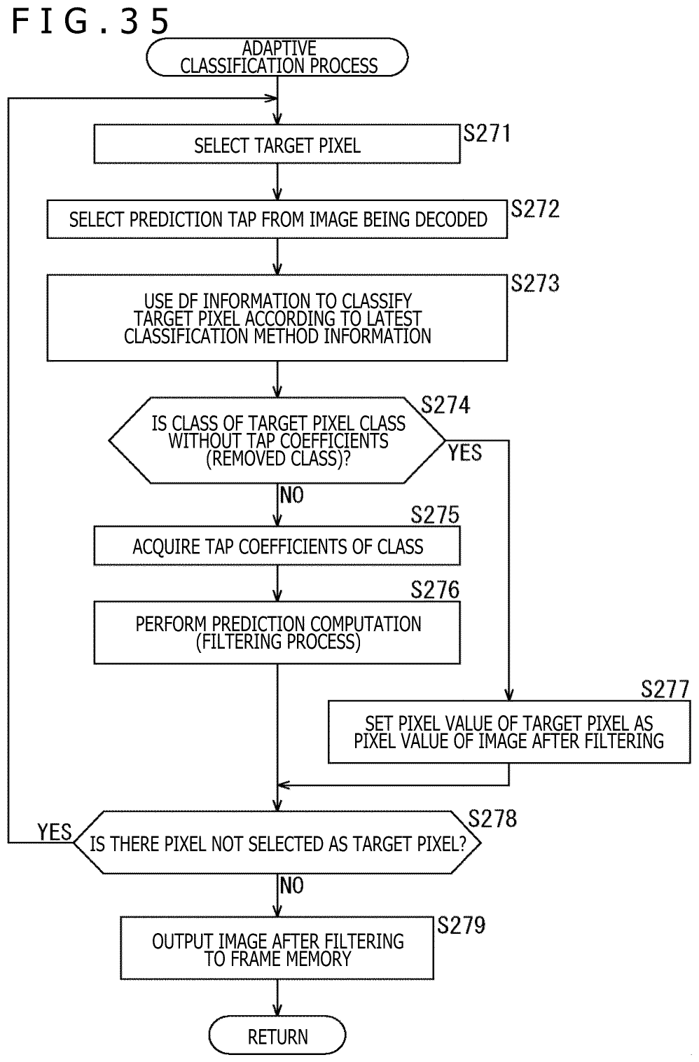

FIG. 35 is a flow chart describing an example of the adaptive classification process executed in step S257 of FIG. 34.

In steps S271 to S279, the image conversion apparatus 333 (FIG. 33) of the adaptive classification filter 311 executes processes similar to steps S71 to S79 of FIG. 22, respectively.

However, although the classification unit 192 uses the DF information from the DF 111 to classify the target pixel based on the classification method indicated in the classification method information included in the filter information from the filter information generation unit 132 (FIG. 11) in step S73 of FIG. 22, the classification unit 192 uses the DF information from the DF 111 to classify the target pixel based on the adopted classification method indicated in the latest classification method information from the classification method decision unit 361 (FIG. 31), that is, the adopted classification method decided by the classification method decision unit 361 in the preceding step S243 (FIG. 34), in step S273.

### <Second Configuration Example of Decoding Apparatus 12>

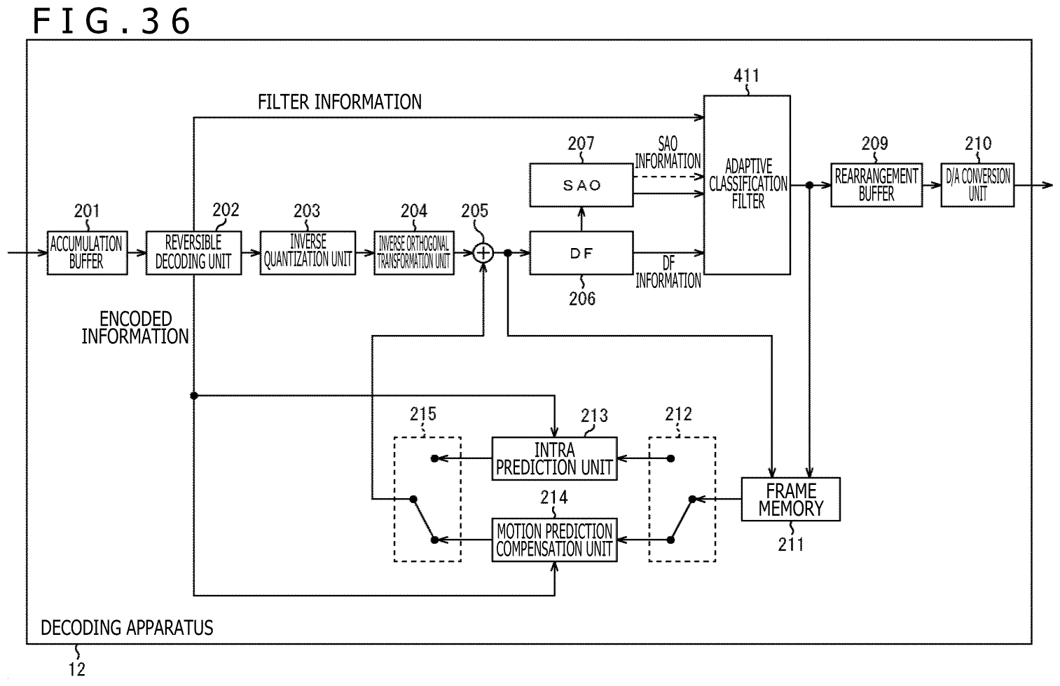

FIG. 36 is a block diagram illustrating a second configuration example of the decoding apparatus 12 of FIG. 1.

Note that in FIG. 36, the same reference signs are provided to the parts corresponding to the case of FIG. 23, and the description will be appropriately skipped.

In FIG. 36, the decoding apparatus 12 includes the components from the accumulation buffer 201 to the SAO 207, the components from the rearrangement buffer 209 to the selection unit 215, and an adaptive classification filter 411.

Therefore, the decoding apparatus 12 of FIG. 36 is in common with the case of FIG. 23 in that the decoding apparatus 12 includes the components from the accumulation buffer 201 to the SAO 207 and the components from the rearrangement buffer 209 to the selection unit 215.

However, the decoding apparatus 12 of FIG. 36 is different from the case of FIG. 23 in that the decoding apparatus 12 includes the adaptive classification filter 411 in place of the adaptive classification filter 208.

Similar to the adaptive classification filter 208 of FIG. 23, the adaptive classification filter 411 is a filter that functions as the ALF in the adaptive classification process, and the adaptive classification filter 411 executes a filtering process equivalent to the ALF in the adaptive classification process.

### <Configuration Example of Adaptive Classification Filter 411>

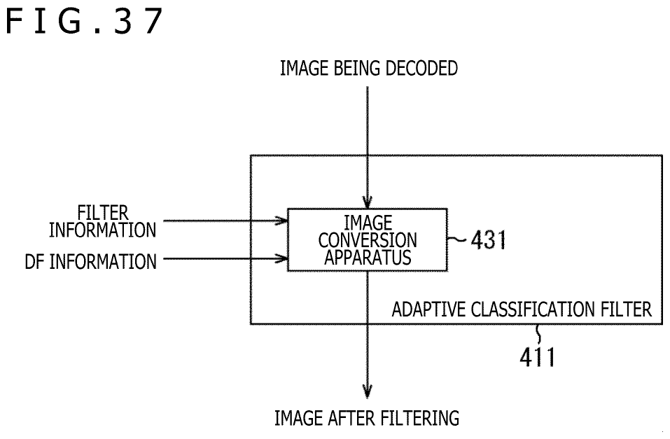

FIG. 37 is a block diagram illustrating a configuration example of the adaptive classification filter 411 of FIG. 36.

In FIG. 37, the adaptive classification filter 411 includes an image conversion apparatus 431.

The image being decoded is supplied from the SAO 207 (FIG. 36) to the image conversion apparatus 431, and the filter information is supplied from the reversible decoding unit 202 to the image conversion apparatus 431. Furthermore, the DF information is supplied from the DF 206 to the image conversion apparatus 431.

Similar to the image conversion apparatus 333 of FIG. 30, the image conversion apparatus 431 sets the image being decoded as a first image and uses the DF information from the DF 206 to perform the classification of the classification method indicated in the classification method information included in the filter information, that is, the same classification as the classification performed by the image conversion apparatus 333. The image conversion apparatus 431 further performs, as a filtering process corresponding to the class obtained as a result of the classification, image conversion in the adaptive classification process of performing the prediction computation that is a filtering process using the tap coefficients (adopted coefficients) of each class included in the filter information. In this way, the image conversion apparatus 431 converts the image being decoded as a first image into the image after filtering as a second image equivalent to the original image (generates the image after filtering) and supplies the image after filtering to the rearrangement buffer 209 and the frame memory 211 (FIG. 36).

Note that although the image conversion apparatus 231 of FIG. 24 decides, as the adopted classification method, the same classification method as the classification performed by the image conversion apparatus 133 (FIG. 11) according to the classification method information included in the filter information, the image conversion apparatus 431 decides, as the adopted classification method, the same classification method as the classification performed by the image conversion apparatus 333 (FIG. 30) according to the acquirable information.

### <Configuration Example of Image Conversion Apparatus 431>

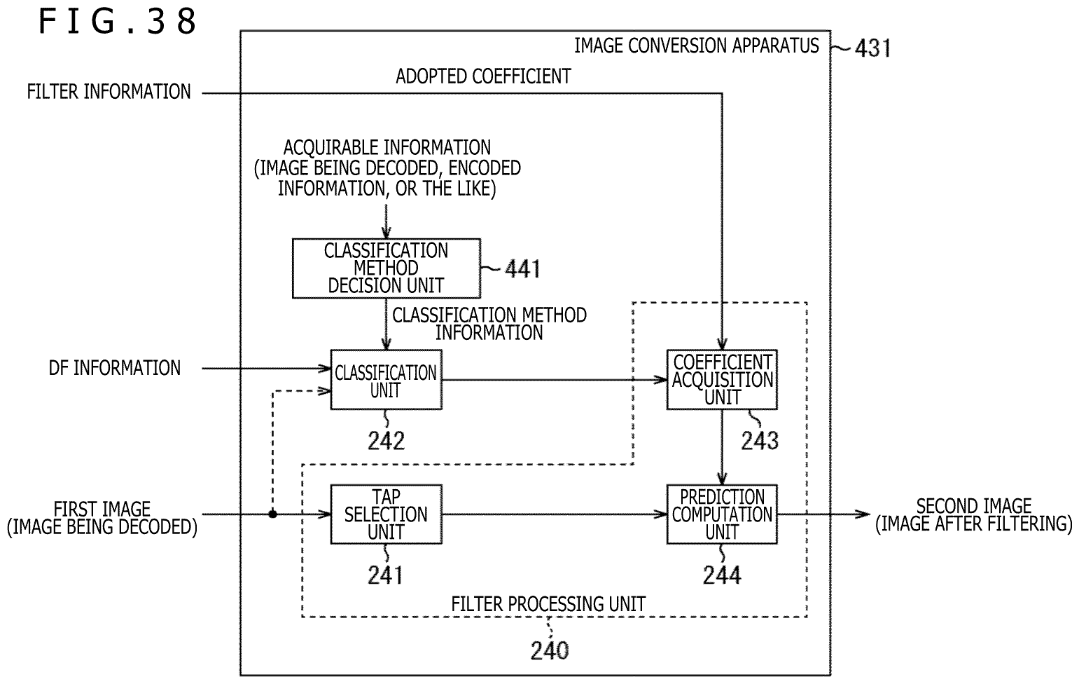

FIG. 38 is a block diagram illustrating a configuration example of the image conversion apparatus 431 of FIG. 37.

Note that in FIG. 38, the same reference signs are provided to the parts corresponding to the case of FIG. 25, and the description will be appropriately skipped.

In FIG. 38, the image conversion apparatus 431 includes the tap selection unit 241, the classification unit 242, the coefficient acquisition unit 243, the prediction computation unit 244, and a classification method decision unit 441.

Therefore, the image conversion apparatus 431 is in common with the image conversion apparatus 231 of FIG. 25 in that the image conversion apparatus 431 includes the components from the tap selection unit 241 to the prediction computation unit 244.

However, the image conversion apparatus 431 is different from the image conversion apparatus 231 of FIG. 25 in that the classification method decision unit 441 is newly provided.

The classification method decision unit 441 stores a plurality of classification methods (information of classification methods) that are the same as the classification methods stored in the classification method decision unit 361 of FIG. 33.

The classification method decision unit 441 then decides one classification method as the adopted classification method from among the plurality of classification methods according to the acquirable information, such as the image being decoded and the encoded information, just like the classification method decision unit 361 of FIG. 33.

Therefore, the classification method decision unit 441 decides, as the adopted classification method, the same classification method as the classification method decided as the adopted classification method by the classification method decision unit 361 of FIG. 33.

The classification method decision unit 441 supplies the classification method information indicating the adopted classification method decided from among the plurality of classification methods to the classification unit 242.

The image conversion apparatus 431 then executes a process similar to the process of the image conversion apparatus 231 in FIG. 25.

That is, the classification unit 242 uses the DF information of the DF 206 to perform the DF classification of the classification method indicated in the classification method information from the classification method decision unit 441. The classification unit 242 obtains the class of the target pixel and supplies the class to the coefficient acquisition unit 243.

The coefficient acquisition unit 243 stores the tap coefficients (adopted coefficients) included in the filter information supplied from the reversible decoding unit 202 (FIG. 36). The coefficient acquisition unit 243 acquires, from the tap coefficients, the tap coefficients of the class of the target pixel obtained by the classification unit 242 and supplies the tap coefficients to the prediction computation unit 244.

The prediction computation unit 244 uses the prediction tap of the target pixel supplied from the tap selection unit 241 and the tap coefficients of the class of the target pixel supplied from the coefficient acquisition unit 243 to perform the prediction computation and obtains the predicted value of the pixel value of the corresponding pixel in the original image corresponding to the target pixel.

### <Decoding Process>

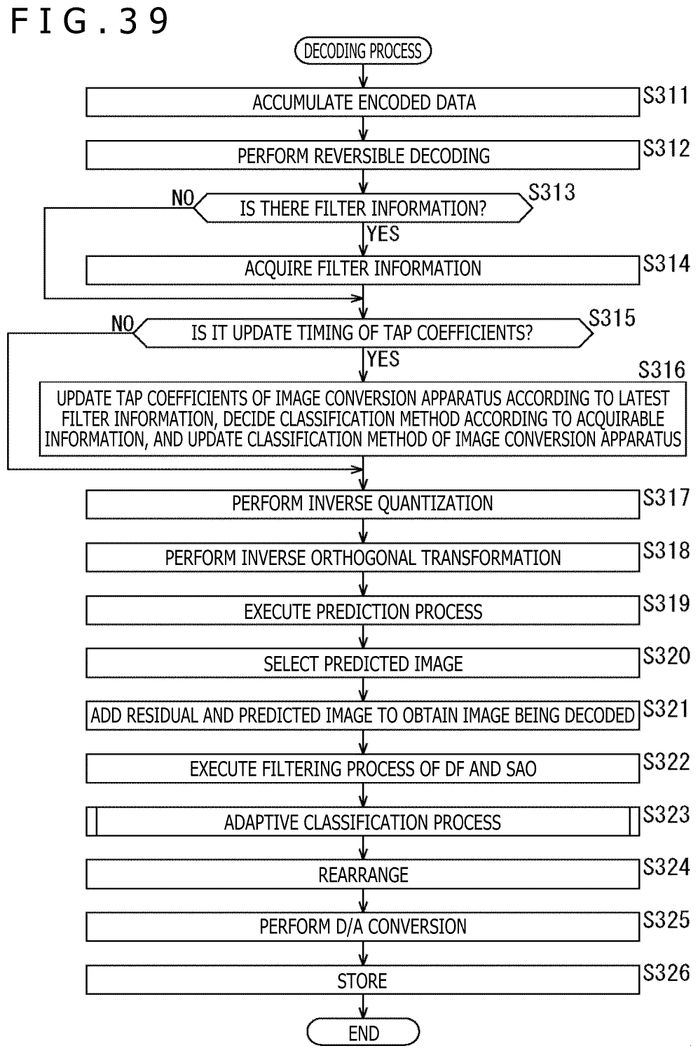

FIG. 39 is a flow chart describing an example of the decoding process of the decoding apparatus 12 in FIG. 36.

In the decoding process, processes similar to steps S111 to S115 of FIG. 26 are executed in steps S311 to S315, respectively.

Furthermore, in a case where it is determined that it is not the update timing of the classification method and the tap coefficients in step S315, the process skips step S316 and proceeds to step S317.

In addition, in a case where it is determined that it is the update timing of the classification method and the tap coefficients in step S315, the process proceeds to step S316.

In step S316, the image conversion apparatus 431 (FIG. 38) updates the tap coefficients of each class stored in the coefficient acquisition unit 243 to the adopted coefficients included in the filter information according to the filter information acquired in the preceding step S314.

Furthermore, in step S316, the classification method decision unit 441 of the image conversion apparatus 431 (FIG. 38) decides the adopted classification method from among the plurality of classification methods according to the acquirable information and supplies the classification method information indicating the adopted classification method to the classification unit 242 to thereby update the method of classification performed by the classification unit 242 to the adopted classification method indicated in the classification method information. The process proceeds to step S317.

In steps S317 to S326, processes similar to steps S117 to 126 of FIG. 26 are executed, respectively.

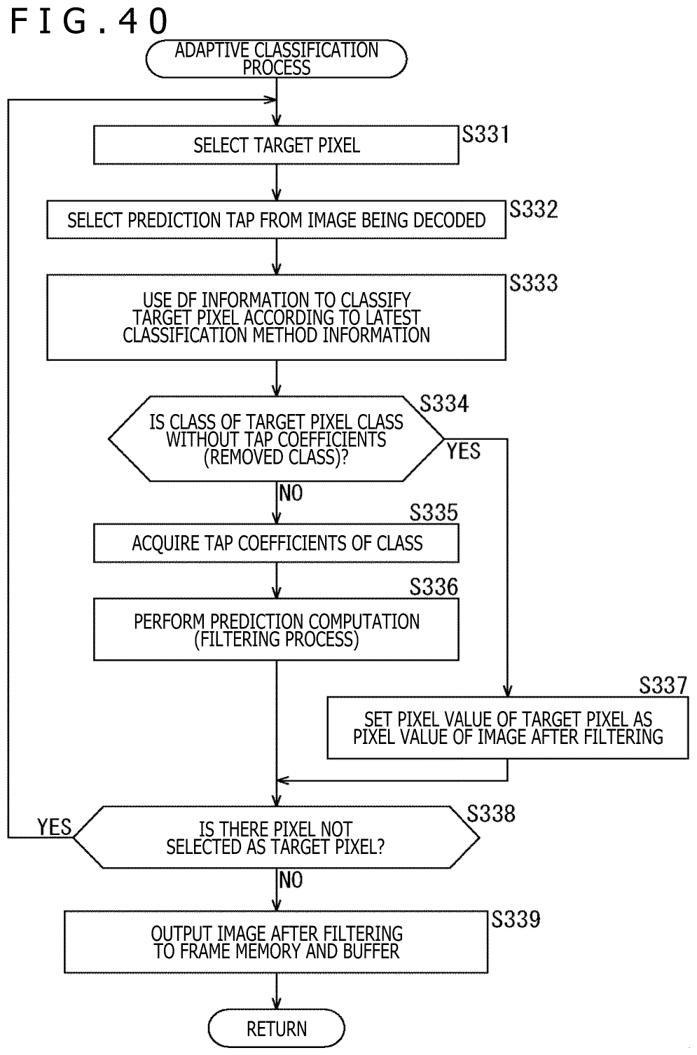

FIG. 40 is a flow chart describing an example of the adaptive classification process executed in step S323 of FIG. 39.

The image conversion apparatus 431 (FIG. 38) of the adaptive classification filter 411 executes processes similar to steps S131 to S139 of FIG. 27 in steps S331 to S339, respectively.

However, although the classification unit 242 (FIG. 25) uses the DF information from the DF 206 to classify the target pixel based on the classification method indicated in the classification method information included in the filter information from the reversible decoding unit 202 (FIG. 23) in step S133 of FIG. 27, the classification unit 242 (FIG. 38) uses the DF information from the DF 206 to classify the target pixel based on the adopted classification method indicated in the latest classification method information from the classification method decision unit 441 (FIG. 38), that is, the adopted classification method decided by the classification method decision unit 441 in the preceding step S316 (FIG. 39), in step S333.

In this way, in the case where the encoding apparatus 11 (FIG. 29) and the decoding apparatus 12 (FIG. 36) decide the adopted classification method according to the acquirable information, the classification method information does not have to be transmitted from the encoding apparatus 11 to the decoding apparatus 12, and the compression efficiency can be improved.

### <Application to Multi-View Image Encoding/Decoding System>

The series of processes can be applied to a multi-view image encoding/decoding system.

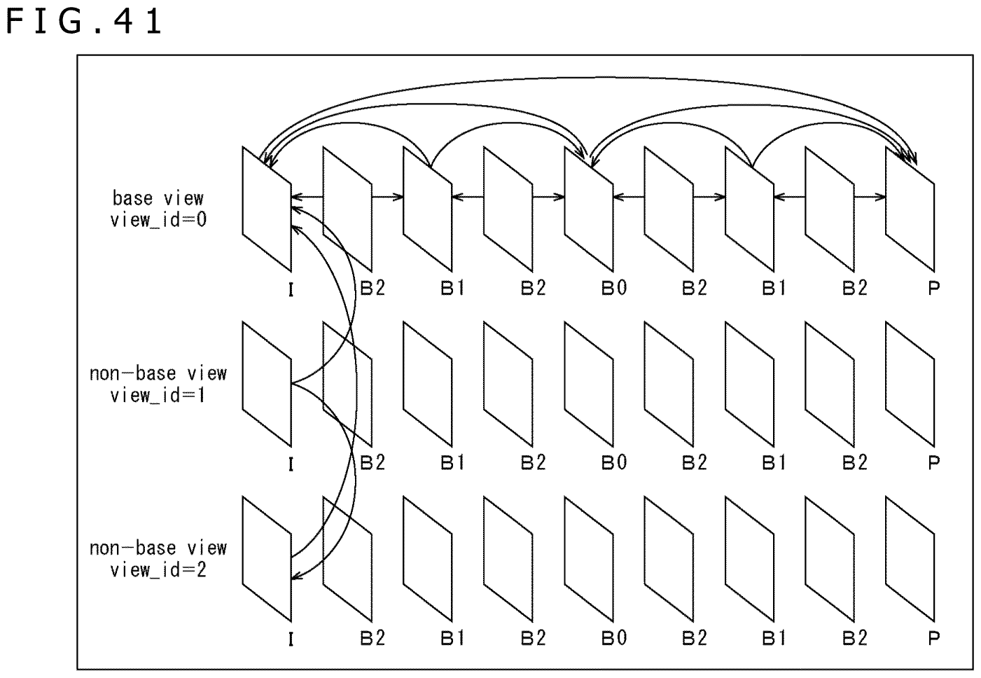

FIG. 41 is a diagram illustrating an example of a multi-view image encoding system.

As illustrated in FIG. 41, multi-view images include images from a plurality of viewpoints (views). The plurality of views of the multi-view images include a base view for performing encoding and decoding by using only the images of the base view without using the information of other views and include non-base views for performing encoding and decoding by using the information of other views. In the encoding and decoding of the non-base views, the information of the base view may be used, or the information of the other non-base views may be used.

In the case of encoding and decoding the multi-view images as in the example of FIG. 41, the multi-view images are encoded for each viewpoint. Furthermore, in the case of decoding the encoded data obtained in this way, the encoded data of each viewpoint is decoded (that is, for each viewpoint). The methods described in the embodiment may be applied to the encoding and decoding for each viewpoint. In this way, the S/N and the compression efficiency can be significantly improved. That is, in the case of the multi-view images, the S/N and the compression efficiency can also be significantly improved in a similar manner.

### <Multi-View Image Encoding/Decoding System>

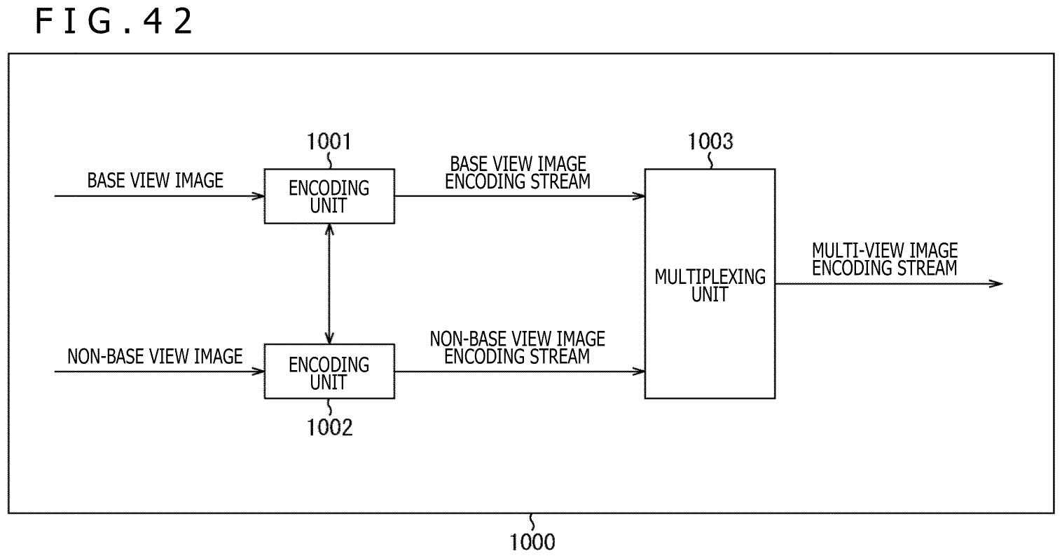

FIG. 42 is a diagram illustrating a multi-view image encoding apparatus of the multi-view image encoding/decoding system that performs the multi-view image encoding/decoding described above.

As illustrated in FIG. 42, a multi-view image encoding apparatus 1000 includes an encoding unit 1001, an encoding unit 1002, and a multiplexing unit 1003.

The encoding unit 1001 encodes a base view image to generate a base view image encoding stream. The encoding unit 1002 encodes a non-base view image to generate a non-base view image encoding stream. The multiplexing unit 1003 multiplexes the base view image encoding stream generated by the encoding unit 1001 and the non-base view image encoding stream generated by the encoding unit 1002 to generate a multi-view image encoding stream.

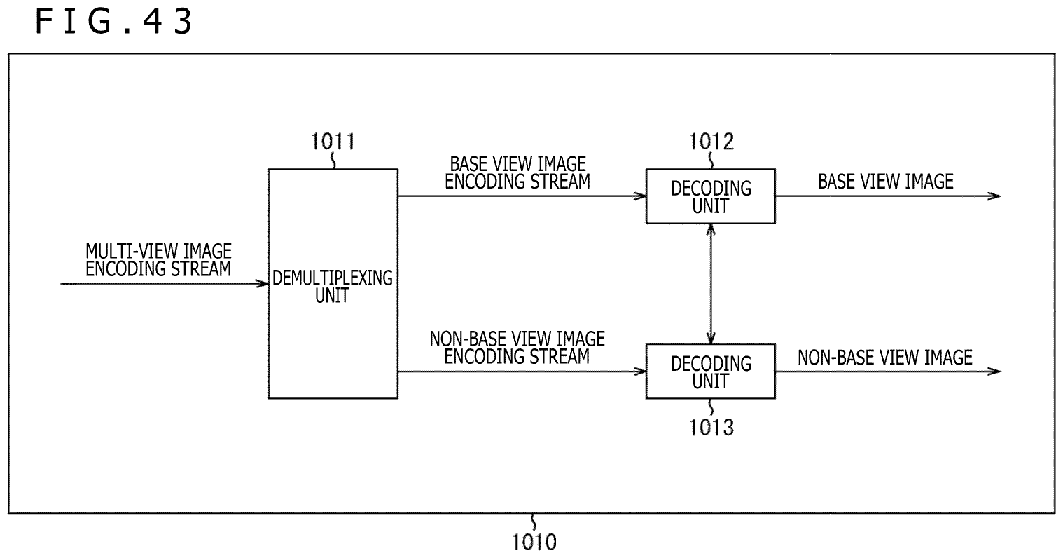

FIG. 43 is a diagram illustrating a multi-view image decoding apparatus that performs the multi-view image decoding described above.

As illustrated in FIG. 43, a multi-view image decoding apparatus 1010 includes a demultiplexing unit 1011, a decoding unit 1012, and a decoding unit 1013.

The demultiplexing unit 1011 demultiplexes a multi-view image encoding stream including multiplexed base view image encoding stream and non-base view image encoding stream and extracts a base view image encoding stream and a non-base view image encoding stream. The decoding unit 1012 decodes the base view image encoding stream extracted by the demultiplexing unit 1011 and obtains a base view image. The decoding unit 1013 decodes the non-base view image encoding stream extracted by the demultiplexing unit 1011 and obtains a non-base view image.

For example, in the multi-view image encoding/decoding system, the encoding apparatus 11 described in the embodiment may be applied as the encoding unit 1001 and the encoding unit 1002 of the multi-view image encoding apparatus 1000. In this way, the methods described in the embodiment can also be applied to the encoding of multi-view images. That is, the S/N and the compression efficiency can be significantly improved. In addition, for example, the decoding apparatus 12 described in the embodiment may be applied as the decoding unit 1012 and the decoding unit 1013 of the multi-view image decoding apparatus 1010. In this way, the methods described in the embodiment can also be applied to the decoding of the encoded data of multi-view images. That is, the S/N and the compression efficiency can be significantly improved.

### <Application to Tiered Image Encoding/Decoding System>

In addition, the series of processes can be applied to a tiered image encoding (scalable encoding) and decoding system.

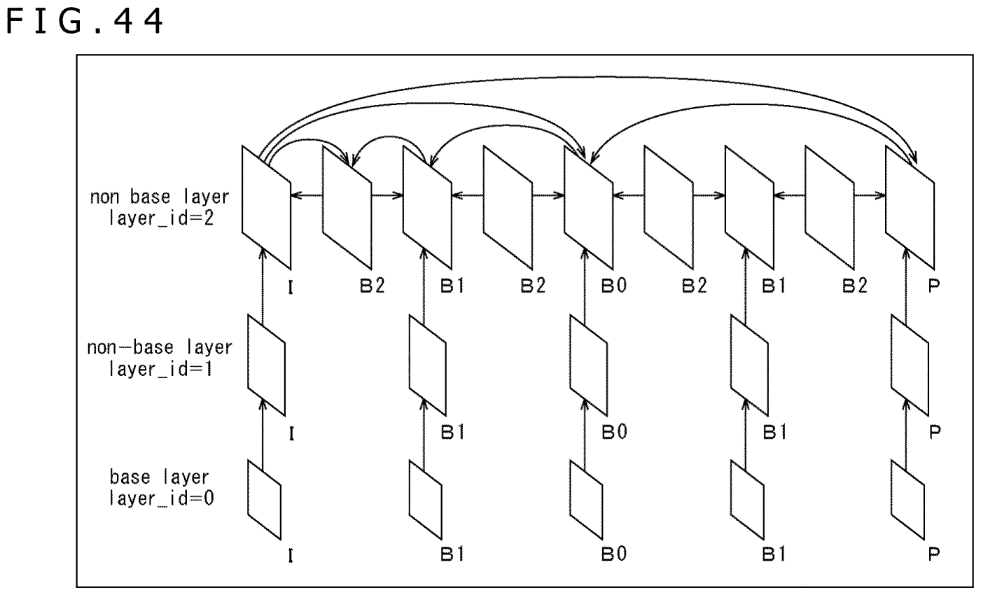

FIG. 44 is a diagram illustrating an example of a tiered image encoding system.

In the tiered image encoding (scalable encoding), an image is divided into a plurality of layers (image is tiered) to provide a scalability function for a predetermined parameter, and the image data is encoded in each layer. The tiered image decoding (scalable decoding) is decoding corresponding to the tiered image encoding.

As illustrated in FIG. 44, in the image tiering, one image is partitioned into a plurality of images (layers) based on the predetermined parameter with the scalability function. That is, the images after tiering (tiered images) include images of a plurality of tiers (layers) with different values of the predetermined parameter. The plurality of layers of the tiered images include a base layer for encoding and decoding using only the images of the base layer without using the images of other layers and include non-base layers (also referred to as enhancement layers) for encoding and decoding using the images of other layers. In the non-base layers, the images of the base layer may be used, or the images of the other non-base layers may be used.

In general, the non-base layer includes data of a difference image (difference data) of an image of the non-base layer and an image of another layer in order to reduce the redundancy. For example, in a case where one image is divided into two tiers including a base layer and a non-base layer (also referred to as enhancement layer), an image with lower quality than the original image can be obtained from only the data of the base layer, and the data of the base layer and the data of the non-base layer can be combined to obtain the original image (that is, high-quality image).

The images are tiered in this way, and images with a variety of quality can be easily obtained according to the situation. For example, image compression information of only the base layer can be transmitted to a terminal with low processing capability, such as a mobile phone, and moving images with low spatial-temporal resolution or low image quality can be reproduced. Image compression information of the enhancement layers in addition to the base layer can be transmitted to a terminal with high processing capability, such as a TV and a personal computer, and moving images with high spatial-temporal resolution or high image quality can be reproduced. In this way, the image compression information according to the capability of the terminal or the network can be transmitted from the server without executing a transcoding process.

In the case of encoding and decoding the tiered images as in the example of FIG. 44, the tiered images are encoded in each layer. Furthermore, in the case of decoding the encoded data obtained in this way, the encoded data of each layer is decoded (that is, on a layer-by-layer basis). The methods described in the embodiment may be applied to the encoding and decoding of each layer. In this way, the S/N and the compression efficiency can be significantly improved. That is, in the case of tiered images, the S/N and the compression efficiency can be significantly improved in a similar manner.

### <Scalable Parameter>

In the tiered image encoding and the tiered image decoding (scalable encoding and scalable decoding), the parameter with the scalability function is arbitrary. For example, the spatial resolution may be the parameter (spatial scalability). In the case of the spatial scalability, the resolution of the image is different in each layer.

In addition, another example of the parameter with scalability includes the temporal resolution (temporal scalability). In the case of the temporal scalability, the frame rate is different in each layer.

Furthermore, another example of the parameter with scalability includes the signal to noise ratio (SNR) (SNR scalability). In the case of the SNR scalability, the SN ratio is different in each layer.

Obviously, the parameter with scalability can be a parameter other than the parameters described in the examples. For example, there is bit-depth scalability in which the base layer includes an 8-bit image, and the enhancement layer is added to the 8-bit image to obtain a 10-bit image.

In addition, there is chroma scalability in which the base layer includes a component image in a 4:2:0 format, and the enhancement layer is added to the component image to obtain a component image in a 4:2:2 format.

### <Tiered Image Encoding/Decoding System>

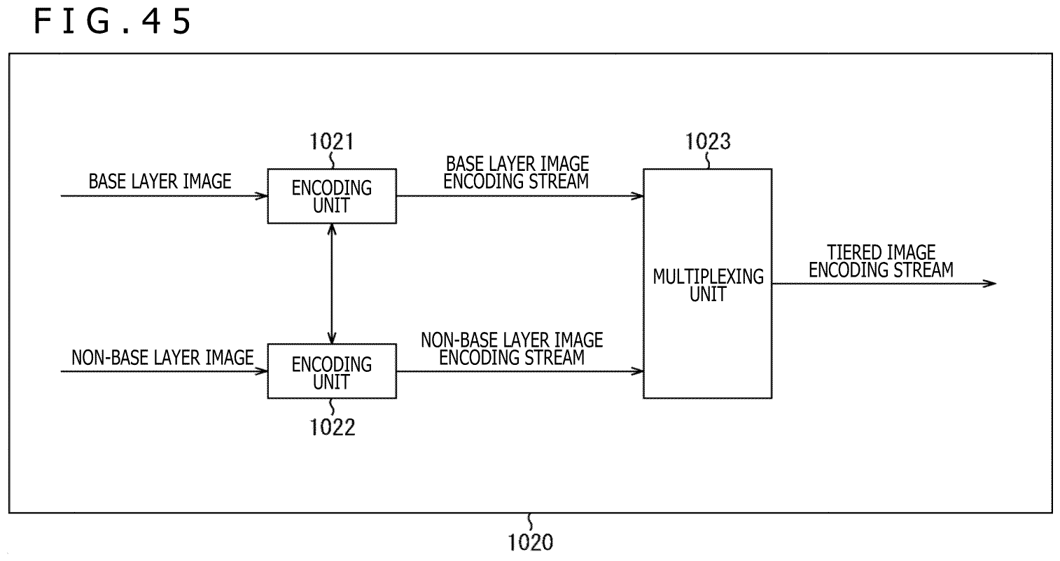

FIG. 45 is a diagram illustrating a tiered image encoding apparatus of the tiered image encoding/decoding system that performs the tiered image encoding/decoding described above.

As illustrated in FIG. 45, a tiered image encoding apparatus 1020 includes an encoding unit 1021, an encoding unit 1022, and a multiplexing unit 1023.

The encoding unit 1021 encodes a base layer image to generate a base layer image encoding stream. The encoding unit 1022 encodes a non-base layer image to generate a non-base layer image encoding stream. The multiplexing unit 1023 multiplexes the base layer image encoding stream generated by the encoding unit 1021 and the non-base layer image encoding stream generated by the encoding unit 1022 to generate a tiered image encoding stream.

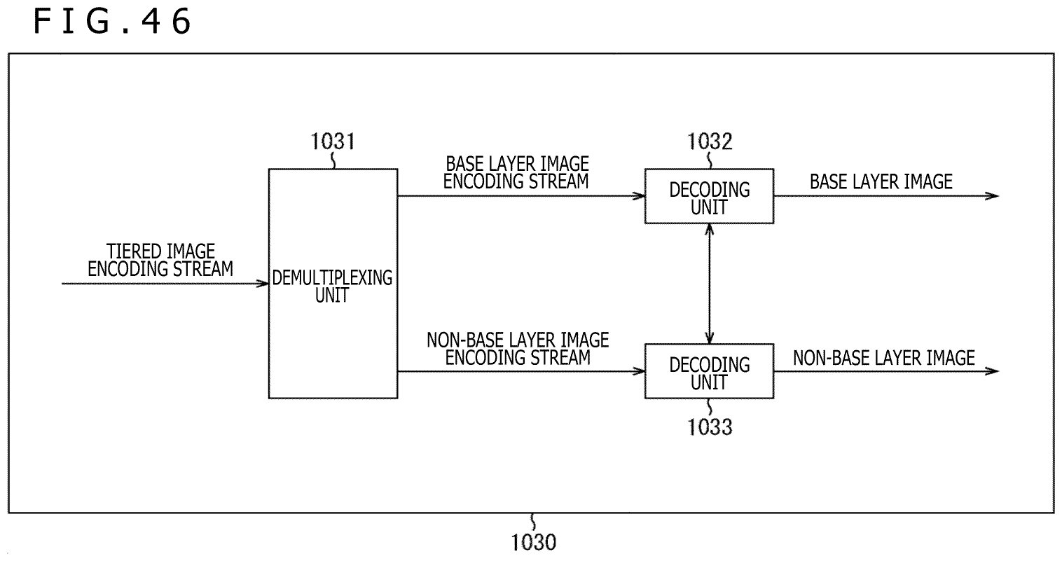

FIG. 46 is a diagram illustrating a tiered image decoding apparatus that performs the tiered image decoding described above.

As illustrated in FIG. 46, a tiered image decoding apparatus 1030 includes a demultiplexing unit 1031, a decoding unit 1032, and a decoding unit 1033.

The demultiplexing unit 1031 demultiplexes a tiered image encoding stream including multiplexed base layer image encoding stream and non-base layer image encoding stream and extracts a base layer image encoding stream and a non-base layer image encoding stream. The decoding unit 1032 decodes the base layer image encoding stream extracted by the demultiplexing unit 1031 and obtains a base layer image. The decoding unit 1033 decodes the non-base layer image encoding stream extracted by the demultiplexing unit 1031 and obtains a non-base layer image.

For example, in the tiered image encoding/decoding system, the encoding apparatus 11 described in the embodiment may be applied as the encoding unit 1021 and the encoding unit 1022 of the tiered image encoding apparatus 1020. In this way, the methods described in the embodiment can also be applied to the encoding of tiered images. That is, the S/N and the compression efficiency can be significantly improved. In addition, for example, the decoding apparatus 12 described in the embodiment may be applied as the decoding unit 1032 and the decoding unit 1033 of the tiered image decoding apparatus 1030. In this way, the methods described in the embodiment can also be applied to the decoding of the encoded data of tiered images. That is, the S/N and the compression efficiency can be significantly improved.

### <Computer>

The series of processes can be executed by hardware or can be executed by software. In the case where the series of processes are executed by software, a program included in the software is installed on a computer. Here, examples of the computer include a computer incorporated into dedicated hardware and a general-purpose personal computer that can execute various functions by installing various programs.

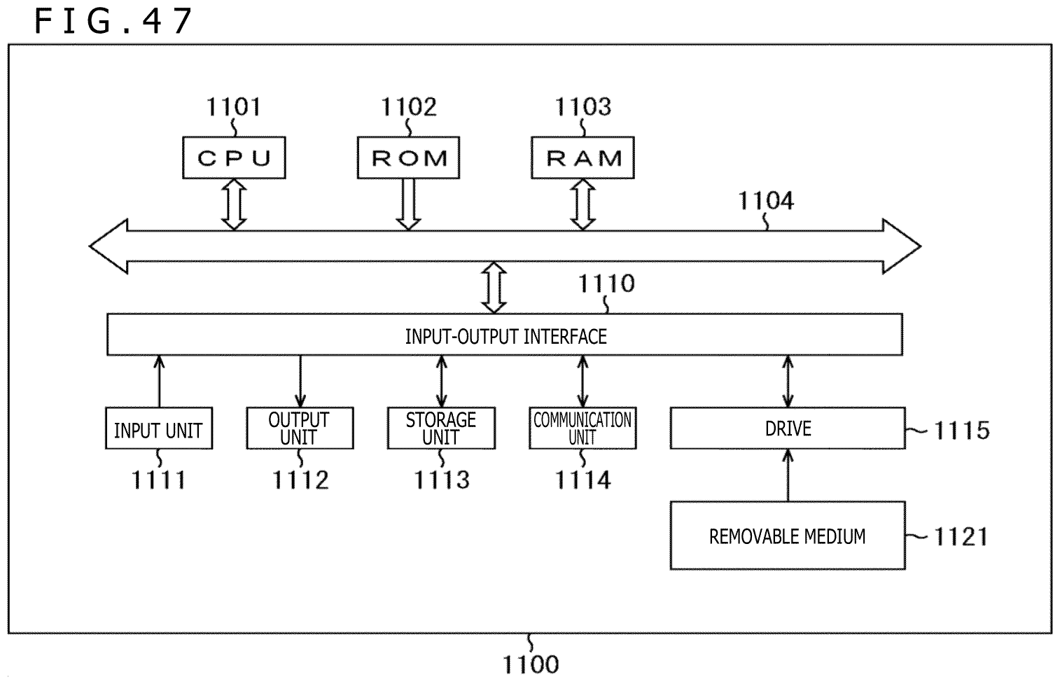

FIG. 47 is a block diagram illustrating a configuration example of the hardware of the computer that uses a program to execute the series of processes.

In a computer 1100 illustrated in FIG. 47, a CPU (Central Processing Unit) 1101, a ROM (Read Only Memory) 1102, and a RAM (Random Access Memory) 1103 are connected to each other through a bus 1104.

An input-output interface 1110 is also connected to the bus 1104. An input unit 1111, an output unit 1112, a storage unit 1113, a communication unit 1114, and a drive 1115 are connected to the input-output interface 1110.

The input unit 1111 includes, for example, a keyboard, a mouse, a microphone, a touch panel, an input terminal, and the like. The output unit 1112 includes, for example, a display, a speaker, an output terminal, and the like. The storage unit 1113 includes, for example, a hard disk, a RAM disk, a non-volatile memory, and the like. The communication unit 1114 includes, for example, a network interface. The drive 1115 drives a removable medium 821, such as a magnetic disk, an optical disk, a magneto-optical disk, and a semiconductor memory.

In the computer configured in this way, the CPU 1101 loads, for example, a program stored in the storage unit 1113 to the RAM 1103 through the input-output interface 1110 and the bus 1104 to execute the program to thereby execute the series of processes. Data and the like necessary for the CPU 1101 to execute various processes are also appropriately stored in the RAM 1103.

The program executed by the computer (CPU 1101) can be applied by, for example, recording the program in the removable medium 821 as a package medium or the like. In this case, the removable medium 821 can be mounted on the drive 1115 to install the program on the storage unit 1113 through the input-output interface 1110.

The program can also be provided through a wired or wireless transmission medium, such as a local area network, the Internet, and digital satellite broadcasting. In this case, the program can be received by the communication unit 1114 and installed on the storage unit 1113.

In addition, the program can also be installed in advance on the ROM 1102 or the storage unit 1113.

### <Application of Present Technique>

The encoding apparatus 11 and the decoding apparatus 12 according to the embodiment can be applied to, for example, various electronic devices, such as a transmitter and a receiver in satellite broadcasting, cable broadcasting like cable TV, distribution through the Internet, or distribution to a terminal through cellular communication, a recording apparatus that records images in a medium like an optical disk, a magnetic disk, or a flash memory, and a reproduction apparatus that reproduces images from these storage media. Hereinafter, four application examples will be described.

### First Application Example: Television Receiver

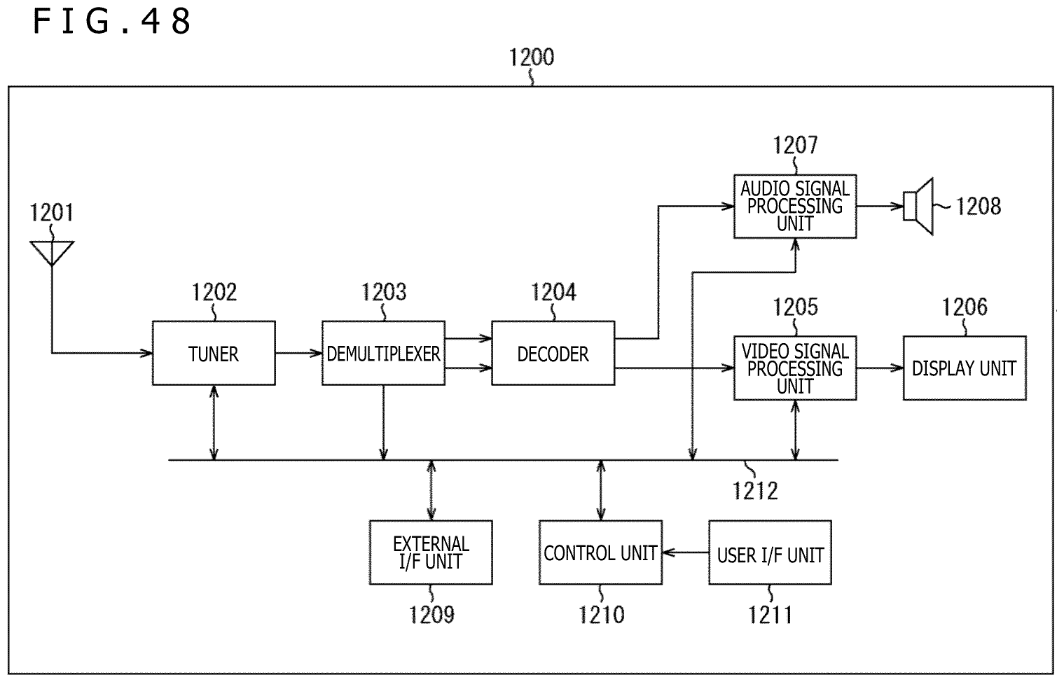

FIG. 48 is a diagram illustrating an example of a schematic configuration of a television apparatus according to the embodiment.

A television apparatus 1200 includes an antenna 1201, a tuner 1202, a demultiplexer 1203, a decoder 1204, a video signal processing unit 1205, a display unit 1206, an audio signal processing unit 1207, a speaker 1208, an external interface (I/F) unit 1209, a control unit 1210, a user interface (I/F) unit 1211, and a bus 1212.

The tuner 1202 extracts a signal of a desired channel from a broadcast signal received through the antenna 1201 and demodulates the extracted signal. The tuner 1202 then outputs an encoded bitstream obtained by the demodulation to the demultiplexer 1203. That is, the tuner 1202 plays a role of a transmission unit in the television apparatus 1200 that receives an encoded stream in which an image is encoded.

The demultiplexer 1203 separates a video stream and an audio stream of a program to be viewed from the encoded bitstream and outputs each of the separated streams to the decoder 1204. The demultiplexer 1203 also extracts auxiliary data, such as EPG (Electronic Program Guide), from the encoded bitstream and supplies the extracted data to the control unit 1210. Note that in a case where the encoded bitstream is scrambled, the demultiplexer 1203 may descramble the encoded bitstream.

The decoder 1204 decodes the video stream and the audio stream input from the demultiplexer 1203. The decoder 1204 then outputs video data generated in the decoding process to the video signal processing unit 1205. The decoder 1204 also outputs audio data generated in the decoding process to the audio signal processing unit 1207.

The video signal processing unit 1205 reproduces the video data input from the decoder 1204 and causes the display unit 1206 to display the video. The video signal processing unit 1205 may also cause the display unit 1206 to display an application screen supplied through a network. The video signal processing unit 1205 may also apply, for example, an additional process, such as noise removal, to the video data according to the setting. The video signal processing unit 1205 may further generate, for example, an image of GUI (Graphical User Interface), such as a menu, a button, and a cursor, and superimpose the generated image on the output image.

The display unit 1206 is driven by a drive signal supplied from the video signal processing unit 1205, and the display unit 1206 displays a video or an image on a video screen of a display device (for example, liquid crystal display, plasma display, OELD (Organic ElectroLuminescence Display) (organic EL display), or the like).

The audio signal processing unit 1207 applies a reproduction process, such as D/A conversion and amplification, to the audio data input from the decoder 1204 and causes the speaker 1208 to output the sound. The audio signal processing unit 1207 may also apply an additional process, such as noise removal, to the audio data.

The external interface unit 1209 is an interface for connecting the television apparatus 1200 and an external device or a network. For example, the decoder 1204 may decode a video stream or an audio stream received through the external interface unit 1209. That is, the external interface unit 1209 also plays a role of a transmission unit in the television apparatus 1200 that receives an encoded stream in which an image is encoded.

The control unit 1210 includes a processor, such as a CPU, and a memory, such as a RAM and a ROM. The memory stores a program executed by the CPU, program data, EPG data, data acquired through the network, and the like. The CPU reads and executes the program stored in the memory at, for example, the start of the television apparatus 1200. The CPU executes the program to control the operation of the television apparatus 1200 according to, for example, an operation signal input from the user interface unit 1211.

The user interface unit 1211 is connected to the control unit 1210. The user interface unit 1211 includes, for example, a button and a switch for the user to operate the television apparatus 1200, a reception unit of a remote control signal, and the like. The user interface unit 1211 detects an operation by the user through these constituent elements to generate an operation signal and outputs the generated operation signal to the control unit 1210.

The bus 1212 mutually connects the tuner 1202, the demultiplexer 1203, the decoder 1204, the video signal processing unit 1205, the audio signal processing unit 1207, the external interface unit 1209, and the control unit 1210.

In the television apparatus 1200 configured in this way, the decoder 1204 may have the function of the decoding apparatus 12. That is, the decoder 1204 may use the methods described in the embodiment to decode the encoded data. In this way, the television apparatus 1200 can significantly improve the S/N and the compression efficiency.

In addition, in the television apparatus 1200 configured in this way, the video signal processing unit 1205 may be able to, for example, encode the image data supplied from the decoder 1204 and output the obtained encoded data to the outside of the television apparatus 1200 through the external interface unit 1209. Furthermore, the video signal processing unit 1205 may have the function of the encoding apparatus 11. That is, the video signal processing unit 1205 may use the methods described in the embodiment to encode the image data supplied from the decoder 1204. In this way, the television apparatus 1200 can significantly improve the S/N and the compression efficiency.

### Second Application Example: Mobile Phone

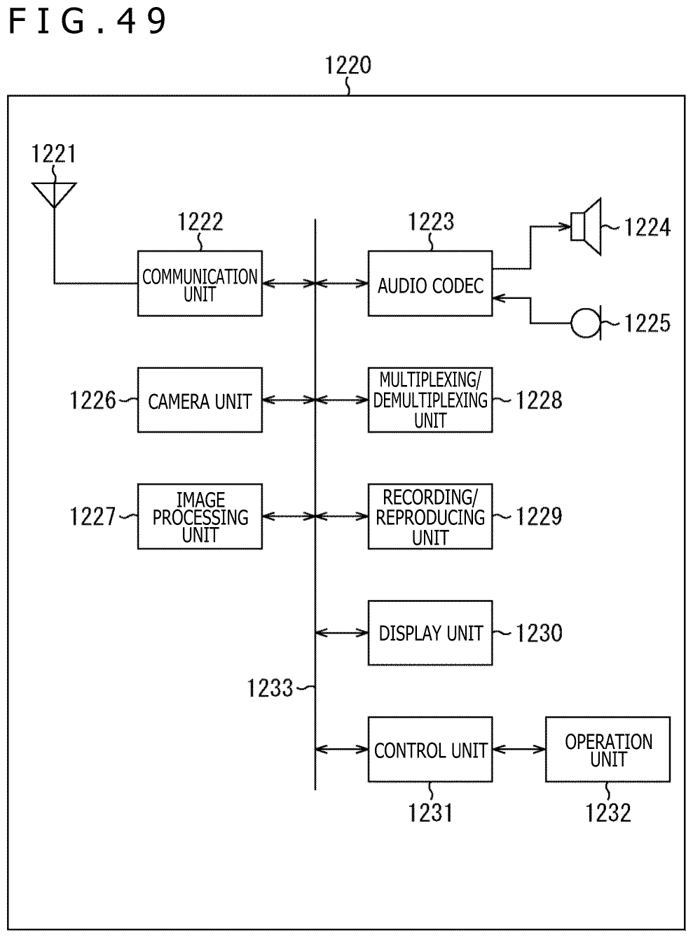

FIG. 49 is a diagram illustrating an example of a schematic configuration of a mobile phone according to the embodiment.

A mobile phone 1220 includes an antenna 1221, a communication unit 1222, an audio codec 1223, a speaker 1224, a microphone 1225, a camera unit 1226, an image processing unit 1227, a multiplexing/demultiplexing unit 1228, a recording/reproducing unit 1229, a display unit 1230, a control unit 1231, an operation unit 1232, and a bus 1233.

The antenna 1221 is connected to the communication unit 1222. The speaker 1224 and the microphone 1225 are connected to the audio codec 1223. The operation unit 1232 is connected to the control unit 1231. The bus 1233 mutually connects the communication unit 1222, the audio codec 1223, the camera unit 1226, the image processing unit 1227, the multiplexing/demultiplexing unit 1228, the recording/reproducing unit 1229, the display unit 1230, and the control unit 1231.

The mobile phone 1220 performs operations, such as transmitting and receiving an audio signal, transmitting and receiving email or image data, taking an image, and recording data, in various operation modes including a voice call mode, a data communication mode, an imaging mode, and a TV phone mode.

In the voice call mode, an analog audio signal generated by the microphone 1225 is supplied to the audio codec 1223. The audio codec 1223 converts the analog audio signal into audio data and performs A/D conversion to compress the converted audio data. The audio codec 1223 then outputs the audio data after the compression to the communication unit 1222. The communication unit 1222 encodes and modulates the audio data to generate a transmission signal. The communication unit 1222 then transmits the generated transmission signal to a base station (not illustrated) through the antenna 1221. The communication unit 1222 also amplifies a wireless signal received through the antenna 1221 and converts the frequency to acquire a reception signal. The communication unit 1222 then demodulates and decodes the reception signal to generate audio data and outputs the generated audio data to the audio codec 1223. The audio codec 1223 expands and performs D/A conversion of the audio data to generate an analog audio signal. The audio codec 1223 then supplies the generated audio signal to the speaker 1224 to output the sound.

In addition, for example, the control unit 1231 generates character data of an email according to an operation by the user through the operation unit 1232 in the data communication mode. The control unit 1231 also causes the display unit 1230 to display the characters. The control unit 1231 also generates email data according to a transmission instruction from the user through the operation unit 1232 and outputs the generated email data to the communication unit 1222. The communication unit 1222 encodes and modulates the email data to generate a transmission signal. The communication unit 1222 then transmits the generated transmission signal to a base station (not illustrated) through the antenna 1221. The communication unit 1222 also amplifies a wireless signal received through the antenna 1221 and converts the frequency to acquire a reception signal. The communication unit 1222 then demodulates and decodes the reception signal to restore email data and outputs the restored email data to the control unit 1231. The control unit 1231 causes the display unit 1230 to display the content of the email and supplies the email data to the recording/reproducing unit 1229 to write the email data to a storage medium of the recording/reproducing unit 1229.

The recording/reproducing unit 1229 includes an arbitrary read/write storage medium. For example, the storage medium may be a built-in storage medium, such as a RAM and a flash memory, or may be an externally mounted storage medium, such as a hard disk, a magnetic disk, a magneto-optical disk, an optical disk, a USB (Universal Serial Bus) memory, and a memory card.

In addition, for example, the camera unit 1226 takes an image of a subject to generate image data and outputs the generated image data to the image processing unit 1227 in the imaging mode. The image processing unit 1227 encodes the image data input from the camera unit 1226 and supplies the encoded stream to the recording/reproducing unit 1229 to write the encoded stream to the storage medium of the recording/reproducing unit 1229.

Furthermore, the recording/reproducing unit 1229 reads an encoded stream recorded in the storage medium and outputs the encoded stream to the image processing unit 1227 in the image display mode. The image processing unit 1227 decodes the encoded stream input from the recording/reproducing unit 1229 and supplies the image data to the display unit 1230 to display the image.

In addition, for example, the multiplexing/demultiplexing unit 1228 multiplexes a video stream encoded by the image processing unit 1227 and an audio stream input from the audio codec 1223 and outputs the multiplexed stream to the communication unit 1222 in the TV phone mode. The communication unit 1222 encodes and modulates the stream to generate a transmission signal. The communication unit 1222 then transmits the generated transmission signal to a base station (not illustrated) through the antenna 1221. The communication unit 1222 also amplifies a wireless signal received through the antenna 1221 and converts the frequency to acquire a reception signal. The transmission signal and the reception signal can include encoded bitstreams. The communication unit 1222 then demodulates and decodes the reception signal to restore the stream and outputs the restored stream to the multiplexing/demultiplexing unit 1228. The multiplexing/demultiplexing unit 1228 separates a video stream and an audio stream from the input stream, outputs the video stream to the image processing unit 1227, and outputs the audio stream to the audio codec 1223. The image processing unit 1227 decodes the video stream to generate video data. The video data is supplied to the display unit 1230, and the display unit 1230 displays a series of images. The audio codec 1223 expands and performs D/A conversion of the audio stream to generate an analog audio signal. The audio codec 1223 then supplies the generated audio signal to the speaker 1224 to output the sound.

In the mobile phone 1220 configured in this way, the image processing unit 1227 may have, for example, the function of the encoding apparatus 11. That is, the image processing unit 1227 may use the methods described in the embodiment to encode the image data. In this way, the mobile phone 1220 can significantly improve the S/N and the compression efficiency.

In addition, in the mobile phone 1220 configured in this way, the image processing unit 1227 may have, for example, the function of the decoding apparatus 12. That is, the image processing unit 1227 may use the methods described in the embodiment to decode the encoded data. In this way, the mobile phone 1220 can significantly improve the S/N and the compression efficiency.

### Third Application Example: Recording/Reproducing Apparatus

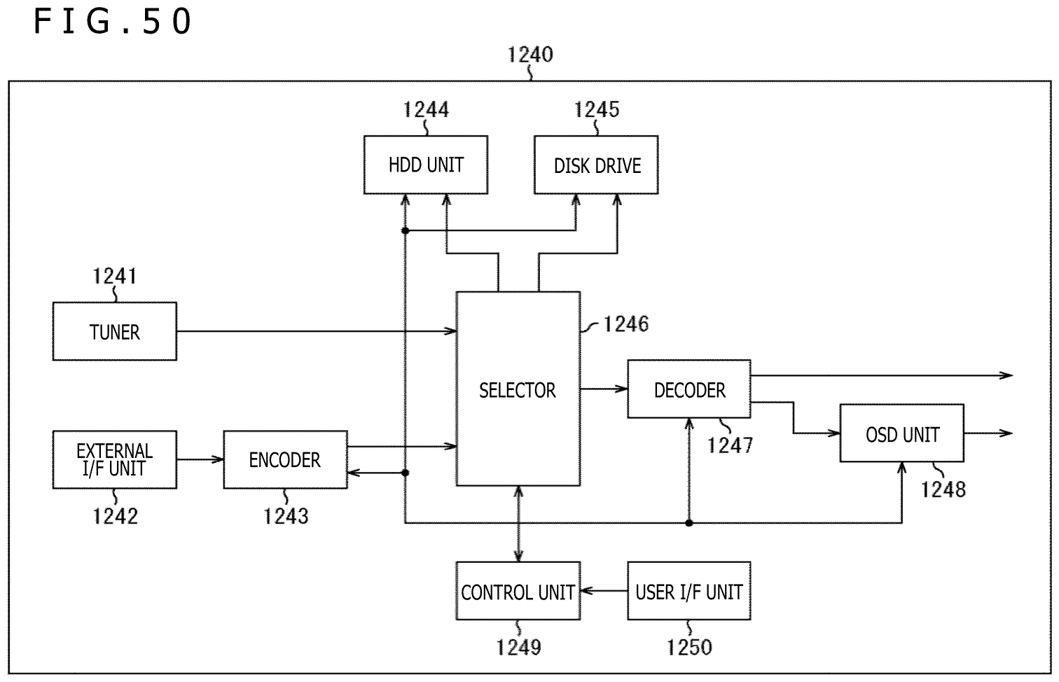

FIG. 50 is a diagram illustrating an example of a schematic configuration of a recording/reproducing apparatus according to the embodiment.

For example, a recording/reproducing apparatus 1240 encodes audio data and video data of a received broadcast program and records the audio data and the video data in a recording medium. The recording/reproducing apparatus 1240 may also encode audio data and video data acquired from another apparatus and record the audio data and the video data in the recording medium, for example. The recording/reproducing apparatus 1240 also reproduces data recorded in the recording medium on a monitor and a speaker according to an instruction of the user, for example. In this case, the recording/reproducing apparatus 1240 decodes audio data and video data.

The recording/reproducing apparatus 1240 includes a tuner 1241, an external interface (I/F) unit 1242, an encoder 1243, an HDD (Hard Disk Drive) unit 1244, a disk drive 1245, a selector 1246, a decoder 1247, an OSD (On-Screen Display) unit 1248, a control unit 1249, and a user interface (I/F) unit 1250.

The tuner 1241 extracts a signal of a desired channel from a broadcast signal received through an antenna (not illustrated) and demodulates the extracted signal. The tuner 1241 then outputs an encoded bitstream obtained by the demodulation to the selector 1246. That is, the tuner 1241 plays a role of a transmission unit in the recording/reproducing apparatus 1240.

The external interface unit 1242 is an interface for connecting the recording/reproducing apparatus 1240 and an external device or a network. The external interface unit 1242 may be, for example, an IEEE (Institute of Electrical and Electronic Engineers) 1394 interface, a network interface, a USB interface, a flash memory interface, or the like. For example, video data and audio data received through the external interface unit 1242 are input to the encoder 1243. That is, the external interface unit 1242 plays a role of a transmission unit in the recording/reproducing apparatus 1240.

The encoder 1243 encodes video data and audio data in a case where the video data and the audio data input from the external interface unit 1242 are not encoded. The encoder 1243 then outputs an encoded bitstream to the selector 1246.

The HDD unit 1244 records encoded bitstreams including compressed content data of video, sound, and the like, various programs, and other data in an internal hard disk. The HDD unit 1244 also reads the data from the hard disk at the reproduction of the video and the sound.

The disk drive 1245 records and reads data to and from a mounted recording medium. The recording medium mounted on the disk drive 1245 may be, for example, a DVD (Digital Versatile Disc) disk (DVD-Video, DVD-RAM (DVD-Random Access Memory), DVD-R (DVD-Recordable), DVD-RW (DVD-Rewritable), DVD+R (DVD+Recordable), DVD+RW (DVD+Rewritable), or the like), a Blu-ray (registered trademark) disk, or the like.

At the recording of the video and the sound, the selector 1246 selects an encoded bitstream input from the tuner 1241 or the encoder 1243 and outputs the selected encoded bitstream to the HDD 1244 or the disk drive 1245. In addition, at the reproduction of the video and the sound, the selector 1246 outputs the encoded bitstream input from the HDD 1244 or the disk drive 1245 to the decoder 1247.

The decoder 1247 decodes the encoded bitstream to generate video data and audio data. The decoder 1247 then outputs the generated video data to the OSD unit 1248. In addition, the decoder 1247 outputs the generated audio data to an external speaker.

The OSD unit 1248 reproduces the video data input from the decoder 1247 and displays the video. The OSD unit 1248 may also superimpose, for example, an image of GUI, such as a menu, a button, and a cursor, on the displayed video.

The control unit 1249 includes a processor, such as a CPU, and a memory, such as a RAM and a ROM. The memory stores a program executed by the CPU, program data, and the like. The CPU reads and executes the program stored in the memory at, for example, the start of the recording/reproducing apparatus 1240. The CPU executes the program to control the operation of the recording/reproducing apparatus 1240 according to, for example, an operation signal input from the user interface unit 1250.

The user interface unit 1250 is connected to the control unit 1249. The user interface unit 1250 includes, for example, a button and a switch for the user to operate the recording/reproducing apparatus 1240, a reception unit of a remote control signal, and the like. The user interface unit 1250 detects an operation by the user through these constituent elements to generate an operation signal and outputs the generated operation signal to the control unit 1249.

In the recording/reproducing apparatus 1240 configured in this way, the encoder 1243 may have, for example, the function of the encoding apparatus 11. That is, the encoder 1243 may use the methods described in the embodiment to encode the image data. In this way, the recording/reproducing apparatus 1240 can significantly improve the S/N and the compression efficiency.

Furthermore, in the recording/reproducing apparatus 1240 configured in this way, the decoder 1247 may have, for example, the function of the decoding apparatus 12. That is, the decoder 1247 may use the methods described in the embodiment to decode the encoded data. In this way, the recording/reproducing apparatus 1240 can significantly improve the S/N and the compression efficiency.

### Fourth Application Example: Imaging Apparatus

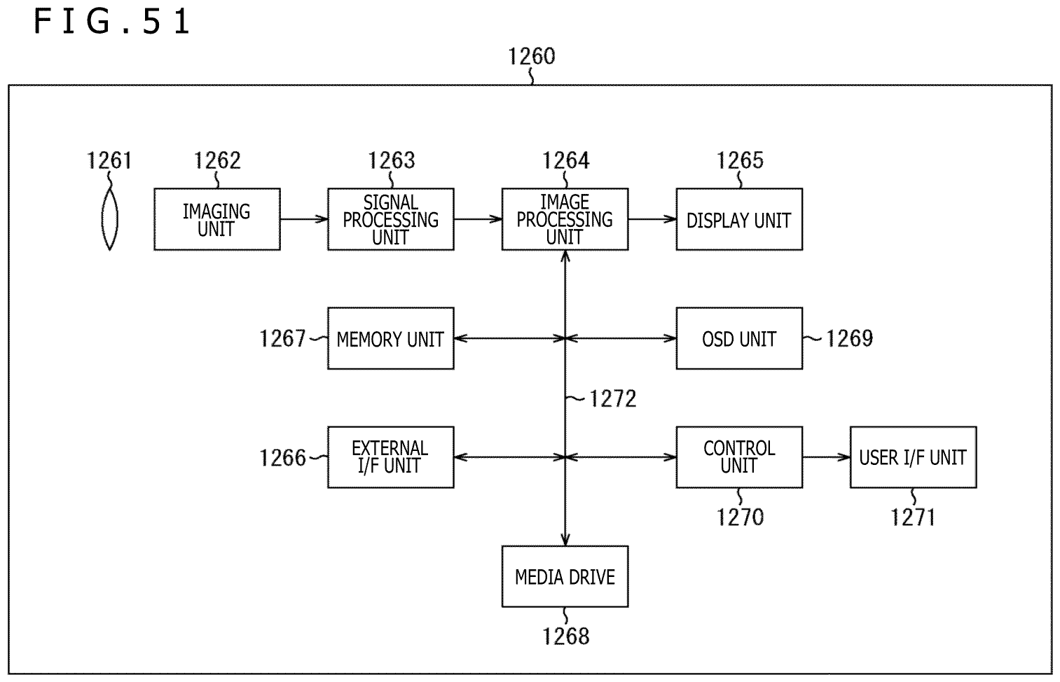

FIG. 51 is a diagram illustrating an example of a schematic configuration of an imaging apparatus according to the embodiment.

An imaging apparatus 1260 images a subject, generates an image, encodes image data, and records the image data in a recording medium.

The imaging apparatus 1260 includes an optical block 1261, an imaging unit 1262, a signal processing unit 1263, an image processing unit 1264, a display unit 1265, an external interface (I/F) unit 1266, a memory unit 1267, a media drive 1268, an OSD unit 1269, a control unit 1270, a user interface (I/F) unit 1271, and a bus 1272.

The optical block 1261 is connected to the imaging unit 1262. The imaging unit 1262 is connected to the signal processing unit 1263. The display unit 1265 is connected to the image processing unit 1264. The user interface unit 1271 is connected to the control unit 1270. The bus 1272 mutually connects the image processing unit 1264, the external interface unit 1266, the memory unit 1267, the media drive 1268, the OSD unit 1269, and the control unit 1270.

The optical block 1261 includes a focus lens, a diaphragm mechanism, and the like. The optical block 1261 forms an optical image of the subject on an imaging surface of the imaging unit 1262. The imaging unit 1262 includes an image sensor, such as a CCD (Charge Coupled Device) and a CMOS (Complementary Metal Oxide Semiconductor), and performs photoelectric conversion of the optical image formed on the imaging surface to convert the optical image into an image signal that is an electrical signal. The imaging unit 1262 then outputs the image signal to the signal processing unit 1263.

The signal processing unit 1263 applies various types of camera signal processing, such as knee correction, gamma correction, and color correction, to the image signal input from the imaging unit 1262. The signal processing unit 1263 outputs the image data after the camera signal processing to the image processing unit 1264.

The image processing unit 1264 encodes the image data input from the signal processing unit 1263 to generate encoded data. The image processing unit 1264 then outputs the generated encoded data to the external interface unit 1266 or the media drive 1268. The image processing unit 1264 also decodes encoded data input from the external interface unit 1266 or the media drive 1268 to generate image data. The image processing unit 1264 then outputs the generated image data to the display unit 1265. The image processing unit 1264 may also output the image data input from the signal processing unit 1263 to the display unit 1265 to display the image. The image processing unit 1264 may also superimpose display data acquired from the OSD unit 1269 on the image output to the display unit 1265.

The OSD unit 1269 generates, for example, an image of GUI, such as a menu, a button, and a cursor, and outputs the generated image to the image processing unit 1264.

The external interface unit 1266 is provided as, for example, a USB input/output terminal. The external interface unit 1266 connects, for example, the imaging apparatus 1260 and a printer at the printing of an image. A drive is also connected to the external interface unit 1266 as necessary. The drive is provided with, for example, a removable medium, such as a magnetic disk and an optical disk, and a program read from the removable medium can be installed on the imaging apparatus 1260. Furthermore, the external interface unit 1266 may be provided as a network interface connected to a network, such as a LAN and the Internet. That is, the external interface unit 1266 plays a role of a transmission unit in the imaging apparatus 1260.

A recording medium mounted on the media drive 1268 may be, for example, an arbitrary read/write removable medium, such as a magnetic disk, a magneto-optical disk, an optical disk, and a semiconductor memory. In addition, the recording medium may be fixed and mounted on the media drive 1268 to provide, for example, a non-portable storage unit, such as a built-in hard disk drive and an SSD (Solid State Drive).

The control unit 1270 includes a processor, such as a CPU, and a memory, such as a RAM and a ROM. The memory stores a program executed by the CPU, program data, and the like. The CPU reads and executes the program stored in the memory at, for example, the start of the imaging apparatus 1260. The CPU executes the program to control the operation of the imaging apparatus 1260 according to, for example, an operation signal input from the user interface unit 1271.

The user interface unit 1271 is connected to the control unit 1270. The user interface unit 1271 includes, for example, a button, a switch, and the like for the user to operate the imaging apparatus 1260. The user interface unit 1271 detects an operation by the user through these constituent elements to generate an operation signal and outputs the generated operation signal to the control unit 1270.

In the imaging apparatus 1260 configured in this way, the image processing unit 1264 may have, for example, the function of the encoding apparatus 11. That is, the image processing unit 1264 may use the methods described in the embodiment to encode the image data. In this way, the imaging apparatus 1260 can significantly improve the S/N and the compression efficiency.

In addition, in the imaging apparatus 1260 configured in this way, the image processing unit 1264 may have, for example, the function of the decoding apparatus 12. That is, the image processing unit 1264 may use the methods described in the embodiment to decode the encoded data. In this way, the imaging apparatus 1260 can significantly improve the S/N and the compression efficiency.

### Other Application Examples

Note that the present technique can also be applied to, for example, HTTP streaming, such as MPEG DASH, in which appropriate data is used by selecting the data on a segment-by-segment basis from a plurality of pieces of encoded data with different resolutions or the like prepared in advance. That is, information regarding encoding and decoding can also be shared between the plurality of pieces of encoded data.

In addition, although the examples of the apparatus, the system, and the like according to the present technique are described above, the present technique is not limited to these. The present technique can also be carried out in any configuration mounted on an apparatus included in the apparatus or the system, such as, for example, a processor as system LSI (Large Scale Integration) or the like, a module using a plurality of processors or the like, a unit using a plurality of modules or the like, and a set provided with other functions in addition to the unit (that is, configuration of part of an apparatus).

### <Video Set>

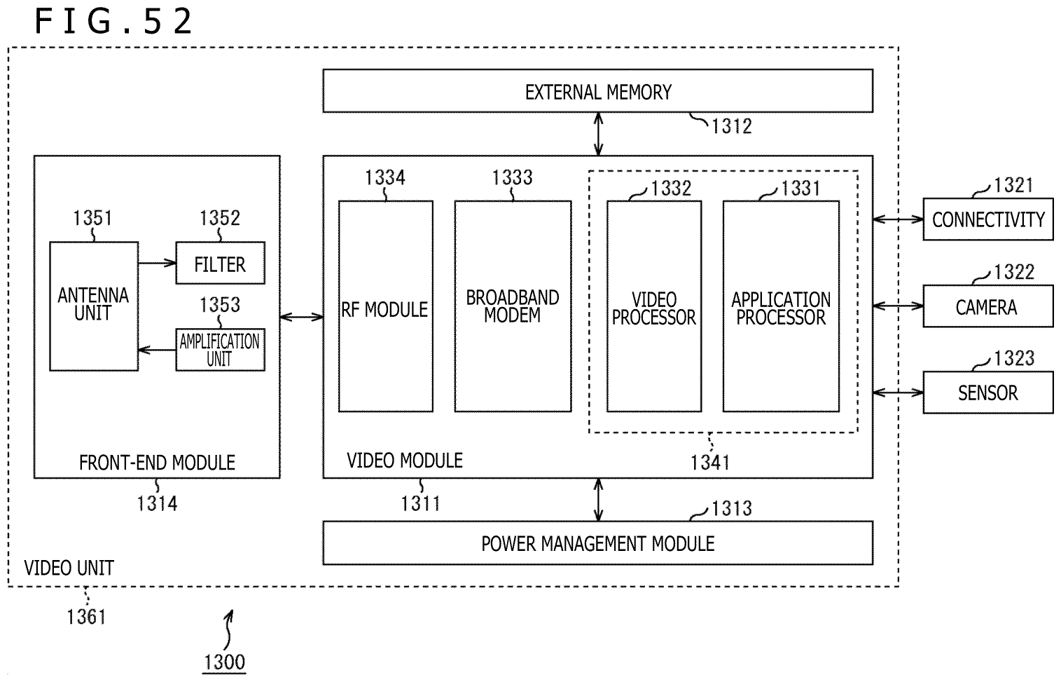

An example of a case where the present technique is carried out as a set will be described with reference to FIG. 52.

FIG. 52 is a diagram illustrating an example of a schematic configuration of a video set according to the present technique.

In recent years, electronic devices are provided with more functions, and in the development or manufacturing of the electronic devices, there is a case where the configuration of part of the electronic devices is implemented by selling or providing the configuration. Instead of implementing the configuration as a configuration having one function, a plurality of configurations with related functions are often combined to implement the configurations as one set provided with a plurality of functions.

A video set 1300 illustrated in FIG. 52 has such a configuration with multiple functions, and a device having functions regarding encoding or decoding (one of or both encoding and decoding) of images is combined with a device having other functions related to the functions.

As illustrated in FIG. 52, a video set 1300 includes a module group, such as a video module 1311, an external memory 1312, a power management module 1313, and a front-end module 1314, and a device having related functions, such as a connectivity 1321, a camera 1322, and a sensor 1323.

The modules are components with integrated functions, in which some functions of components related to each other are integrated. The specific physical configuration is arbitrary, and for example, a plurality of processors with respective functions, electronic circuit elements, such as resistors and capacitors, and other devices can be arranged and integrated on a wiring board or the like. In addition, other modules, processors, and the like can be combined with the modules to provide new modules.

In the case of the example of FIG. 52, components with functions regarding image processing are combined in the video module 1311, and the video module 1311 includes an application processor 1331, a video processor 1332, a broadband modem 1333, and an RF module 1334.

The processor includes components with predetermined functions integrated on a semiconductor chip based on SoC (System On a Chip), and the processor is called, for example, system LSI (Large Scale Integration) or the like. The components with predetermined functions may be a logic circuit (hardware configuration), may be a CPU, a ROM, a RAM, and a program executed by using them (software configuration), or may be a combination of these. For example, the processor may include the logic circuit, the CPU, the ROM, the RAM, and the like, and part of the functions may be realized by the logic circuit (hardware configuration). The other functions may be realized by the program executed by the CPU (software configuration).

The application processor 1331 of FIG. 52 is a processor that executes an application regarding image processing. The application executed by the application processor 1331 can not only execute a computing process, but can also control, for example, components inside and outside of the video module 1311, such as a video processor 1332, as necessary in order to realize a predetermined function.

The video processor 1332 is a processor with a function regarding encoding or decoding (one of or both encoding and decoding) of an image.

The broadband modem 1333 performs digital modulation or the like of data (digital signal) to be transmitted in wired or wireless (or both wired and wireless) broadband communication performed through a broadband circuit, such as the Internet and a public phone network, to convert the data into an analog signal and demodulates an analog signal received in the broadband communication to convert the analog signal into data (digital signal). The broadband modem 1333 processes, for example, arbitrary information, such as image data to be processed by the video processor 1332, a stream including encoded image data, an application program, and configuration data.

The RF module 1334 is a module that applies frequency conversion, modulation and demodulation, amplification, a filtering process, and the like to an RF (Radio Frequency) signal transmitted and received through an antenna. For example, the RF module 1334 applies frequency conversion or the like to a baseband signal generated by the broadband modem 1333 to generate an RF signal. In addition, the RF module 1334 applies, for example, frequency conversion or the like to an RF signal received through the front-end module 1314 to generate a baseband signal.

Note that as indicated by a dotted line 1341 in FIG. 52, the application processor 1331 and the video processor 1332 may be integrated to provide one processor.

The external memory 1312 is a module provided outside of the video module 1311 and including a storage device used by the video module 1311. The storage device of the external memory 1312 may be realized by any physical configuration. However, the storage device is generally used to store high-capacity data, such as frame-based image data, in many cases. Therefore, it is desirable to realize the storage device by, for example, a relatively inexpensive high-capacity semiconductor memory, such as a DRAM (Dynamic Random Access Memory).

The power management module 1313 manages and controls power supplied to the video module 1311 (each component in the video module 1311).

The front-end module 1314 is a module that provides a front-end function (circuit at transmitting and receiving end of antenna side) to the RF module 1334. As illustrated in FIG. 52, the front-end module 1314 includes, for example, an antenna unit 1351, a filter 1352, and an amplification unit 1353.

The antenna unit 1351 includes an antenna that transmits and receives wireless signals and includes components around the antenna. The antenna unit 1351 transmits a wireless signal of a signal supplied from the amplification unit 1353 and supplies an electrical signal (RF signal) of a received wireless signal to the filter 1352. The filter 1352 applies a filtering process or the like to the RF signal received through the antenna unit 1351 and supplies the RF signal after the process to the RF module 1334. The amplification unit 1353 amplifies the RF signal supplied from the RF module 1334 and supplies the RF signal to the antenna unit 1351.

The connectivity 1321 is a module with a function regarding connection to the outside. The physical configuration of the connectivity 1321 is arbitrary. For example, the connectivity 1321 includes a component with a communication function of a standard other than the communication standard handled by the broadband modem 1333 and includes an external input-output terminal and the like.

For example, the connectivity 1321 may include: a module with a communication function in compliance with a wireless communication standard, such as Bluetooth (registered trademark), IEEE 802.11 (for example, Wi-Fi (Wireless Fidelity, registered trademark)), NFC (Near Field Communication), and IrDA (InfraRed Data Association); an antenna that transmits and receives a signal in compliance with the standard; and the like. The connectivity 1321 may also include, for example, a module with a communication function in compliance with a wired communication standard, such as USB (Universal Serial Bus) and HDMI (registered trademark) (High-Definition Multimedia Interface), and a terminal in compliance with the standard. The connectivity 1321 may further include, for example, other data (signal) transmission functions and the like, such as an analog input-output terminal.

Note that the connectivity 1321 may include a device of a transmission destination of data (signal). For example, the connectivity 1321 may include a drive (including not only a drive of a removable medium, but also a hard disk, an SSD (Solid State Drive), a NAS (Network Attached Storage), and the like) that reads and writes data to a recording medium, such as a magnetic disk, an optical disk, a magneto-optical disk, and a semiconductor memory. The connectivity 1321 may also include an output device (such as a monitor and a speaker) of images and sound.

The camera 1322 is a module with a function of imaging a subject to obtain image data of the subject. The image data obtained by the imaging of the camera 1322 is supplied to and encoded by, for example, the video processor 1332.

The sensor 1323 is, for example, a module with arbitrary functions of sensors, such as an audio sensor, an ultrasonic sensor, an optical sensor, an illumination sensor, an infrared sensor, an image sensor, a rotation sensor, an angle sensor, an angular velocity sensor, a speed sensor, an acceleration sensor, a tilt sensor, a magnetic identification sensor, an impact sensor, and a temperature sensor. Data detected by the sensor 1323 is supplied to, for example, the application processor 1331 and used by an application or the like.

The configurations of the modules described above may be realized by processors, and conversely, the configurations of the processors described above may be realized by modules.

In the video set 1300 configured as described above, the present technique can be applied to the video processor 1332 as described later. Therefore, the video set 1300 can be carried out as a set according to the present technique.

### <Configuration Example of Video Processor>

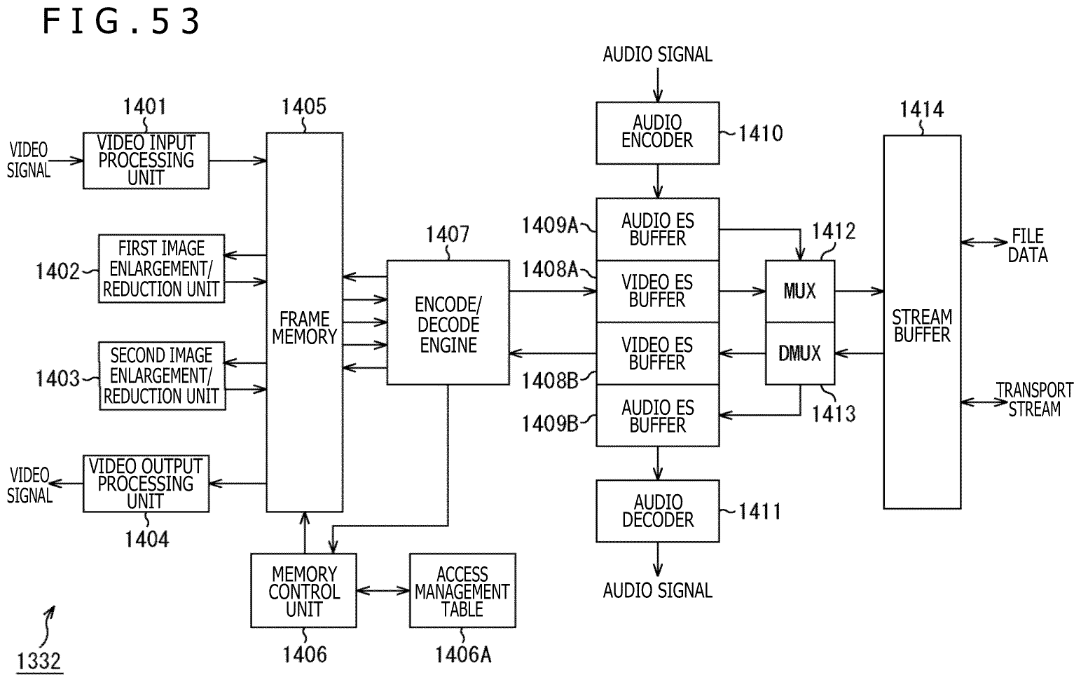

FIG. 53 is a diagram illustrating an example of a schematic configuration of the video processor 1332 (FIG. 52) according to the present technique.

In the case of the example of FIG. 53, the video processor 1332 has a function of receiving an input of a video signal and an audio signal and using a predetermined system to encode the signals and has a function of decoding encoded video data and audio data and reproducing and outputting a video signal and an audio signal.

As illustrated in FIG. 53, the video processor 1332 includes a video input processing unit 1401, a first image enlargement/reduction unit 1402, a second image enlargement/reduction unit 1403, a video output processing unit 1404, a frame memory 1405, and a memory control unit 1406. The video processor 1332 also includes an encode/decode engine 1407, video ES (Elementary Stream) buffers 1408A and 1408B, and audio ES buffers 1409A and 1409B. The video processor 1332 further includes an audio encoder 1410, an audio decoder 1411, a multiplexing unit (MUX (Multiplexer)) 1412, a demultiplexing unit (DMUX (Demultiplexer)) 1413, and a stream buffer 1414.

The video input processing unit 1401 acquires, for example, a video signal input from the connectivity 1321 (FIG. 52) or the like and converts the video signal into digital image data. The first image enlargement/reduction unit 1402 applies format conversion, enlargement/reduction processing of image, or the like to the image data. The second image enlargement/reduction unit 1403 applies enlargement/reduction processing of image to the image data according to the format at the destination of the output through the video output processing unit 1404 and applies format conversion, enlargement/reduction processing of image, or the like to the image data just like the first image enlargement/reduction unit 1402. The video output processing unit 1404 performs operations, such as converting the format of the image data and converting the image data into an analog signal, and outputs a reproduced video signal to, for example, the connectivity 1321 or the like.

The frame memory 1405 is a memory for image data shared by the video input processing unit 1401, the first image enlargement/reduction unit 1402, the second image enlargement/reduction unit 1403, the video output processing unit 1404, and the encode/decode engine 1407. The frame memory 1405 is realized as, for example, a semiconductor memory, such as a DRAM.

The memory control unit 1406 receives a synchronization signal from the encode/decode engine 1407 to control the access for writing and reading to and from the frame memory 1405 according to a schedule for accessing the frame memory 1405 written in the access management table 1406A. The access management table 1406A is updated by the memory control unit 1406 according to the process executed by the encode/decode engine 1407, the first image enlargement/reduction unit 1402, the second image enlargement/reduction unit 1403, or the like.

The encode/decode engine 1407 executes an encoding process of image data and a decoding process of a video stream in which image data is encoded data. For example, the encode/decode engine 1407 encodes image data read from the frame memory 1405 and sequentially writes video streams to the video ES buffer 1408A. In addition, for example, the encode/decode engine 1407 sequentially reads video streams from the video ES buffer 1408B to decode the video streams and sequentially writes image data to the frame memory 1405. The encode/decode engine 1407 uses the frame memory 1405 as a work area in the encoding and the decoding. The encode/decode engine 1407 also outputs a synchronization signal to the memory control unit 1406 at timing of, for example, the start of the process for each macroblock.

The video ES buffer 1408A buffers a video stream generated by the encode/decode engine 1407 and supplies the video stream to the multiplexing unit (MUX) 1412. The video ES buffer 1408B buffers a video stream supplied from the demultiplexing unit (DMUX) 1413 and supplies the video stream to the encode/decode engine 1407.

The audio ES buffer 1409A buffers an audio stream generated by the audio encoder 1410 and supplies the audio stream to the multiplexing unit (MUX) 1412. The audio ES buffer 1409B buffers an audio stream supplied from the demultiplexing unit (DMUX) 1413 and supplies the audio stream to the audio decoder 1411.

The audio encoder 1410 performs, for example, digital conversion of an audio signal input from, for example, the connectivity 1321 or the like and uses, for example, a predetermined system, such as an MPEG audio system and an AC3 (AudioCode number 3) system, to encode the audio signal. The audio encoder 1410 sequentially writes, to the audio ES buffer 1409A, audio streams that are data in which the audio signal is encoded. The audio decoder 1411 decodes the audio stream supplied from the audio ES buffer 1409B, performs an operation, such as, for example, converting the audio stream into an analog signal, and supplies a reproduced audio signal to, for example, the connectivity 1321 or the like.

The multiplexing unit (MUX) 1412 multiplexes a video stream and an audio stream. The method of multiplexing (that is, the format of the bitstream generated by multiplexing) is arbitrary. In the multiplexing, the multiplexing unit (MUX) 1412 can also add predetermined header information or the like to the bitstream. That is, the multiplexing unit (MUX) 1412 can convert the format of the stream by multiplexing. For example, the multiplexing unit (MUX) 1412 multiplexes the video stream and the audio stream to convert the streams into a transport stream that is a bitstream in a format for transfer. In addition, for example, the multiplexing unit (MUX) 1412 multiplexes the video stream and the audio stream to convert the streams into data (file data) in a file format for recording.

The demultiplexing unit (DMUX) 1413 uses a method corresponding to the multiplexing by the multiplexing unit (MUX) 1412 to demultiplex a bitstream in which a video stream and an audio stream are multiplexed. That is, the demultiplexing unit (DMUX) 1413 extracts the video stream and the audio stream (separates the video stream and the audio stream) from the bitstream read from the stream buffer 1414. That is, the demultiplexing unit (DMUX) 1413 can demultiplex the stream to convert the format of the stream (inverse transformation of the conversion by the multiplexing unit (MUX) 1412). For example, the demultiplexing unit (DMUX) 1413 can acquire a transport stream supplied from, for example, the connectivity 1321, the broadband modem 1333, or the like through the stream buffer 1414 and demultiplex the transport stream to convert the transport stream into a video stream and an audio stream. In addition, for example, the demultiplexing unit (DMUX) 1413 can acquire file data read from various recording media by the connectivity 1321 through the stream buffer 1414 and demultiplex the file data to convert the file data into a video stream and an audio stream.

The stream buffer 1414 buffers a bitstream. For example, the stream buffer 1414 buffers a transport stream supplied from the multiplexing unit (MUX) 1412 and supplies the transport stream to, for example, the connectivity 1321, the broadband modem 1333, or the like at predetermined timing or based on a request or the like from the outside.

In addition, for example, the stream buffer 1414 buffers file data supplied from the multiplexing unit (MUX) 1412 and supplies the file data to, for example, the connectivity 1321 or the like at predetermined timing or based on a request or the like from the outside to record the file data in various recording media.

The stream buffer 1414 further buffers a transport stream acquired through, for example, the connectivity 1321, the broadband modem 1333, or the like and supplies the transport stream to the demultiplexing unit (DMUX) 1413 at predetermined timing or based on a request or the like from the outside.

The stream buffer 1414 also buffers file data read from various recording media by, for example, the connectivity 1321 or the like and supplies the file data to the demultiplexing unit (DMUX) 1413 at predetermined timing or based on a request or the like from the outside.

Next, an example of an operation of the video processor 1332 configured in this way will be described. For example, the video input processing unit 1401 converts the video signal input from the connectivity 1321 or the like to the video processor 1332 into digital image data of a predetermined system, such as a 4:2:2 Y/Cb/Cr system, and sequentially writes the digital image data to the frame memory 1405. The first image enlargement/reduction unit 1402 or the second image enlargement/reduction unit 1403 reads the digital image data to convert the format into a predetermined system, such as a 4:2:0 Y/Cb/Cr system, and execute enlargement/reduction processing. The digital image data is written again to the frame memory 1405. The encode/decode engine 1407 encodes the image data, and the video stream is written to the video ES buffer 1408A.

In addition, the audio encoder 1410 encodes the audio signal input from the connectivity 1321 or the like to the video processor 1332, and the audio stream is written to the audio ES buffer 1409A.

The video stream of the video ES buffer 1408A and the audio stream of the audio ES buffer 1409A are read and multiplexed by the multiplexing unit (MUX) 1412 and converted into a transport stream, file data, or the like. The transport stream generated by the multiplexing unit (MUX) 1412 is buffered by the stream buffer 1414 and then output to an external network through, for example, the connectivity 1321, the broadband modem 1333, or the like. In addition, the stream buffer 1414 buffers the file data generated by the multiplexing unit (MUX) 1412, and the file data is then output to, for example, the connectivity 1321 or the like and recorded in various recording media.

In addition, for example, the transport stream input from the external network to the video processor 1332 through the connectivity 1321, the broadband modem 1333, or the like is buffered by the stream buffer 1414 and then demultiplexed by the demultiplexing unit (DMUX) 1413. In addition, for example, the file data read from various recording media by the connectivity 1321 or the like and input to the video processor 1332 is buffered by the stream buffer 1414 and then demultiplexed by the demultiplexing unit (DMUX) 1413. That is, the transport stream or the file data input to the video processor 1332 is separated into the video stream and the audio stream by the demultiplexing unit (DMUX) 1413.

The audio stream is supplied to the audio decoder 1411 through the audio ES buffer 1409B and decoded to reproduce the audio signal. In addition, the video stream is written to the video ES buffer 1408, and then the video stream is sequentially read and decoded by the encode/decode engine 1407 and written to the frame memory 1405. The decoded image data is enlarged or reduced by the second image enlargement/reduction unit 1403 and written to the frame memory 1405. The decoded image data is then read by the video output processing unit 1404, and the format is converted into a predetermined system, such as a 4:2:2 Y/Cb/Cr system. The decoded image data is further converted into an analog signal, and the video signal is reproduced and output.

In the case of applying the present technique to the video processor 1332 configured in this way, it is sufficient to apply the present technique according to the embodiment to the encode/decode engine 1407. That is, for example, the encode/decode engine 1407 may have one of or both the function of the encoding apparatus 11 and the function of the decoding apparatus 12. In this way, the video processor 1332 can obtain advantageous effects similar to the advantageous effects of the encoding apparatus 11 and the decoding apparatus 12 of the embodiment.

Note that in the encode/decode engine 1407, the present technique (that is, one of or both the function of the encoding apparatus 11 and the function of the decoding apparatus 12) may be realized by hardware, such as a logic circuit, may be realized by software, such as an embedded program, or may be realized by both the hardware and the software.

### <Another Configuration Example of Video Processor>

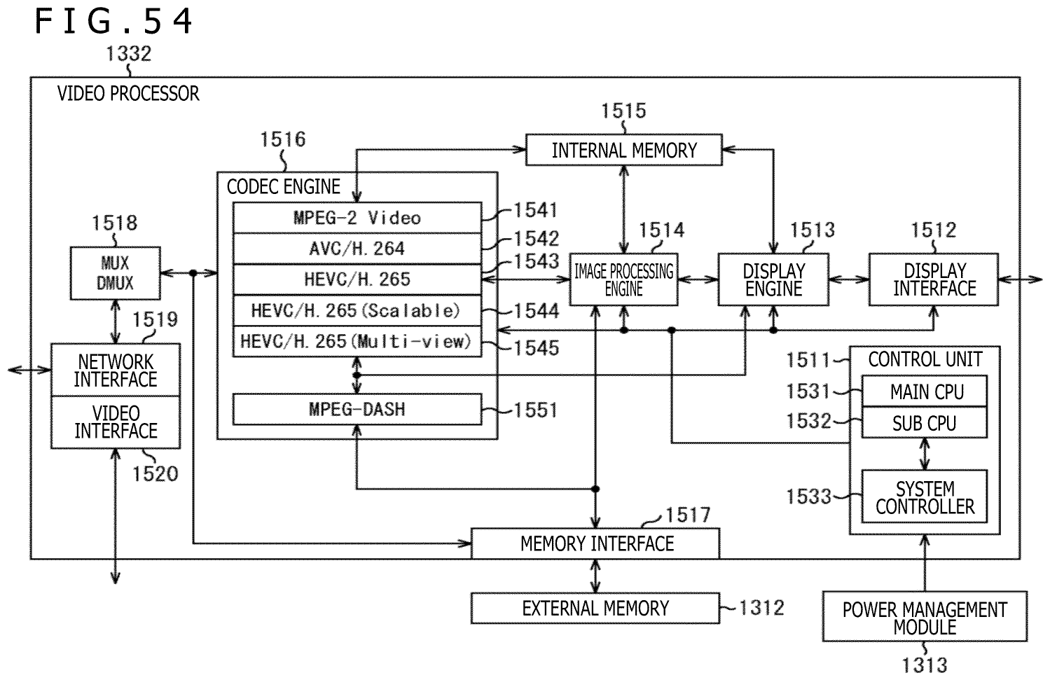

FIG. 54 is a diagram illustrating another example of the schematic configuration of the video processor 1332 according to the present technique.

In the case of the example of FIG. 54, the video processor 1332 has a function of using a predetermined system to encode and decode the video data.

More specifically, as illustrated in FIG. 54, the video processor 1332 includes a control unit 1511, a display interface 1512, a display engine 1513, an image processing engine 1514, and an internal memory 1515. The video processor 1332 also includes a codec engine 1516, a memory interface 1517, a multiplexing/demultiplexing unit (MUX DMUX) 1518, a network interface 1519, and a video interface 1520.

The control unit 1511 controls the operation of each processing unit in the video processor 1332, such as the display interface 1512, the display engine 1513, the image processing engine 1514, and the codec engine 1516.

As illustrated in FIG. 54, the control unit 1511 includes, for example, a main CPU 1531, a sub CPU 1532, and a system controller 1533. The main CPU 1531 executes a program or the like for controlling the operation of each processing unit in the video processor 1332. The main CPU 1531 generates a control signal according to the program or the like and supplies the control signal to each processing unit (that is, controls the operation of each processing unit). The sub CPU 1532 plays an auxiliary role of the main CPU 1531. For example, the sub CPU 1532 executes a child process, a subroutine, or the like of the program or the like executed by the main CPU 1531. The system controller 1533 controls the operations of the main CPU 1531 and the sub CPU 1532, such as designating the program executed by the main CPU 1531 and the sub CPU 1532.

The display interface 1512 outputs image data to, for example, the connectivity 1321 or the like under the control of the control unit 1511. For example, the display interface 1512 converts image data of digital data into an analog signal and outputs a reproduced video signal or the image data of the digital data to a monitor apparatus or the like of the connectivity 1321.

Under the control of the control unit 1511, the display engine 1513 applies various conversion processes, such as format conversion, size conversion, and color gamut conversion, to the image data according to hardware specifications of a monitor apparatus or the like that displays the image.

The image processing engine 1514 applies predetermined image processing, such as, for example, a filtering process for improving the image quality, to the image data under the control of the control unit 1511.

The internal memory 1515 is a memory shared by the display engine 1513, the image processing engine 1514, and the codec engine 1516 and provided inside of the video processor 1332. The internal memory 1515 is used to transfer data between, for example, the display engine 1513, the image processing engine 1514, and the codec engine 1516. For example, the internal memory 1515 stores data supplied from the display engine 1513, the image processing engine 1514, or the codec engine 1516 and supplies the data to the display engine 1513, the image processing engine 1514, or the codec engine 1516 as necessary (for example, according to a request). Although the internal memory 1515 may be realized by any storage device, the internal memory 1515 is generally used to store low-capacity data, such as block-based image data and parameters, in many cases, and it is desirable to realize the internal memory 1515 by a relatively (for example, compared to the external memory 1312) low-capacity semiconductor memory with high response speed, such as an SRAM (Static Random Access Memory).

The codec engine 1516 executes a process regarding encoding and decoding of image data. The system of encoding and decoding corresponding to the codec engine 1516 is arbitrary, and there may be one system or a plurality of systems. For example, the codec engine 1516 may have codec functions of a plurality of encoding and decoding systems and may use selected one of the codec functions to encode image data or decode encoded data.

In the example illustrated in FIG. 54, the codec engine 1516 includes, for example, an MPEG-2 Video 1541, an AVC/H.264 1542, an HEVC/H.265 1543, an HEVC/H.265 (Scalable) 1544, an HEVC/H.265 (Multi-view) 1545, and an MPEG-DASH 1551 that are functional blocks of processes regarding the codec.

The MPEG-2 Video 1541 is a functional block that uses the MPEG-2 system to encode and decode image data. The AVC/H.264 1542 is a functional block that uses the AVC system to encode and decode image data. The HEVC/H.265 1543 is a functional block that uses the HEVC system to encode and decode image data. The HEVC/H.265 (Scalable) 1544 is a functional block that uses the HEVC system to apply scalable encoding and scalable decoding to image data. The HEVC/H.265 (Multi-view) 1545 is a functional block that uses the HEVC system to apply multi-view encoding and multi-view decoding to the image data.

The MPEG-DASH 1551 is a functional block that uses the MPEG-DASH (MPEG-Dynamic Adaptive Streaming over HTTP) system to transmit and receive image data. The MPEG-DASH is a technique of using the HTTP (HyperText Transfer Protocol) to stream a video, and one of the features is that appropriate encoded data is transmitted by selecting the encoded data on a segment-by-segment basis from a plurality of pieces of encoded data with different resolutions or the like prepared in advance. The MPEG-DASH 1551 performs operations, such as generating a stream in compliance with the standard and controlling the transmission of the stream, and uses the components from the MPEG-2 Video 1541 to the HEVC/H.265 (Multi-view) 1545 to encode and decode image data.

The memory interface 1517 is an interface for the external memory 1312. The data supplied from the image processing engine 1514 or the codec engine 1516 is supplied to the external memory 1312 through the memory interface 1517. In addition, the data read from the external memory 1312 is supplied to the video processor 1332 (image processing engine 1514 or codec engine 1516) through the memory interface 1517.

The multiplexing/demultiplexing unit (MUX DMUX) 1518 multiplexes and demultiplexes various types of data regarding the image, such as a bitstream of encoded data, image data, and a video signal. The method of multiplexing and demultiplexing is arbitrary. For example, the multiplexing/demultiplexing unit (MUX DMUX) 1518 can not only group together a plurality of pieces of data in multiplexing, but can also add predetermined header information or the like to the data. In addition, the multiplexing/demultiplexing unit (MUX DMUX) 1518 can not only partition one piece of data into a plurality of pieces of data in demultiplexing, but can also add predetermined header information or the like to each piece of partitioned data. That is, the multiplexing/demultiplexing unit (MUX DMUX) 1518 can multiplex and demultiplex data to convert the format of the data. For example, the multiplexing/demultiplexing unit (MUX DMUX) 1518 can multiplex a bitstream to convert the bitstream into a transport stream that is a bitstream in the format of transfer or into data (file data) in the file format for recording. Obviously, the inverse transformation of the data can also be performed by demultiplexing.

The network interface 1519 is, for example, an interface for the broadband modem 1333, the connectivity 1321, and the like. The video interface 1520 is, for example, an interface for the connectivity 1321, the camera 1322, and the like.

Next, an example of the operation of the video processor 1332 will be described. For example, when a transport stream is received from an external network through the connectivity 1321, the broadband modem 1333, or the like, the transport stream is supplied to the multiplexing/demultiplexing unit (MUX DMUX) 1518 through the network interface 1519 and demultiplexed, and the codec engine 1516 decodes the transport stream. The image processing engine 1514 applies, for example, predetermined image processing to the image data obtained by the decoding of the codec engine 1516, and the display engine 1513 performs predetermined conversion. The image data is supplied to, for example, the connectivity 1321 or the like through the display interface 1512, and the image is displayed on the monitor. In addition, for example, the codec engine 1516 encodes again the image data obtained by the decoding of the codec engine 1516, and the multiplexing/demultiplexing unit (MUX DMUX) 1518 multiplexes the image data and converts the image data into file data. The file data is output to, for example, the connectivity 1321 or the like through the video interface 1520 and recorded in various recording media.

Furthermore, for example, the file data of the encoded data including the encoded image data read by the connectivity 1321 or the like from a recording medium not illustrated is supplied to the multiplexing/demultiplexing unit (MUX DMUX) 1518 through the video interface 1520 and demultiplexed, and the file data is decoded by the codec engine 1516. The image processing engine 1514 applies predetermined image processing to the image data obtained by the decoding of the codec engine 1516, and the display engine 1513 performs predetermined conversion of the image data. The image data is supplied to, for example, the connectivity 1321 or the like through the display interface 1512, and the image is displayed on the monitor. In addition, for example, the codec engine 1516 encodes again the image data obtained by the decoding of the codec engine 1516, and the multiplexing/demultiplexing unit (MUX DMUX) 1518 multiplexes the image data and converts the image data into a transport stream. The transport stream is supplied to, for example, the connectivity 1321, the broadband modem 1333, or the like through the network interface 1519 and transmitted to another apparatus not illustrated.

Note that the transfer of the image data and other data between processing units in the video processor 1332 is performed by using, for example, the internal memory 1515 or the external memory 1312. In addition, the power management module 1313 controls power supplied to, for example, the control unit 1511.

In the case where the present technique is applied to the video processor 1332 configured in this way, it is sufficient to apply the present technique according to the embodiment to the codec engine 1516. That is, for example, the codec engine 1516 is only required to have one of or both the function of the encoding apparatus 11 and the function of the decoding apparatus 12. In this way, the video processor 1332 can obtain advantageous effects similar to the advantageous effects of the encoding apparatus 11 and the decoding apparatus 12.

Note that in the codec engine 1516, the present technique (that is, the functions of the encoding apparatus 11 and the decoding apparatus 12) may be realized by hardware, such as a logic circuit, may be realized by software, such as an embedded program, or may be realized by both the hardware and the software.

Although two configurations of the video processor 1332 have been illustrated, the configuration of the video processor 1332 is arbitrary, and the configuration may be other than the configurations of the two examples. In addition, the video processor 1332 may be provided as one semiconductor chip or may be provided as a plurality of semiconductor chips. For example, the video processor 1332 may be a three-dimensional stacked LSI including a plurality of stacked semiconductors. The video processor 1332 may also be realized by a plurality of LSIs.

### <Example of Application to Apparatus>

The video set 1300 can be incorporated into various apparatuses that process image data. For example, the video set 1300 can be incorporated into the television apparatus 1200 (FIG. 48), the mobile phone 1220 (FIG. 49), the recording/reproducing apparatus 1240 (FIG. 50), the imaging apparatus 1260 (FIG. 51), and the like. The incorporation of the video set 1300 allows the apparatus to obtain advantageous effects similar to the advantageous effects of the encoding apparatus 11 and the decoding apparatus 12.

Note that part of each configuration of the video set 1300 can be carried out as a configuration according to the present technique as long as the part includes the video processor 1332. For example, the video processor 1332 alone can be carried out as a video processor according to the present technique. In addition, for example, the processor indicated by the dotted line 1341, the video module 1311, or the like can be carried out as a processor, a module, or the like according to the present technique as described above. Furthermore, for example, the video module 1311, the external memory 1312, the power management module 1313, and the front-end module 1314 can be combined to carry out a video unit 1361 according to the present technique. In any of the configurations, advantageous effects similar to the advantageous effects of the encoding apparatus 11 and the decoding apparatus 12 can be obtained.

That is, any configuration including the video processor 1332 can be incorporated into various apparatuses that process image data, as in the case of the video set 1300. For example, the video processor 1332, the processor indicated by the dotted line 1341, the video module 1311, or the video unit 1361 can be incorporated into the television apparatus 1200 (FIG. 48), the mobile phone 1220 (FIG. 49), the recording/reproducing apparatus 1240 (FIG. 50), the imaging apparatus 1260 (FIG. 51), or the like. In addition, the incorporation of one of the configurations according to the present technique allows the apparatus to obtain advantageous effects similar to the advantageous effects of the encoding apparatus 11 and the decoding apparatus 12 as in the case of the video set 1300.

### <Etc.>

Note that although various types of information are multiplexed with the encoded data (bitstream) and transmitted from the encoding side to the decoding side in the example described in the present specification, the method of transmitting the information is not limited to the example. For example, the information may not be multiplexed with the encoded data, and the information may be transmitted or recorded as separate data associated with the encoded data. Here, the term “associated” means, for example, that the image (may be part of the image, such as a slice or a block) included in the encoded data and the information corresponding to the image can be linked at the decoding. That is, the information associated with the encoded data (image) may be transmitted on a transmission path different from the encoded data (image). In addition, the information associated with the encoded data (image) may be recorded in a recording medium separate from the encoded data (image) (or in a separate recording area of the same recording medium). Furthermore, the image and the information corresponding to the image may be associated with each other in an arbitrary unit, such as, for example, a plurality of frames, one frame, and part of the frame.

In addition, the terms, such as “combine,” “multiplex,” “add,” “integrate,” “include,” “store,” “put in,” “place into,” and “insert,” denote grouping of a plurality of things, such as grouping of the flag information and the encoded data of the information regarding the image into one piece of data, and each term denotes one method of “associating” described above.

In addition, the embodiment of the present technique is not limited to the embodiment described above, and various changes can be made without departing from the scope of the present technique.

For example, the system in the present specification denotes a set of a plurality of constituent elements (apparatuses, modules (components), and the like), and whether or not all of the constituent elements are in the same housing does not matter. Therefore, a plurality of apparatuses stored in separate housings and connected through a network and one apparatus storing a plurality of modules in one housing are both systems.

Furthermore, for example, the configuration of one apparatus (or processing unit) described above may be divided to provide a plurality of apparatuses (or processing units). Conversely, the configurations of a plurality of apparatuses (or processing units) described above may be put together to provide one apparatus (or processing unit). In addition, configurations other than the configurations described above may be obviously added to the configuration of each apparatus (or each processing unit). Furthermore, part of the configuration of an apparatus (or processing unit) may be included in the configuration of another apparatus (or another processing unit) as long as the configuration and the operation of the entire system are substantially the same.

In addition, the present technique can be provided as, for example, cloud computing in which a plurality of apparatuses share one function and cooperate to execute a process through a network.

In addition, the program described above can be executed by, for example, an arbitrary apparatus. In that case, the apparatus is only required to have necessary functions (such as functional blocks) and obtain necessary information.

In addition, for example, one apparatus can execute each step described in the flow charts, or a plurality of apparatuses can take charge and execute each step. Furthermore, in the case where one step includes a plurality of processes, one apparatus can execute the plurality of processes included in one step, or a plurality of apparatuses can take charge and execute the processes.

Note that the program executed by the computer may be a program in which the processes of the steps describing the program are executed in chronological order described in the present specification, or the program may be a program for executing the processes in parallel or for executing the processes separately at a necessary timing such as when the processes are invoked. That is, the processes of the steps may be executed in an order different from the order described above as long as there is no contradiction. Furthermore, the processes of the steps describing the program may be executed in parallel with processes of other programs or may be executed in combination with processes of other programs.

Note that the plurality of present techniques described in the present specification can be independently and separately carried out as long as there is no contradiction. Obviously, a plurality of arbitrary present techniques can be combined and carried out. For example, the present technique described in one of the embodiments can also be carried out in combination with the present technique described in another embodiment. In addition, an arbitrary present technique described above can also be carried out in combination with another technique not described above.

In addition, the advantageous effects described in the present specification are illustrative only, and the advantageous effects are not limited. There may also be other advantageous effects.

Note that the present technique can be configured as follows.

<1>

An encoding apparatus including:

a classification unit that classifies a target pixel of a first image, the first image being obtained by adding a residual of prediction encoding and a predicted image, into one of a plurality of classes; and

a filter processing unit that applies a filtering process corresponding to the class of the target pixel to the first image to generate a second image used to predict the predicted image, in which

the classification unit performs the classification by using previous-stage filter related information regarding a previous-stage filtering process executed in a previous stage of the filtering process of the filter processing unit, and

the encoding apparatus performs the prediction encoding.

<2>

The encoding apparatus according <1>, further including:

a classification method decision unit that decides a method of the classification.

<3>

The encoding apparatus according to <2>, further including:

a transmission unit that transmits classification method information indicating the method of the classification decided by the classification method decision unit.

<4>

The encoding apparatus according to <2>, in which

the classification method decision unit decides the method of the classification according to acquirable information acquirable from encoded data obtained by the prediction encoding.

<5>

The encoding apparatus according to <1> or <2>, in which

the filter processing unit includes a prediction tap selection unit that forms a prediction tap used for prediction computation for obtaining a pixel value of a corresponding pixel of the second image corresponding to the target pixel of the first image by selecting pixels to be the prediction tap from the first image,

a tap coefficient acquisition unit that acquires tap coefficients of the class of the target pixel from tap coefficients of each of the classes used for the prediction computation obtained by learning using a student image equivalent to the first image and a teacher image equivalent to an original image corresponding to the first image, and

a computation unit that obtains a pixel value of the corresponding pixel by performing the prediction computation using the tap coefficients of the class of the target pixel and the prediction tap of the target pixel, and

the encoding apparatus further includes:

a transmission unit that transmits the tap coefficients.

<6>

The encoding apparatus according to <5>, further including:

a coefficient deletion unit that sets part of the classes, for which the tap coefficients are obtained by the learning, as a removed class to be removed from a target of the filtering process, sets, as adopted coefficients to be used for the filtering process, tap coefficients after deletion of the tap coefficients of the removed class from the tap coefficients of each of the classes obtained by the learning, and outputs the adopted coefficients, in which

the transmission unit transmits the adopted coefficients, and

the computation unit outputs a pixel value of the target pixel as the pixel value of the corresponding pixel in a case where the class of the target pixel is the removed class.

<7>

The encoding apparatus according to any one of <1> to <6>, in which

the previous-stage filtering process includes a filtering process of DF (Deblocking Filter).

<8>

The encoding apparatus according to any one of <1> to <7>, in which

the classification unit uses the previous-stage filter related information and an image feature value of the target pixel to perform the classification.

<9>

An encoding method of an encoding apparatus, the encoding apparatus including:

a classification unit that classifies a target pixel of a first image, the first image being obtained by adding a residual of prediction encoding and a predicted image, into one of a plurality of classes; and

a filter processing unit that applies a filtering process corresponding to the class of the target pixel to the first image to generate a second image used to predict the predicted image, in which

the encoding apparatus performs the prediction encoding, and

the classification unit performs the classification by using previous-stage filter related information regarding a previous-stage filtering process executed in a previous stage of the filtering process of the filter processing unit.

<10>

A decoding apparatus including:

a classification unit that classifies a target pixel of a first image, the first image being obtained by adding a residual of prediction encoding and a predicted image, into one of a plurality of classes; and

a filter processing unit that applies a filtering process corresponding to the class of the target pixel to the first image to generate a second image used to predict the predicted image, in which

the classification unit performs the classification by using previous-stage filter related information regarding a previous-stage filtering process executed in a previous stage of the filtering process of the filter processing unit, and

the decoding apparatus uses the predicted image to decode an image.

<11>

The decoding apparatus according to <10>, further including:

a collection unit that collects classification method information indicating a method of the classification, in which

the classification unit uses the method indicated in the classification method information to perform the classification.

<12>

The decoding apparatus according to <10>, further including:

a classification method decision unit that decides the method of the classification according to acquirable information acquirable from encoded data obtained by the prediction encoding.

<13>

The decoding apparatus according to <10>, in which

the filter processing unit includes
a prediction tap selection unit that forms a prediction tap used for prediction computation for obtaining a pixel value of a corresponding pixel of the second image corresponding to the target pixel of the first image by selecting pixels to be the prediction tap from the first image,
a tap coefficient acquisition unit that acquires tap coefficients of the class of the target pixel from tap coefficients of each of the classes used for the prediction computation obtained by learning using a student image equivalent to the first image and a teacher image equivalent to an original image corresponding to the first image, and
a computation unit that obtains a pixel value of the corresponding pixel by performing the prediction computation using the tap coefficients of the class of the target pixel and the prediction tap of the target pixel, and

the decoding apparatus further includes:

a collection unit that collects the tap coefficients.

<14>

The decoding apparatus according to <13>, in which

in a case where part of the classes, for which the tap coefficients are obtained by the learning, is set as a removed class to be removed from a target of the filtering process, and tap coefficients after deletion of the tap coefficients of the removed class from the tap coefficients of each of the classes obtained by the learning are set as adopted coefficients to be used for the filtering process,

the collection unit collects the adopted coefficients, and

the computation unit outputs a pixel value of the target pixel as the pixel value of the corresponding pixel in a case where the class of the target pixel is the removed class.

<15>

The decoding apparatus according to any one of <10> to <14>, in which

the previous-stage filtering process includes a filtering process of DF (Deblocking Filter).

<16>

The decoding apparatus according to any one of <10> to <15>, in which

the classification unit uses the previous-stage filter related information and an image feature value of the target pixel to perform the classification.

<17>

A decoding method of a decoding apparatus, the decoding apparatus including:

a classification unit that classifies a target pixel of a first image, the first image being obtained by adding a residual of prediction encoding and a predicted image, into one of a plurality of classes; and

a filter processing unit that applies a filtering process corresponding to the class of the target pixel to the first image to generate a second image used to predict the predicted image, in which

the decoding apparatus uses the predicted image to decode an image, and

the classification unit performs the classification by using previous-stage filter related information regarding a previous-stage filtering process executed in a previous stage of the filtering process of the filter processing unit.

### REFERENCE SIGNS LIST

11 Encoding apparatus, 12 Decoding apparatus, 21 Tap selection unit, 22 Classification unit, 23 Coefficient acquisition unit, 24 Prediction computation unit, 40 Learning apparatus, 41 Teacher data generation unit, 42 Student data generation unit, 43 Learning unit, 51 Tap selection unit, 52 Classification unit, 53 Summing unit, 54 Coefficient calculation unit, 61 Coefficient acquisition unit, 71 Parameter generation unit, 72 Student data generation unit, 73 Learning unit, 81 Summing unit, 82 Coefficient calculation unit, 91, 92 Summing unit, 93 Coefficient calculation unit, 101 A/D conversion unit, 102 Rearrangement buffer, 103 Computation unit, 104 Orthogonal transformation unit, 105 Quantization unit, 106 Reversible encoding unit, 107 Accumulation buffer, 108 Inverse quantization unit, 109 Inverse orthogonal transformation unit, 110 Computation unit, 111 DF, 112 SAO, 113 Adaptive classification filter, 114 Frame memory, 115 Selection unit, 116 Intra prediction unit, 117 Motion prediction compensation unit, 118 Predicted image selection unit, 119 Rate control unit, 131 Learning apparatus, 132 Filter information generation unit, 133 Image conversion apparatus, 151 Classification method decision unit, 152 Learning unit, 153 Unused coefficient deletion unit, 161 Tap selection unit, 162 Classification unit, 163 Summing unit, 164 Coefficient calculation unit, 171 Class tap selection unit, 172 Image feature value extraction unit, 173, 174 Subclass classification unit, 175 DF information acquisition unit, 176 Subclass classification unit, 177 Combining unit, 190 Filter processing unit, 191 Tap selection unit, 192 Classification unit, 193 Coefficient acquisition unit, 194 Prediction computation unit, 201 Accumulation buffer, 202 Reversible decoding unit, 203 Inverse quantization unit, 204 Inverse orthogonal transformation unit, 205 Computation unit, 206 DF, 207 SAO, 208 Adaptive classification filter, 209 Rearrangement buffer, 210 D/A conversion unit, 211 Frame memory, 212 Selection unit, 213 Intra prediction unit, 214 Motion prediction compensation unit, 215 Selection unit, 231 Image conversion apparatus, 240 Filter processing unit, 241 Tap selection unit, 242 Classification unit, 243 Coefficient acquisition unit, 244 Prediction computation unit, 311 Adaptive classification filter, 331 Learning apparatus, 332 Filter information generation unit, 333 Image conversion apparatus, 351, 361 Classification method decision unit, 411 Adaptive classification filter, 431 Image conversion apparatus, 441 Classification method decision unit

1. An encoding apparatus comprising:
a classification unit that classifies a target pixel of a first image, the first image being obtained by adding a residual of prediction encoding and a predicted image, into one of a plurality of classes; and
a filter processing unit that applies a filtering process corresponding to the class of the target pixel to the first image to generate a second image used to predict the predicted image, wherein
the classification unit performs the classification by using previous-stage filter related information regarding a previous-stage filtering process executed in a previous stage of the filtering process of the filter processing unit, and
the encoding apparatus performs the prediction encoding.

2. The encoding apparatus according to claim 1, further comprising:
a classification method decision unit that decides a method of the classification.

3. The encoding apparatus according to claim 2, further comprising:
a transmission unit that transmits classification method information indicating the method of the classification decided by the classification method decision unit.

4. The encoding apparatus according to claim 2, wherein
the classification method decision unit decides the method of the classification according to acquirable information acquirable from encoded data obtained by the prediction encoding.

5. The encoding apparatus according to claim 1, wherein
the filter processing unit includes
a prediction tap selection unit that forms a prediction tap used for prediction computation for obtaining a pixel value of a corresponding pixel of the second image corresponding to the target pixel of the first image by selecting pixels to be the prediction tap from the first image,
a tap coefficient acquisition unit that acquires tap coefficients of the class of the target pixel from tap coefficients of each of the classes used for the prediction computation obtained by learning using a student image equivalent to the first image and a teacher image equivalent to an original image corresponding to the first image, and
a computation unit that obtains a pixel value of the corresponding pixel by performing the prediction computation using the tap coefficients of the class of the target pixel and the prediction tap of the target pixel, and
the encoding apparatus further comprises:
a transmission unit that transmits the tap coefficients.

6. The encoding apparatus according to claim 5, further comprising:
a coefficient deletion unit that sets part of the classes, for which the tap coefficients are obtained by the learning, as a removed class to be removed from a target of the filtering process, sets, as adopted coefficients to be used for the filtering process, tap coefficients after deletion of the tap coefficients of the removed class from the tap coefficients of each of the classes obtained by the learning, and outputs the adopted coefficients, wherein
the transmission unit transmits the adopted coefficients, and
the computation unit outputs a pixel value of the target pixel as the pixel value of the corresponding pixel in a case where the class of the target pixel is the removed class.

7. The encoding apparatus according to claim 1, wherein
the previous-stage filtering process includes a filtering process of DF (Deblocking Filter).

8. The encoding apparatus according to claim 1, wherein
the classification unit uses the previous-stage filter related information and an image feature value of the target pixel to perform the classification.

9. An encoding method of an encoding apparatus, the encoding apparatus comprising:
a classification unit that classifies a target pixel of a first image, the first image being obtained by adding a residual of prediction encoding and a predicted image, into one of a plurality of classes; and
a filter processing unit that applies a filtering process corresponding to the class of the target pixel to the first image to generate a second image used to predict the predicted image, wherein
the encoding apparatus performs the prediction encoding, and
the classification unit performs the classification by using previous-stage filter related information regarding a previous-stage filtering process executed in a previous stage of the filtering process of the filter processing unit.

10. A decoding apparatus comprising:
a classification unit that classifies a target pixel of a first image, the first image being obtained by adding a residual of prediction encoding and a predicted image, into one of a plurality of classes; and
a filter processing unit that applies a filtering process corresponding to the class of the target pixel to the first image to generate a second image used to predict the predicted image, wherein
the classification unit performs the classification by using previous-stage filter related information regarding a previous-stage filtering process executed in a previous stage of the filtering process of the filter processing unit, and
the decoding apparatus uses the predicted image to decode an image.

11. The decoding apparatus according to claim 10, further comprising:
a collection unit that collects classification method information indicating a method of the classification, wherein
the classification unit uses the method indicated in the classification method information to perform the classification.

12. The decoding apparatus according to claim 10, further comprising:
a classification method decision unit that decides the method of the classification according to acquirable information acquirable from encoded data obtained by the prediction encoding.

13. The decoding apparatus according to claim 10, wherein
the filter processing unit includes
a prediction tap selection unit that forms a prediction tap used for prediction computation for obtaining a pixel value of a corresponding pixel of the second image corresponding to the target pixel of the first image by selecting pixels to be the prediction tap from the first image,
a tap coefficient acquisition unit that acquires tap coefficients of the class of the target pixel from tap coefficients of each of the classes used for the prediction computation obtained by learning using a student image equivalent to the first image and a teacher image equivalent to an original image corresponding to the first image, and
a computation unit that obtains a pixel value of the corresponding pixel by performing the prediction computation using the tap coefficients of the class of the target pixel and the prediction tap of the target pixel, and
the decoding apparatus further comprises:
a collection unit that collects the tap coefficients.

14. The decoding apparatus according to claim 13, wherein
in a case where part of the classes, for which the tap coefficients are obtained by the learning, is set as a removed class to be removed from a target of the filtering process, and tap coefficients after deletion of the tap coefficients of the removed class from the tap coefficients of each of the classes obtained by the learning are set as adopted coefficients to be used for the filtering process,
the collection unit collects the adopted coefficients, and
the computation unit outputs a pixel value of the target pixel as the pixel value of the corresponding pixel in a case where the class of the target pixel is the removed class.

15. The decoding apparatus according to claim 10, wherein
the previous-stage filtering process includes a filtering process of DF (Deblocking Filter).

16. The decoding apparatus according to claim 10, wherein
the classification unit uses the previous-stage filter related information and an image feature value of the target pixel to perform the classification.

17. A decoding method of a decoding apparatus, the decoding apparatus comprising:
a classification unit that classifies a target pixel of a first image, the first image being obtained by adding a residual of prediction encoding and a predicted image, into one of a plurality of classes; and
a filter processing unit that applies a filtering process corresponding to the class of the target pixel to the first image to generate a second image used to predict the predicted image, wherein
the decoding apparatus uses the predicted image to decode an image, and
the classification unit performs the classification by using previous-stage filter related information regarding a previous-stage filtering process executed in a previous stage of the filtering process of the filter processing unit.
